(19) United States
(12) Patent Application Publication
(10) Pub. No.: US 2006/0046834 A1
(43) Pub. Date: Mar. 2, 2006

(54) Gaming machine, control method for gaming machine, game system, server, mobile device and game program

(75) Inventor: Yuichi Sekine, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/210,861

(22) Filed: Aug. 25, 2005

(30) Foreign Application Priority Data
Aug. 30, 2004 (JP) P2004-250244
Sep. 13, 2004 (JP) P2004-265200

(51) Int. Cl. A63F 13/00

(52) U.S. Cl. 463/20

(57) ABSTRACT

A pachi-slot gaming machine is disclosed having a two-dimensional code displayed on a two-dimensional code display area at the end of a game. A camera of a mobile phone captures the two-dimensional code for transmission to a server. The two-dimensional code, transmitted to the server, is converted by a conversion program for the two-dimensional code into gaming information to be transmitted back to the mobile phone. Further, gaming information, acquired by the mobile phone, is able to be returned to the pachi-slot gaming machine as the two-dimensional code via an image capture device of the pachi-slot gaming machine, thereby enabling alteration of gaming information as needed.

### CROSS REFERENCE TO RELATED APPLICATIONS

This invention is based upon and claims the benefit of priority from the prior Japanese Patent Application Nos. P2004-250244 with a filing date of Aug. 30, 2004; and P2004-265200 with a filing date of Sep. 13, 2004; the entire contents of which are incorporated herein by reference.

### BACKGROUND OF THE INVENTION

1. Field of the Invention

The present invention relates to a gaming machine, a control method for the gaming machine, a game system including such a gaming machine, a server for use in such a game system, a mobile device and a game program and, more particularly, a gaming machine displays code information in which information (hereinafter referred to as personal information), involving a gaming outcome of a player, is coded into, for instance, a BAR code or the like while providing a player with various services on a game program, to be executed on the gaming machine, depending on code information displayed over the gaming machine.

2. Description of the Related Art

In recent years, music and images as effects for use in pachinko-gaming machines and pachi-slot machines (slot-gaming machines) (Japanese Slot Machines), have not been formed in simplified natures for the purpose of merely for notifying players starts of a “BB” (Big Bonus) and an “RB” (Regular Bonus) and have been using characters, featuring popular comic/animation characters (hereinafter, referred to as “character(s)”) or famous music such as those ranked in hit charts. Further, a home-use gaming-machine industry have been getting a large sale in video games which simulate slot-gaming machines/pachinko-gaming machines installed in game arcades.

Furthermore, in the related art, it has been a usual practice for a plurality of kinds of gaming machines to be installed in the game arcades. Moreover, even in the game arcade has the gaming machines with the same models, since each internal setting of the installed gaming machines are different one another, there is a case where the player winning the game or loosing the game even plays with the same models of the gaming machines. Under such a background, the player records gaming outcomes, resulting from games practiced by himself, on, for instance, a notebook and makes analysis on such gaming outcomes for the purpose of playing a game next time with an advantage.

Further, as set forth above, as popularities on the slot-gaming machine and pachinko-gaming machine increase, the number of players, who have the thinking to effectively use the gaming information, is increasing in recent years. For instance, it is a short avenue for beginners of the games in reaching their proficiencies on games to analyze the gaming information and expert players have capabilities of utilizing such gaming information as strong execution guides with an aim for continued winnings.

Furthermore, in the related art, depending on the game arcades in which gaming machines, such as slot-gaming machines and pachinko-gaming machines, are installed, there are game arcades in which as a bonus state (“BB” or “RB”) starts when a specified condition is satisfied, effects are provided to allow the player to have further increased excitement. For instance, in cases where “BB” or “RB” has started on the gaming machine, services are provided including notification given to the player by making announcement in the game arcade or by varying BGM. With such services, the player is able to have further increased excitement on “BB” or “RB”.

As the popularities of the slot-gaming machine or the Pachinko-gaming machines increase, the players have ardent supports or attachments for characters or music, etc., used in the effect of the gaming machine provided by a certain gaming machine manufacturer and the number of maniacal customers for the gaming machine manufacturer increases. Under such an actual situation, it has been expected for a service to be provided by the gaming machine manufacturer so as to allow the player to have support and attachment for a gaming machine of the same gaming machine manufacturer.

Further, products related to the gaming machine have been increased its popularities. Despite such a phenomenon provides the gaming machine manufacturer with advantages for the gaming machine of the own manufacturer in obtaining supports of the players, no advantage exists for the game arcade. For this reason, under a current situation wherein maniacal customers for the gaming machine manufacturer are increasing in recent years, appearance of a service has been expected to provide a capability of causing a support of a player on the gaming machine manufacturer to be united to an ability to pull in more customers in the game arcade.

### SUMMARY OF THE INVENTION

The present invention has been completed with a view to addressing such issues of the related art and has an object to provide a gaming machine, which displays code information, resulting from coding personal information, such as a lottery outcome or the like of a player, depending on a gamins state, and a game system that can provides various services depending on code information displayed over the gaming machine.

To achieve the above object, one aspect of the present invention provides a gaming machine comprising: a display device; a lottery device; a gaming state varying device varying a gaming state of the gaming machine depending on a lottery outcome resulting from the lottery device; a code information display device displaying code information depending on the gaming state so that an external image capture device captures the code information; and a code information readout device reading out the code information. The present invention, whose second issue is to address the problems encountered in the related art set forth above and related to a gaming machine, a game system equipped with the gaming machine, a server, a mobile device and a gaming device (Video game), and a program to be executed in the gaming device, more particularly, has an object to provide a gaming machine, arranged to display code information, such as bar code, depending on a gaming state, and various services to a player on a game program executed on the gaming device.

To achieve such an object, another aspect of the present invention provides a gaming machine operative to be used in a game system having a gaming device which includes an interface through which game-related information is inputted from an outside and executes a game based on a game program depending on the game-related information inputted via the interface, and the gaming machine, the gaming machine comprising: a display device; a lottery device; a gaming state varying device varying a gaming state depending on a lottery outcome resulting from the lottery device, wherein the display device further includes a code information display device displaying code information, function as the game-related information or key information for obtaining the game-related information, which is readable with an external image capture device depending on the gaming state varied by the gaming state varying device.

### BRIEF DESCRIPTION OF THE DRAWINGS

FIG. 1 is an illustrative view typically showing a game system of first to third embodiments according to the present invention.

FIG. 2 is an exterior perspective view of a gaming machine (pachi-slot gaming machine) of the first to third embodiments.

FIG. 3 is an illustrative view showing a panel display section, a liquid crystal display and a fixed display section of the gaming machine in an enlarged scale.

FIG. 4 is an illustrative view showing an example of symbols drawn on outer peripheries of respective reels of the gaming machine.

FIG. 5 is an award table showing the relationship among a winning symbol combination in respective gaming states, winning combinations and the number of medals being paid out.

FIG. 6 is a block diagram of a main control circuit of the gaming machine of the first to third embodiments.

FIG. 7 is a block diagram of a sub-control circuit of the gaming machine of first to fifth embodiments.

FIGS. 8A and 8B are illustrative views showing a start command and a bonus gaming state alteration designating command.

FIGS. 9A to 9C are illustrative view showing a winning command, a gaming medal insertion command and a display control command.

FIGS. 10A and 10B are illustrative views showing one examples of odds lottery tables, with FIG. 10A showing the odds lottery table for use in a regular gaming state while FIG. 10B shows the odds lottery table for use in a “BB” gaming state.

FIG. 11 is an illustrative view regarding a concept in which a two-dimensional code 30 is obtained using a mobile phone.

FIG. 12 is an illustrative view during a mode in which the two-dimensional code 30 is obtained by the gaming machine of the first to third embodiments.

FIG. 13 is a flowchart of a control operation program of a CPU in the main control circuit of the gaming machine of the first to third embodiments.

FIG. 14 is a flowchart of the control operation program of the CPU in the main control circuit of the gaming machine of the first to third embodiments.

FIG. 15 is a flowchart of a gaming data acquiring process to be executed in the gaming machine of the first to third embodiments.

FIG. 16 is a flowchart of a recognition process for the two-dimensional code 30 to be executed in the gaming machine of the first to third embodiments.

FIG. 17 is a flowchart of an accumulated medal clearing process to be executed in the gaming machine of the first to third embodiments.

FIG. 18 is a flowchart of an encoding process of a sub-control circuit of the gaming machine of the first to third embodiments.

FIG. 19 is a flowchart of a command receiving process of the sub-control circuit of the gaming machine of the first to third embodiments.

FIG. 20 is a flowchart of a display control process of the sub-control circuit of the gaming machine of the first to third embodiments.

FIG. 21 is a flowchart of a character display process to be executed in a display control process of the first to third embodiments.

FIGS. 22A to 22D are illustrative views of characters to be displayed by the character display process.

FIG. 23 is an exterior perspective view of a mobile phone forming the game system of the first to fifth embodiments.

FIG. 24 is an exterior perspective view of the mobile phone, forming the game system of the first to fifth embodiments, in a folded state.

FIG. 25 is a block diagram showing a control system of the mobile phone of the first to fifth embodiments.

FIG. 26 is a block diagram of a server forming the game system of the first to fifth embodiments.

FIG. 27 is a flowchart showing a process to be executed in the mobile phone in the game system of the first embodiment.

FIG. 28 is a display example appearing when acquired gaming data is displayed over a liquid crystal display of the mobile phone.

FIG. 29 is an illustrative view typically showing a game system of a second embodiment according to the present invention.

FIG. 30 is a flowchart showing a process to be executed between a mobile phone and a server in the game system of the second embodiment.

FIG. 31 is an illustrative view typically showing a game system of a third embodiment.

FIG. 32 is a flowchart showing a process to be executed between a mobile phone and a server in a game system of a third embodiment.

FIG. 33 is an illustrative view typically showing a game system of fourth and fifth embodiments.

FIG. 34 is an exterior perspective view of a gaming machine (pachi-slot gaming machine) of the fourth and fifth embodiments. FIG. 35 is an illustrative view showing a panel display section, a liquid crystal display and a fixed display section of the gaming machine of the fourth end fifth embodiments in an enlarged scale.

FIG. 36 is a block diagram of a main control circuit of the gaming machine of the fourth and fifth embodiments.

FIG. 37 is a flowchart of a control operation program of a CPU in a main control circuit of the gaming machine of the fourth and fifth embodiments.

FIG. 38 is a flowchart of the control operation program of the CPU in the main control circuit of the gaming machine of the fourth and fifth embodiments.

FIG. 39 is a flowchart of a command receiving process of a sub-control circuit of the gaming machine of the fourth and fifth embodiments.

FIG. 40 is an illustrative view showing one example of a premium lottery table for use in a premium lottery process.

FIG. 41 is a flowchart of an encoding process of the sub-control circuit of the gaming machine of the fourth and fifth embodiments.

FIG. 42 is a flowchart of a display control process of the sub-control circuit of the gaming machine of the fourth and fifth embodiments.

FIG. 43 is a flowchart showing a process to be executed between a mobile phone and a server in the game system of the fourth embodiment.

FIG. 44 is a flowchart of a recognition process for the two-dimensional code 30 to be executed in the fourth and fifth embodiments.

FIGS. 45A and 45B are illustrative views of the game system of the fourth and fifth embodiments. FIG. 45A shows a case in which an awaiting image is won as premium data and FIG. 45B shows a case wherein password data is won as premium data.

FIG. 46 is an exterior perspective view of a gaming device forming the game system of the fourth and fifth embodiments.

FIG. 47 is a block diagram showing a control system of the gaming device.

FIG. 48 is a flowchart of a game program to be executed by the gaming device.

FIGS. 49A and 49B are illustrative views (first example) showing a display mode of a game display section when the game program is executed.

FIGS. 50A and 50B are illustrative views (second example) showing a display mode of the game display section when the game program is executed.

FIGS. 51A and 51B are illustrative views (third example) showing a display mode of the game display section when the game program is executed.

FIG. 52 is a flowchart showing a process to be executed between the mobile phone and the server in the game system of the fifth embodiment.

### DETAILED DESCRIPTION OF THE INVENTION

### First Embodiment

(Structure of Game System)

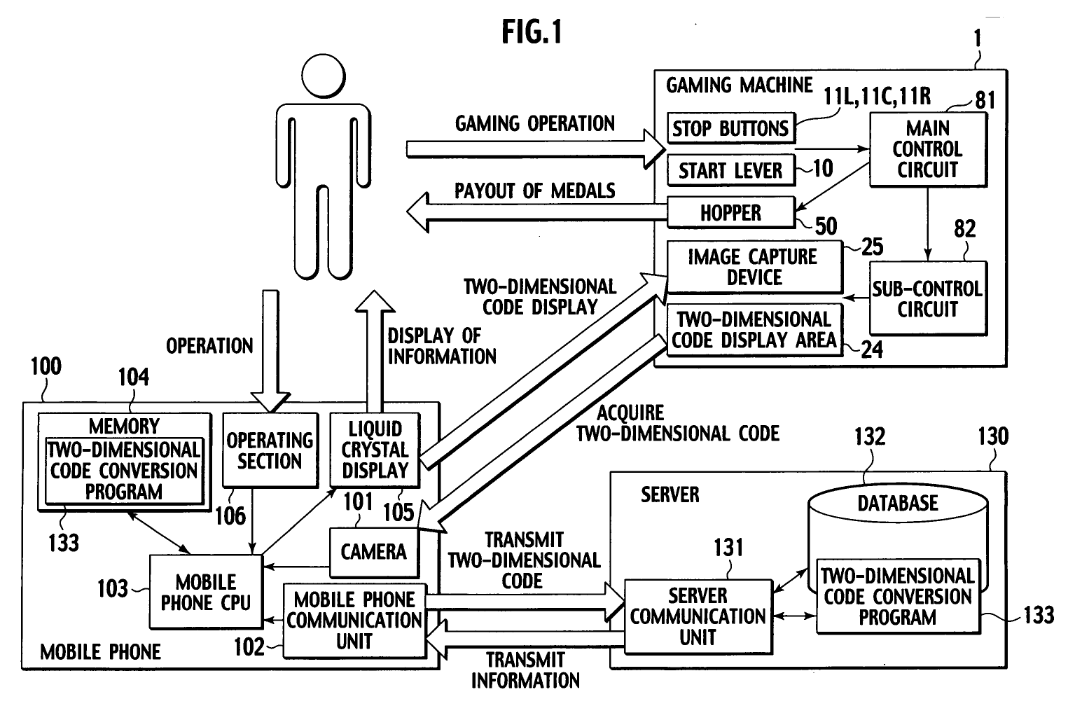

FIG. 1 is a network structure showing one example of a game system of a first embodiment. The game system comprises a pachi-slot gaming machine 1 having an image capture device 25, a mobile phone 100 with a camera 101 as an image capture device (external image capture device), and a server 130 operative to transmit data to and receive the same from the mobile phone 100 on radio over the Internet.

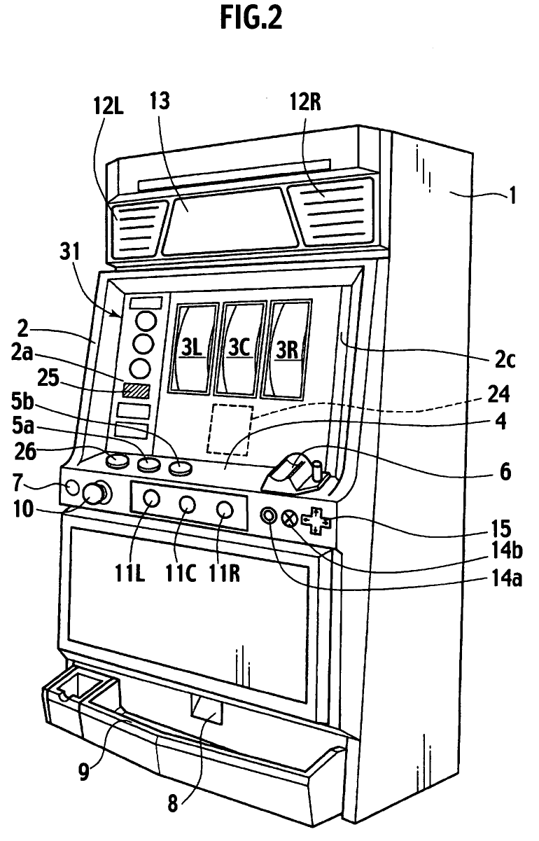

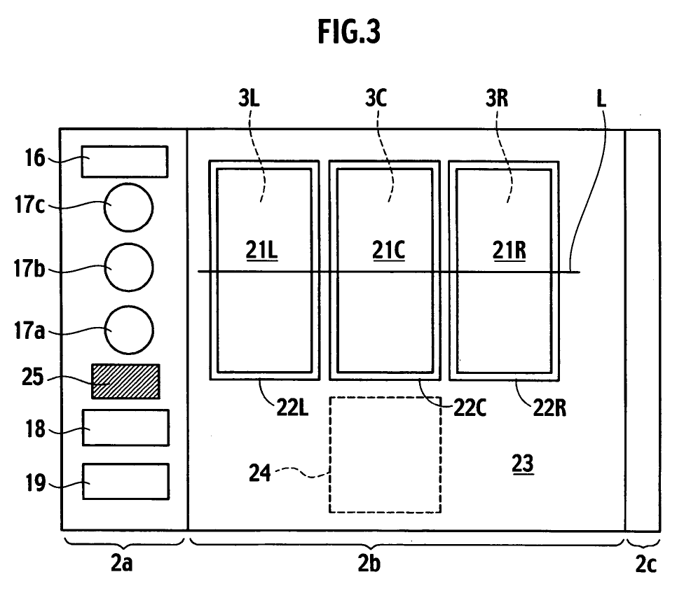

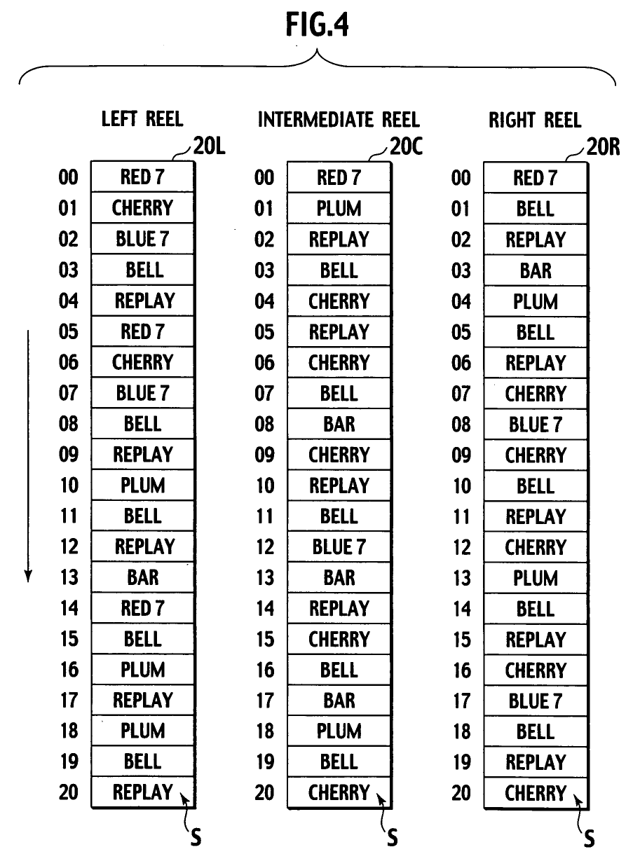

With the pachi-slot gaming machine 1, reels 3L, 3C, 3R (see FIGS. 2 and 3) are rotated upon operation of a start lever 10 and operating stop buttons 1L, 11C, 11R allows symbols (see FIG. 4) on respective outer peripheries of the reels 3L, 3C, 3R to be aligned on a predetermined winning combination so as to payout a number of medals (coins) depending on a kind of winning combination. During operation of a player to finish the game, executing a predetermined operation allows information (gaming data), related to current game, and a two-dimensional code (code information) 30 which is generated based on coded gaming data involving information (hereinafter, referred to as “gaming information”, the gaming information is information which includes past gaming result data) related to the game in the past, to be displayed over a two-dimensional code display area 24. The player is enabled to capture the two-dimensional code 30 in image using the camera 101 of the mobile phone 100.

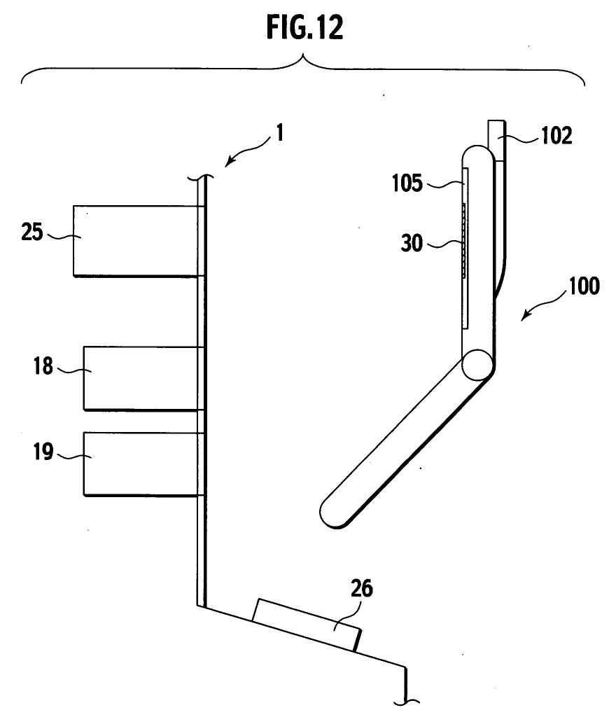

In the meanwhile, when starting a game, the player, who has the two-dimensional code 30 which is stored in his/her mobile phone 100, operates a shutter button 26 (see FIG. 12) mounted on the gaming machine 1 to cause the image capture device 25 to capture the two-dimensional code 30 displayed on a liquid crystal display (display device) 105 of the mobile phone 100 to allow the same to be read out by the pachi-slot gaming machine 1. This enables gaming information of the past to be reflected on the current game to store gaming information.

The mobile phone 100 has a first function (function as a converter) in which a conversion program 133, which is preinstalled on a memory 104, converses the captured coded image data into the two-dimensional code 30. Thereafter, the conversion program 133 generates the gaming data based on the conversed and decoded two-dimensional code 30. Additionally, as a second function (function as a display device), the image data which is coded based on the two-dimensional code 30 is displayed over the liquid crystal display 105, enabling the pachi-slot gaming machine 1 to read out the gaming data.

When the mobile phone 100 functions its first function described above, in response to a request from the mobile phone 100, the server 130 transmits the conversion program 133 for two-dimensional code 30, preliminarily stored in a database 132, to the mobile phone 100 (a first function of the server 130). Further, in cases where the mobile phone 100 transmits image data involving the second-dimensional code 30 (thus, the mobile phone 100 functions its second function described above), a CPU 135 of the server 130 executes the conversion program 133 for two-dimensional code 30 for decoding the two-dimensional code 30 inside the server 130 per se. Moreover, the server 130 transmits the gaming data, resulting from decoding the two-dimensional code 30 (decoded gaming data), to the mobile phone 100. That is, in this case, the server 130 per se practices encoding operation (as a second function of the server) in the server 130.

Thus, with the game system of the presently filed embodiment, upon operation of the player to capture the image of the two-dimensional code 30, displayed over the liquid crystal display device 31, with the camera 101 of the mobile phone 100, the player is enabled to obtain the two-dimensional code 30. Displaying the gaming data, resulting from the two-dimensional code 30, over the liquid crystal display 105 enables the player to grasp content of the gaming data. Also, by displaying the two-dimensional code 30, acquired in such a way described above, over the liquid crystal display 105 of the mobile phone 100 to allow this two-dimensional code 30 to be captured with the image capture device 25 of the pachi-slot gaming machine 1, the player is- enabled to play new game with the gaming machine with the captured two-dimensional code 30 including the past gaming data of the player. And it is also possible to update the gaming data after terminated the new game.

The pachi-slot gaming machine 1, incorporated in the game system mentioned above, corresponds to a gaming machine of the present invention. The present invention is not limited to such an example of the gaming machine and may preferably include a pachinko-gaming machine, a slot machine, etc.

While the presently filed embodiment is described with reference to an exemplary case in which code information is comprised of the two-dimensional code 30, code information may include not only the two-dimensional code 30 but also one-dimensional code (BAR code). Further, while the presently filed embodiment is described in respect of a case in which the two-dimensional code 30 is employed, it is, of course, to be appreciated that the present invention is not limited to such an exemplary case and it may be possible to use a QR code (Registered Trade Mark) forming one kind of the two-dimensional code 30. Particularly, as shown in the presently filed embodiment, in cases where the code information, displayed as an image, is transferred through an image capture device such as a camera, it may be more preferable to use the QR code that is less subjective to adverse affects such as blurring of images during operation to perform image capture. The QR code is a code that is standardized under ISO (International Organization for Standardization) and JIS (Japanese Industrial Standards) and has a capability of representing the maximum alphanumeric characters of approximately 4300 characters and Kanji (Chinese characters) and Katakana (one kind of Japanese syllabary characters) of approximately 1800 characters under a version 40. Thus, there are mobile phones with 42 models that are operative to read out a version 10 (representing the alphanumeric characters of approximately 174 to 395 characters and kanji characters and katakana of 74 to 167 characters) under a version 10 at the point of August, 2004. As used herein, the term “operative to read out” means that application software, such as a code information conversion device (code information conversion program) 133, is preliminarily installed in a mobile phone, and the code information conversion device converses/decodes a QR code (code information) obtained with the image capture device whereby generating a predetermined URL and characters which are coded in the QR code.

The mobile phone 100 corresponds to a mobile device of the present invention. Also, the present invention is not particularly limited to the mobile device of the present invention provided that the mobile device includes an image capture device operative to transmit data and receive the same from a server 130 over a network, and may include, for instance, a personal digital assistant (a so-called PDA) and a mobile terminal for the above game system only.

Further, while the first embodiment is described with reference to a case wherein data is transmitted and received between the mobile phone 100 and the server 130, the present invention is not limited to such an example and may be arranged to allow data to be transmitted and received between associated component parts over a cable line. That is, the network in the present invention may include a cable network and a radio network.

(Structure of Pachi-Slot Gaming Machine)

FIG. 2 is a perspective view typically showing one example of the pachi-slot gaming machine shown in FIG. 1. While the pachi-slot gaming machine 1 is of a gaming machine that makes it possible for a player to play a game using, in addition to coins, medals or tokens, gaming media such as a card, etc., afforded to the player or stored with information of a gaming value to be afforded, the pachi-slot gaming machine 1 will be hereunder described as using medals.

A liquid crystal display device 31 is mounted in front of a cabinet 2 by which an overall structure of the pachi-slot gaming machine 1 is formed. The liquid crystal display device 31 is configured to change its permeability related to any area, that is a part of or entire are of the liquid crystal display 31, hence it is possible to display the two-dimensional code 30 as code information on the desired position. That is, the liquid crystal display device 31 functions as a code information display device.

Further, the three reels 3L, 3C, 3R are located on a rear side of the liquid crystal display device 31 as variable display devices. The three reels 3L, 3C, 3R have respective outer peripheries provided with identification information S such as a plurality of symbols, respectively, (see FIG. 4) and line up in single file from left to right. A pedestal 4, having a horizontal surface, is formed on the cabinet 1 in an area below the liquid crystal display device 31. A medal insertion slot 6 and an accumulated medal-clearing switch 74 are disposed on a right side of the pedestal 4 and a 1-BET button 5a, a MAXIMUM-BET switch 5b and the shutter button 26, by which the image capture device 25 described below is operated, are disposed in the pedestal 4 on a left side thereof.

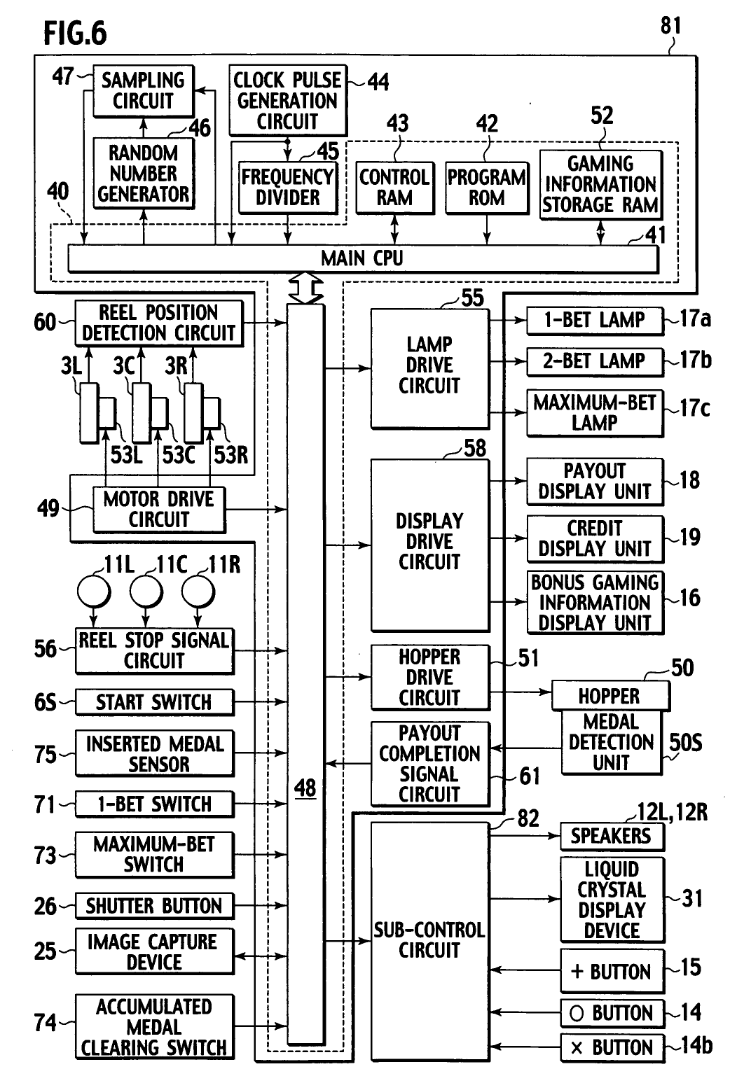

In the meanwhile, a C/P button 7 is disposed in front of the pedestal 4 at a left-leaning side thereof to switchover credit/payout of medals obtained in playing of the player upon depressive operation thereof. If “Payout” mode is selected upon switchover operation of the C/P button 7, medals are paid out from a medal payout opening 8 provided in a front area at a lower part thereof with paid out medals being accumulated in a medal receiver 9. In contrast, if “Credit” mode is selected, a value of the number of medals is stored in a memory (such as, for instance, a control RAM 43 (see FIG. 6), etc., which will be described later) incorporated in the pachi-slot gaming machine 1.

A start lever (variable display start device) 10 is mounted on the pedestal 4 in an area at a left side of the C/P button 7 for rotating capabilities within a predetermined angular range for the purpose of permitting the player to operate to rotate the reels 3L, 3C, 3R to begin variable display of the symbols S within symbol display areas 21L, 21C, 21R formed in the liquid crystal display device 31. Three stop buttons (variable display stop devices) 11L, 11C, 11R are disposed on a central area of the pedestal 4 in front thereof for the purpose of stopping rotating the three reels 3L, 3C, 3R. Further, a “◯” button 14a, a “×” button 14b and a “+” button (+shape button) 15 are mounted in front of the pedestal 4 at a right side thereof. Actuating the “◯” button 14a, the “×” button 14b and the “+” button 15 enables a display screen of the liquid crystal display device 31 to be switched over and various inputs to be entered. Mounted on upper areas of the cabinet 2 at left and right sides thereof are speakers 12L, 12R between which an award display panel 13 is disposed to designate a combination of winning symbols and the number of medals to be awarded.

Also, while the first embodiment 1 is described with reference to a case wherein the liquid crystal display device 31, function as the code information display device, is located in front of the reels 3L, 3C, 3R, the present invention is not limited to a particular position in which the code information display device is located. Moreover, while the presently filed embodiment is described with reference to a case wherein the liquid crystal display device 31 functions as the code information display device and also functions as a display device to display effect images, etc., the present invention may be implemented such that a display device, by which the effect images, etc., are provided, and the display device code information display device are separately provided.

Subsequently, referring to FIG. 3, description is made of a panel display section 2a, a liquid crystal display section 2b and a fixed display section 2c that are formed on the surface of the liquid crystal display device 31, respectively. FIG. 3 is a view for illustrating the panel display section 2a, the liquid crystal display section 2b and the fixed display section 2c in an enlarged scale.

The panel display section 2a is comprised with a bonus gaming information display unit 16, 1-BET lamps 17a to 17c, a payout display unit 18, a credit display unit 19 and the image capture device 25. The bonus gaming information display unit 16 further includes seven-segment LEDs to display the gaming information, such as the number of times available for play in RB games and the number of winning times available in RB games, etc., during operation practiced in a bonus game. The 1-BET lamp 17a, the 2-BET lamp 17b and the MAXIMUM-BET lamp 17c are lighted on depending on the number of medals (hereinafter referred to as a BET number) bet on a single game. The single game is completed when all the reels 3L, 3C, 3R are caused to stop or when the medals have been completely paid out during payout operation of the medals. Moreover, a central line on the liquid crystal display section 2b indicates one of winning lines L. The winning line L is activated depending on the number of medals being used. The determination as to whether the winning combination is present is made upon discriminating whether or not the symbols S of the reels 3L, 3C, 3R are aligned on the winning line L in a predetermined winning combination.

The payout display unit 18 is configured to display the number of medals to be paid out when the winning combination is established and the credit display unit 19 is configured to display the number of medals being accumulated (in credit). These display units are comprised of seven-segment display devices, respectively. The image capture device 25 has an interior in which a digital camera (not shown) is mounted and functions as a section to capture an object in front of the image capture device 25 in response to depressive operation of the shutter button 26 to allow the resulting image to be stored as image data. The image capture device 25 corresponds to a code information readout device.

The liquid crystal display section 2b includes symbol the display areas 21L, 21C, 21R, window frame display areas 22L, 22C, 22R, an effect display area 23 and a two-dimensional code display area 24. The effect display area 23 and the two-dimensional code display area 24 provide displays whose contents vary depending on operations of the liquid crystal display device 31 in a manner as will be described below.

Further, the symbol display areas 21L, 21C, 21R are located in areas associated with the respective reels 3L, 3C, 3R for displaying symbols S disposed on the reels 3L, 3C, 3R while providing a variety of effect displays. Here, in cases where the symbol display areas 211, 21C, 21R remain in rotations or in cases where the associated symbol display areas 211, 21C, 21R are operative to be operated for respective stops, the liquid crystal display 31 changes its permeability so that the symbol display areas 21L, 21C, 21R allow the symbols S, disposed on the reels 3L, 3C, 3R, to be transmitted in display to provide the player with ease of viewing ability.

The effect display area 23 includes the other area than the associated symbol display areas 21L, 21C, 21R and the window frame display areas 22L, 22C, 22R. The effect display area 23 functions as to display effects to provide increased entertaining and exciting properties of the game and information needed for the player to play the game with advantages. Further, the fixed display section 2c functions as an area to display various images that are predetermined. The two-dimensional code display area 24 is formed in a central area of the effect display area 23 at a region below the reels 3C. The two-dimensional code display area 24, which will be described later in detail, functions as the effect display area 23 during normal operation and also functions as an area to display the two-dimensional code 30 in an associated region under circumstances where the pachi-slot gaming machine 1 enters a gaming status that satisfies a specified condition.

Now, description is made of symbols S on sheets 20L, 20C, 20R provided on the outer peripheries of the reels 3L, 3C, 3R with reference to FIG. 4. FIG. 4 is a view for illustrating examples of the sheets 20L, 20C, 20R on the outer peripheries of the reels 3L, 3C, 3R, respectively. In FIG. 4, the sheets 20L, 20C, 20R, on the outer peripheries of the reels 3L, 3C, 3R, respectively, include 21-medals of symbols S each in a plurality of kinds. The respective symbols S are allocated with code numbers ranging from “0” to “20” and stored in a program ROM 42 as a data table. Examples of the symbols, by which the respective sheets 20L, 20C, 20R are formed, include “BLUE 7”, “RED 7”, “BAR”, “BELL”, “PLUM”, “REPLAY” and “CHERRY”. Also, the respective reels 3L, 3C, 3R are rotatably driven to allow the sheets 20L, 20C, 20R to move in a direction as shown by an arrow.

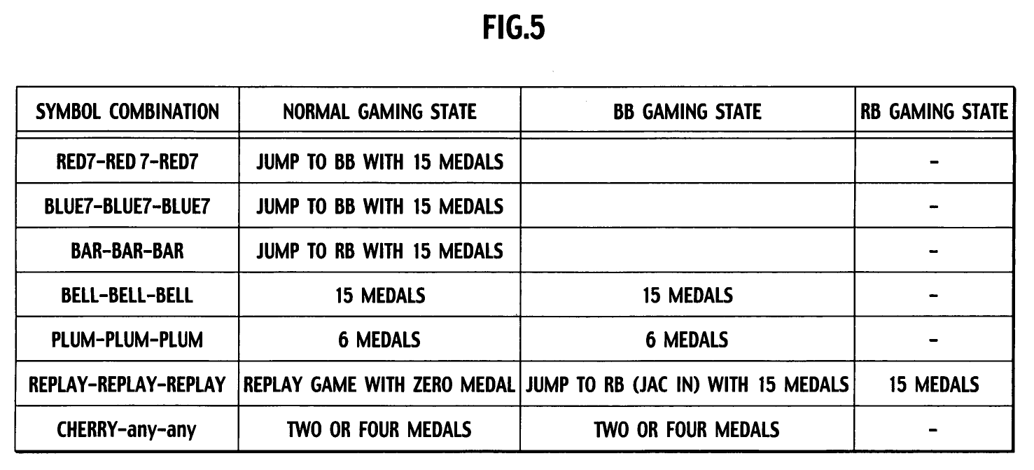

Next, description is made of the relationship between the winning combination of the respective symbols on the sheets 20L, 20C, 20R and the number of medals to be paid out with reference to FIG. 5. FIG. 5 is an award table representing the relationships among the winning symbol combinations, the winning combinations and the number of medals to be paid out in respective gaming states. Also, the award table is displayed over the award display panel 13.

The gaming states in the pachi-slot gaming machine 1 of the presently filed embodiment are separated into three gaming states involving a normal gaming state, a BB gaming state and an RB gaming state. Also, kinds of the winning combinations available to be internally won are determined in accordance with so-called odds lottery tables (which are described below) that are allocated for the gaming states, respectively. That is, for a game under the identical gaming state, an identical kind appears for a combination available to be internally won.

As shown in FIG. 5, if “BLUE 7-BLUE 7-BLUE 7” or “RED 7-RED 7-RED 7” get lined up under the normal gaming state, 15 medals of medals are paid out and the next gaming state shifts to the “BB gaming state”.

The “RB gaming state” occurs when a combination of the symbols, got lined up along the winning combination L, appears to be “BAR-BAR-BAR” under the “normal gaming state or when the combination of the symbols, got lined up along the winning combination L, appears to be “REPLAY-REPLAY-REPLAY” under the “BB gaming state” (under a so-called “JAC IN”), thereby paying out 15 medals of medals. There are times where an RB, jumped from the “normal gaming state”, is normally referred to as a usual RB to be distinguished from the RB jumped from the “BB gaming state”.

The “RB gaming state” represents a status under which the symbols get lined up like “REPLAY-REPLAY-REPLAY”, indicative of one of predetermined symbol combinations, to enter a status, under which 15 medals of medals are paid out, upon betting one medal, that is, a time period during which the medals can be easily got. The maximum number of games (hereinafter referred to as an “available number of times in RB game”) available to be played in the “RB gaming state” per one time is set to a value of 12 times. Further, under the RB gaming state, the number of available winning times (hereinafter referred to as an “available number of winning times in RB game”) is set to a value of 8 times. That is, the “RB gaming state” is completed when the number of times played on games reaches 12 times or when the number of winning times reaches 8 times. Upon completion of the RB gaming state, the gaming status is jumped to the normal gaming state.

The “BB” on one time is completed when 30 games are replayed under the normal gaming state during the BB state or at a stage when the games are jumped to the RB gaming state three times and the RB on the third time is completed. Upon completion of the BB gaming state, the game is jumped to the normal gaming state.

Under the normal gaming state, the symbol combination, got lined up along the winning line L to enter a state of “REPLAY-REPLAY-REPLAY”, represents a status with a winning on a “REPLAY” for a game wherein the reels 3L, 3C, 3R are caused to rotate without consuming any medals. Further, the number of winning medals on the normal gaming state, the BB gaming state and the other state are indicated as shown in FIG. 5.

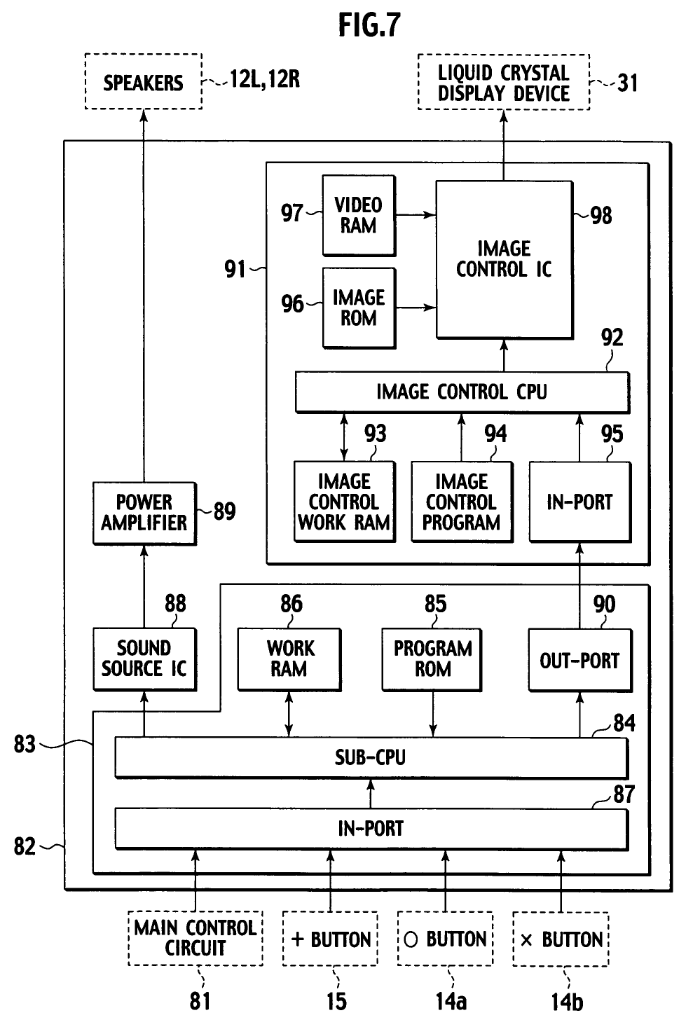

Next, a control system of the pachi-slot gaming machine 1 of the presently filed embodiment is explained with reference to FIGS. 6 and 7. FIG. 6 is a block diagram showing an internal structure of the pachi-slot gaming machine shown in FIG. 2. A main control circuit 81 includes a major component element, i.e., a microcomputer 40 mounted on a circuit substrate (not shown). The microcomputer 40 comprises a main CPU (playing a role as a gaming state varying device and a -gaming control device) 41, the program ROM 42 playing a role as a memory device, the control RAM 43 and a gaming information storage RAM 52. Connected to the main CPU 41 are a clock pulse generation circuit 44 by which reference cock pulses are set, a frequency divider 45, a random number generator 46 for generating a random number to be subjected to sampling, and a sampling circuit 47. Also, a device for sampling the random number may be formed in a structure so as to execute the sampling of the random number on an operation program of the CPU 41.

The ROM 42 stores therein various control commands to be transmitted to a sub-control circuit 82. As the relevant commands, the ROM 42 stores commands related to display controls for the liquid crystal display device 31.

Examples of the commands, related to display controls for the liquid crystal display device 31, may include, for instance, a start effect command, a completion effect command, etc. The start effect command includes a command by which an effect image is displayed over the liquid crystal display device 31 at a start when the three reels 3L, 3C, 3R are rotated. The completion effect command includes a command by which an effect image is displayed over the liquid crystal display device 31 when rotations of all the three reels 3L, 3C, 3R are completed. Further, the commands, related to the setting or the canceling of the “RB” and “BB”, are stored in the ROM 42 and the sub-control circuit 82 is notified with the setting or the canceling of the “RB” and “BB” through the relevant commands. Also, in place of using the commands related to the setting or the canceling of the.“RB” and “BB”, the various commands, related to the display controls of the liquid crystal display device 31, may include data indicative of the “RB” or “BB” being under execution.

The main CPU 41 retrieves the various commands, set forth above, from the ROM 42 upon establishment of a predetermined condition. Then, the commands, set in the RAM 43, are supplied to the sub-control circuit 82 at a predetermined timing. The sub-control circuit 82 executes various operations based on the commands being supplied. Moreover, with the presently filed embodiment, no operation is executed by the sub-control circuit 82 to input the commands to the main control circuit 81 and communication is established in one way from the main control circuit 81 to the sub-control circuit 82. In addition, the ROM 42 stores therein a winning symbol combination table, wherein the symbol table (see FIG. 4), set forth above, the symbol combinations representative of the winnings, the winning award medal number and winning determination codes, indicative of the relevant winnings, are associated, and an odds lottery table or the like needed for executing the lottery to determine an internal winning combination. Moreover, the ROM 42 may stores the other factors such as, for instance, a credit number, etc., corresponding to the number of medals, variables related to a gaming progress and flags, etc.

The gaming information storage RAM 52 stores various information related to the games in the pachi-slot gaming machine 1. With the presently filed embodiment, gaming data to be stored in the gaming information storage RAM 52 may include various information resulting from summing up the games practiced by the player, such as the number of career game medals used by the player, the number of career times on “BB” and the number of career times on “RB”, and information on the number of used game medals summed up for each model of the pachi-slot gaming machine 1 or the like, the number of times on “RB” and the number of times on “BB”, etc.

Major peripheral devices (actuators), whose operations are controlled in response to the control signals delivered from the microcomputer 40, may include the various lamps (1-BET lamp 17a, the 2-BET lamp 17b and the MAXIMUM-BET lamp 17c), various display units (the payout display unit 18, the credit display unit 19 and the bonus gaming information display unit 16), the image capture device 25 acquiring an object in a forward area as image data in association with the depressive operation of the shutter button 26, a hopper (inclusive of a driver section for executing the payout) for performing the payout of a predetermined number of medals in accordance with a command from the hopper drive circuit 51, and stepping motors 53L, 53C, 53R by which the reels 3L, 3C, 3R are rotatably driven.

Additionally, the motor drive circuit 49 for controllably driving the stepping motors 53L, 53C, 53R, the hopper drive circuit 51 for controllably driving the hopper 50, the lamp drive circuit 55 for controllably driving the various lamps and the display driver circuit 58 for controllably driving the various display sections are connected to an output section of the main CPU 41 via an I/O port 48. These driver circuits control the operations of the respective actuators in response to control signals such as driving commands or the like outputted from the main CPU 41.

Further, major input signal generators for generating input signals needed for the microcomputer 40 to generate control commands include the start switch 6S, the shutter button 26, the 1-BET switch 71, the MAXIMUM-BET switch 73, the accumulated medal-clearing switch 74, an inserted medal sensor 75, the reel stop signal circuit 56, the reel position detection circuit 60 and a payout completion signal circuit 61. These component parts are also connected to the main CPU 41 via the I/O port 48.

The start switch 6S detects the start lever 10 being operated. The shutter button 26 generates a start signal by which the image capture device 25 is actuated. The inserted medal sensor 75 detects the medals inserted to the medal insertion slot 6. The reel stop signal circuit 56 generates stop signals depending on the operations of the respective stop buttons 11L, 11C, 11R. Upon actuations of the “◯” button 14a, the “×” button 14b and “+” button 15, the display screens of the liquid crystal display device 31 can be switched over and the commands can be inputted.

The reel position detection circuit 60 transmits signals, for detecting respective positions of the reels 3L, 3C, 3R in response to the pulse signals delivered from the reel rotation sensors, to the main CPU 41. The payout completion signal circuit 61.generates a medal payout completion signal when a count value (representing the number of medals paid out from the hopper 50) reaches the number of medals being predetermined. Upon receipt of this medal payout completion signal, the main CPU 41 permits the hopper drive circuit 51 to stop driving the hopper 50, thereby completing the payout of the medals. The medal detection unit 50S includes a medal sensor (not shown), composed of a physical sensor or the like for detecting the medals being paid out from the hopper 50, which is able to count the number of paid out medals.

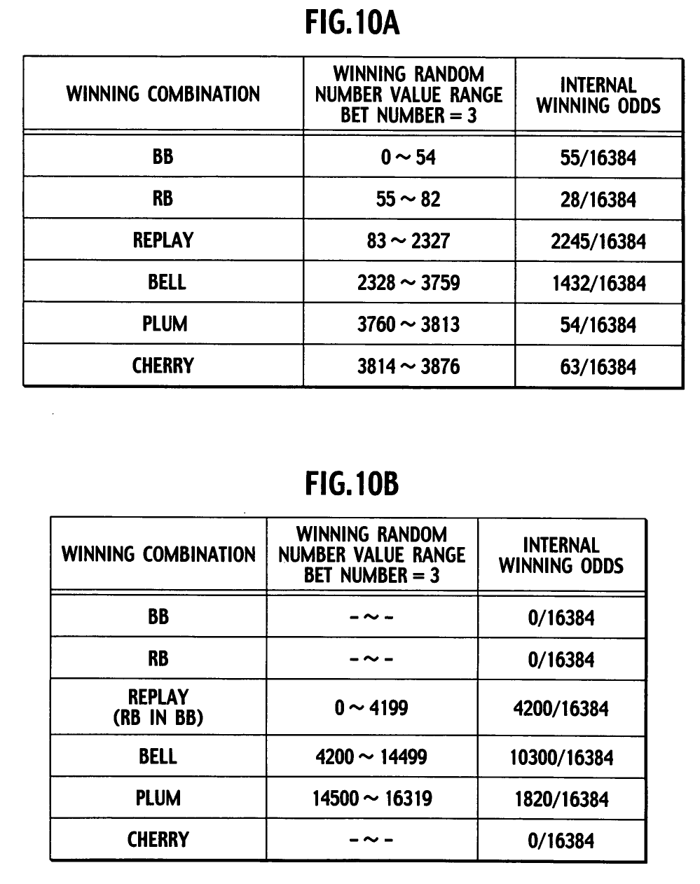

With the circuit shown in FIG. 6, the random number generator 46 generates a random number that belongs to a certain numeric value range and the sampling circuit 47 functions to execute the sampling of one random number at an appropriate timing after the start lever 10 is operated. The internal winning combination is determined based on the random number subjected to the sampling in such a way, and the odds lottery table (see FIGS. 10A, 10B) stored in the ROM 42 that will be described below. Upon determination of the internal winning combination, the random number is subjected to the sampling again for selecting a “stop control table”.

Now, the odds lottery tables are explained. The odds lottery tables are provided depending on the gaming states, respectively. Here, description is made of one example of such tables. FIG. 10A is an odds lottery table for use in the normal gaming state and FIG. 10B is an odds lottery table for use in the normal gaming state under the BB. Even with any of the odds lottery tables, a random number range is set in a value ranging from 0 to 16383 and the internal winning combination is determined by using one random number selected from the random numbers present in such a range. For instance, if the selected random number represents a value of 2851 under the normal gaming state, the internal winning combination in this game represents the “BELL”. Also, if the selected random number appears in a range from 11036 to 16383, the internal winning combination in this game represents the “LOSING”. As described above, after the internal winning combination has been determined based on the sampled random number and the odds lottery table, the random numbers are subjected to the sampling again for selecting the “stop control table”.

In the meanwhile, after the reels 3L, 3C, 3R have begun to rotate, the operation is executed to count the drive pulses being supplied to the stepping motors 53L, 53C, 53R, with the resulting count value being written into a given area of the control RAM 43. Reset pulses are obtained from the reels 3L, 3C, 3R, respectively, for each revolution, with these pulses being inputted to the main CPU 41 via the reel position detection circuit 60. Upon receipt of these reset pulses obtained in such a way, the count value of the drive pulses counted by the control RAM 43 is reset to “0”. This allows the control RAM 43 to store the count value associated with the rotational positions of the respective reels 3L, 3C, 3R, respectively, within a range for one revolution of each reel.

Further, the program ROM 42 stores therein the winning symbol combination table. The winning symbol combination table is referred to when confirming the winning at time when the left reel 3L, the central reel 3C and the right reel 3R are controllably stopped and when all the reels 3L, 3C, 3R are stopped.

In cases where the internal winning combination takes place due to the lottery operation (odds lottery operation) based on the sampling on the random number as set forth above, the main CPU 41 delivers signals, for controlling the reels 3L, 3C, 3R, to the motor drive circuit 49 based on the operation signals, delivered from the reel stop signal circuit 56 at the timing when the player depresses the stop buttons 11L, 11C, 11R, and the selected stop control table.

In cases where a situation stands for a stop mode representing that an internally won combination is established to be winning, if the C/P button 7 is shifted to select the “Payout” mode, then, the CPU 41 supplies a payout command signal to the hopper drive circuit 51 to allow the hopper 50 to payout a predetermined number of medals. In this moment, the medal detection unit 50S counts the number of medals being paid out from the hopper 50 and when the count value reaches the predetermined number, a medal payout completion signal is inputted to the main CPU 41. This allows the main CPU 41 to stop driving the hopper 51 via the hopper drive circuit 51, thereby finishing the “medal payout operation”. On the contrary, if the “Credit” mode is selected due to the shift of the C/P button 7, the number of medals to be paid out is stored in the program RAM 43. The sub-control circuit 82 is connected to the main control circuit 81 equipped with the main CPU 41. The sub-control circuit 82 performs display controls for the liquid crystal display device 31 and the output controls for sounds reproduced by the speakers 12L, 12R based on the control commands delivered from the main control circuit 81.

FIG. 7 is a block diagram showing a structure of the sub-control circuit shown in FIG. 6. A sub-microcomputer 83 of the sub-control circuit 82 includes a sub-CPU 84, a program ROM 85 and a work RAM 86. Further, the “◯” button 14a, the “+” button 15, and the “×” button 14b are connected to the sub-control circuit 82 via an IN port 87. Also, the sub-control circuit 82 allows the image control circuit 91 to execute the display controls for the liquid crystal display device 31, while permitting a sound source IC 88 and a power amplifier 89 to perform controls related to the sounds regenerated by the speakers 12L, 12R.

The sub-CPU 84 has a function to execute various operations in accordance with the programs stored in the program ROM 85, while controlling the sub-control circuit 82 in accordance with the various commands supplied from the main CPU 41. Especially, the sub-CPU 84 performs the display control for the image control circuit 91. In addition, upon the completion of the game by the player at time when the accumulated medal-clearing switch 74 is inputted in the presently filed embodiment), the sub-CPU 84 encodes gaming data to generate the two-dimensional code 30 which in turn is stored in the work RAM 86. Then, the sub-CPU 84 selects a display pattern for the two-dimensional code 30 from the main control circuit 81 for transmission to an image control CPU 92. The display pattern for the two-dimensional code 30 may include various data, such as a position at which and a time period in which the two-dimensional code 30 is displayed, needed for the two-dimensional code 30 to be displayed. As described below, upon receipt of the display pattern of the two-dimensional code 30, the image control CPU 92 executes the operations to read out the two-dimensional code 30 from the work RAM 86 based on the relevant display pattern of the two-dimensional code 30 for display on the liquid crystal display device 31. Also, while the presently filed embodiment is described in conjunction with an exemplary case wherein gaming data is encoded into the two-dimensional code 30, the present invention may be implemented in such a way to allow the two-dimensional code 30 to be preliminarily stored in the image ROM 96 or the like.

The program ROM 85 stores therein programs, by which the sub-CPU 84 controls gaming effects to be provided in the liquid crystal display device 31, and programs for executing character display operations to allow the characters, to be displayed over the liquid crystal display device 31, which is described below, to be altered depending on the content of gaming data. In addition to these programs, the program ROM 85 stores various tables such as tables, based on which character patterns are determined, and tables, etc., based on which determinations related to the effects are made. Moreover, the program ROM 85 stores a plurality of kinds of effect patterns associated with screen images to be displayed over the liquid crystal display device 31, a plurality of kinds of completion effect patterns associated with the screen images to be displayed over the liquid crystal display device 31 when all the reels 3L, 3C, 3R are stopped. Additionally, the program ROM 85 stores the display pattern for the two-dimensional code 30 involving various data for displaying the two-dimensional code 30.

Also, while the presently filed embodiment is structured in a way to use the program ROM 85 as storage medium for storing the programs and tables, etc., the present invention is not limited to such a structure and may take another form of storage medium, such as for instance storage medium like CD-ROM, etc., available to be read by a computer that is equipped with a CPU, etc. Of course, those, which are stored in the program ROM 85, may be stored in the ROM 42.

The work RAM 86 has a function to store a variety of flags and values of variables in a temporary storage area of the sub-CPU 84. Further, the work RAM 86 stores the two-dimensional code 30 resulting from encoding gaming data. Also, while the presently filed embodiment employs the work RAM 86 as the temporary storage area of the sub-CPU 84, the present invention is not limited to such a storage means and may include storage medium that is readable.

Further, the controls related to the sounds are executed by the sound source IC 88 for performing the controls related to voices, the power amplifier 89 for amplifying voice signals, and the sub-CPU 84. The sound source IC 88 is connected to the sub-CPU 84 and the power amplifier 89. The sound source IC 88 performs the controls of the voices generated by the speakers 12L, 12R.

The sub-CPU 84 selects one voice data from among a plurality of voice data stored in the program ROM 85 in response to the command supplied from the main CPU 41. Subsequently, the sub-CPU 84 reads out selected voice data from the program ROM 85 for supply to the sound source IC 88. Upon receipt of voice data, the sound source IC 88 converts the resulting voice data into a predetermined voice signal, which in turn is supplied to the power amplifier 89. The power amplifier 89 amplifies the voice signal to reproduce a voice from the speakers 12L, 12R.

Depending on the gaming result determined by the main CPU 41 or the commands inputted by the “O” button 14a, the ” X ” button 14b and the “+” button 15, the image control circuit 91 controls to generate a screen image while displays the above screen image over the liquid crystal display device 31 and is comprised of an image control CPU 92, an image control work RAM 93, an image control program ROM 94, an IN-port 95, an image ROM 96, a video RAM 97 and an image control IC 98.

Depending on parameters set by the sub-microcomputer 83, the image control CPU 92 determines a display content to be provided over the liquid crystal display device 31 in accordance with the image control program stored in the image control program ROM 94. The image control program ROM 94 stores therein an image control program and various selection tables related to the display, such as a display of the two-dimensional code 30 and a display of the characters, to be provided over the liquid crystal display device 31. The image control work RAM 93 is structured as a temporally storage device when permitting the image control CPU 92 to execute the image control program. The image control IC 98 forms an image, depending on the display content determined by the image control CPU 92, which in turn is outputted to the liquid crystal display device 31. The video RAM 97 is structured as a temporally storage device when permitting the image control IC 98 to form the image.

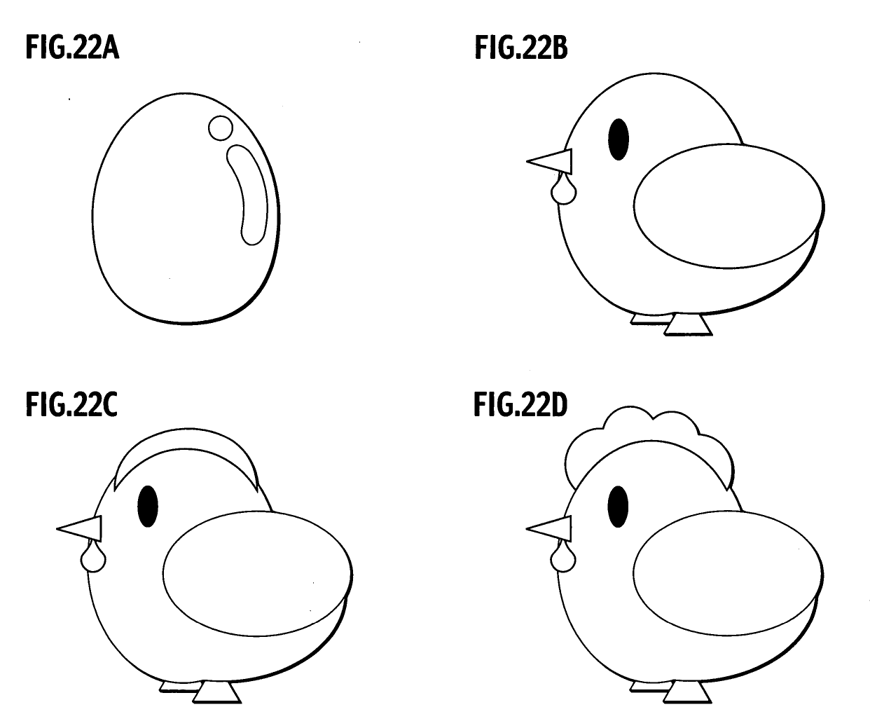

The image ROM 96 stores character images (FIGS. 22A through 22D), etc., representing, for instance, background images and characters. While the presently filed embodiment is described with reference to a case wherein the gaming data is encoded into the two-dimensional code 30, the present invention may be implemented in such a way to allow the two-dimensional code 30 to be preliminarily stored in the image ROM 96.

The image control CPU 92 selects the effect images from the image ROM 96 depending on an image display command supplied from the sub-CPU 84. Further, upon receipt of the display pattern for the two-dimensional code 30 from the sub-CPU 84, the image control CPU 92 selects the two-dimensional code 30 from the work RAM 86 based on the display pattern for the two-dimensional code 30.

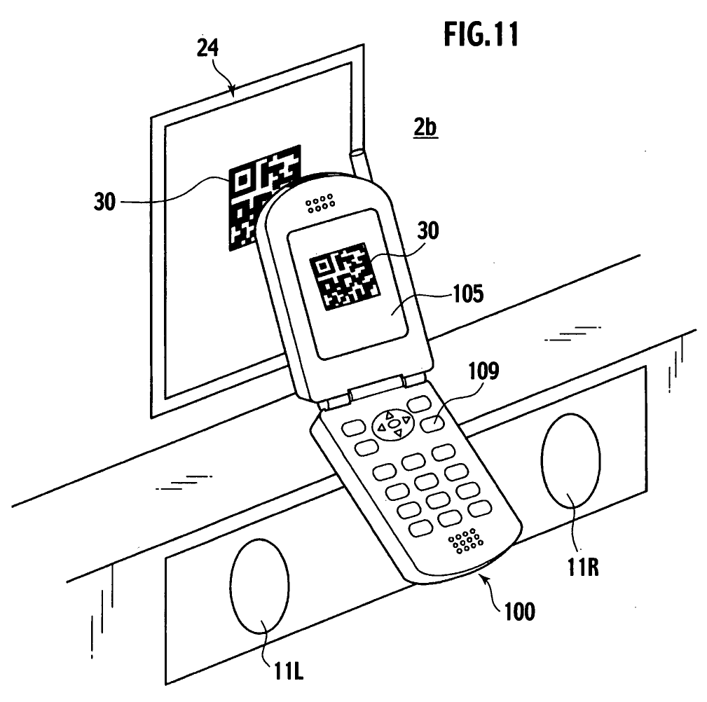

The image control CPU 92 stores various images, extracted from the image ROM 96 or the work RAM 86, in the video RAM 97 such that, for instance, the background image, the character image and the two-dimensional code 30 are overlapped in this order from an image located rearward, thereby synthesizing a screen image which in turn is supplied to the liquid crystal display device 31 at a predetermined timing. As a result, the two-dimensional code 30 is displayed on the liquid crystal display device 31 (see FIG. 11). The player is enabled to use the camera 101, incorporated in the mobile phone 100, for capturing the two-dimensional code 30 displayed in the two-dimensional code display area 24 of the liquid crystal display device 31 as shown in FIG. 11. When this takes place, the liquid crystal display device 31 functions as a code information display device that allows the two-dimensional code 30 (code information), which is generated based on the coded gaming data related to a lottery outcome, to be displayed in a mode available for the camera 101 (readout device) to capture in image.

In the meanwhile, image data involving the two-dimensional code 30 is displayed over the mobile phone 100 as shown in FIG. 12 and the image capture device 25 of the pachi-slot gaming machine 1 is also enabled to capture the image shown on the liquid crystal display 105 of the mobile phone 100. Such an operation enables the pachi-slot gaming machine 1 to get the gaming data. When this takes place, the image capture device 25 functions as a code information readout device by which the code information is read out.

Also, while the first embodiment is described with reference to a case wherein the sub-CPU 84 is encoded into the two-dimensional code 30, the present invention may be implemented such that the two-dimensional code 30 is preliminarily stored in the memory device incorporated in the gaming machine. In such a case, at least more than one table data, associated with a certain random number value and image data of the two-dimensional code 30, are preliminarily stored in the memory device, mentioned above, to allow image data of the two-dimensional code 30 to be displayed over the liquid crystal display device 31 depending on the random number associated with the lottery outcome.

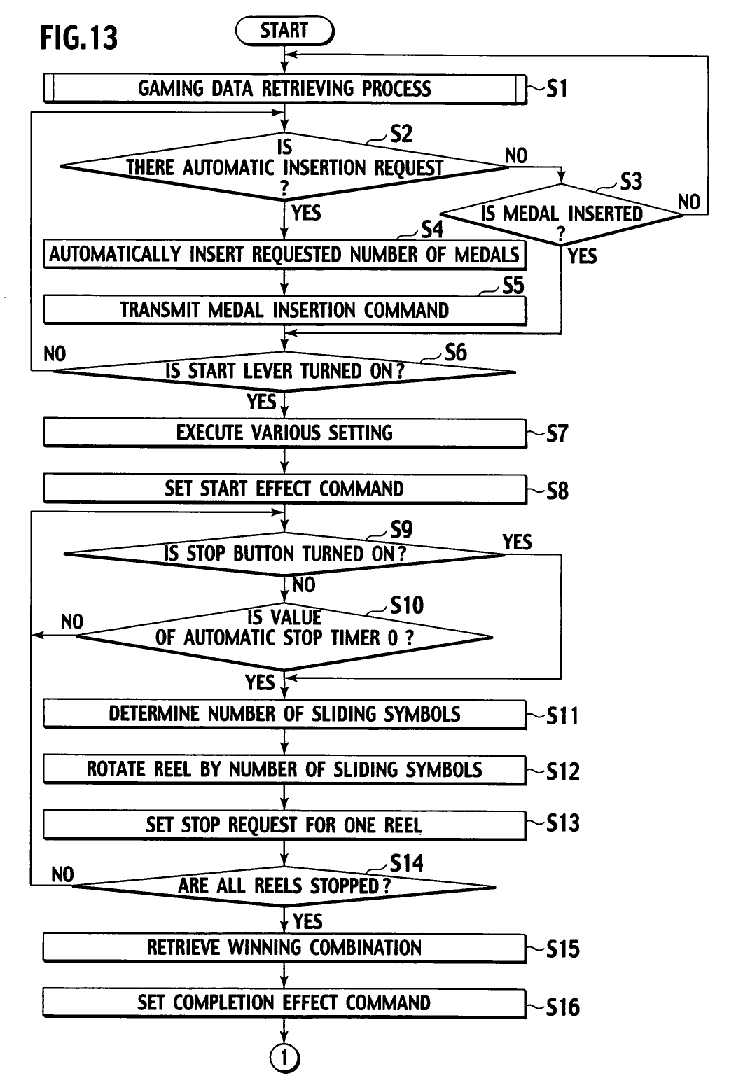

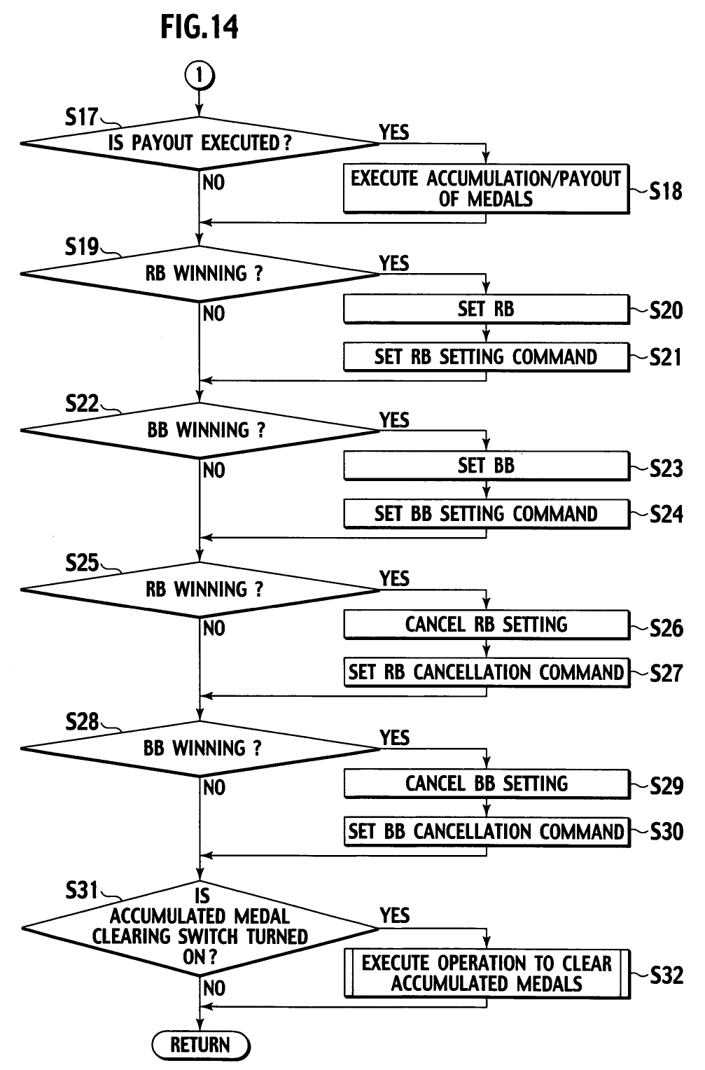

Now, description is made of a game execution process to be carried out in the pachi-slot gaming machine 1 according to the present invention. It is hereunder supposed that the pachi-slot gaming machine 1 is started up and variables to be used in the main CPU 41 are initialized to predetermined values whereas the pachi-slot gaming machine 1 remains under steady state operation with preset values being set to respective predetermined values. FIGS. 13 and 14 are flowcharts showing a main routine of the game execution process to be conducted in the main control circuit 81.

First in step 1 (hereinafter abbreviated as “S”), a gaming data retrieving process is carried out. Upon execution of such gaming data execution process (S1), gaming data (gaming information) of the past is retrieved as the two-dimensional code 30 that is stored in the gaming information storage RAM 52. Also, the gaming data retrieving process is described below in detail with reference to the accompanying drawings. After the gaming data (gaming information) has been retrieved, the operation goes to S2. In S2, the main CPU 41 determines whether or not there is a request for automatic insertion of medals. Also, as used herein, the term “a case wherein there is a request for automatic insertion of medals” refers to a case wherein a winning combination is established on a “REPLAY” in a preceding game. In the presence of the request for automatic insertion of medals, the operation is executed to automatically insert the requested number of medals (S4) upon which a medal insertion command is transmitted to the sub-control circuit 82 (S5).

On the contrary, if determination is made that the request for automatic insertion of medals is absent, then, the main CPU 41 determines whether or not the medals are inserted (S3). That is, the main CPU 41 determines whether or not a detection signal, resulting from the inserted medal sensor 75 detecting the presence of the medals being inserted to the insertion slot 6, is received or determines whether or not a detection signal, resulting from the BET-switch (the 1-BET switch 71 or the MAXIMUM-BET switch 73), is received, thereby determining whether or not the medals are inserted. Also, if determination is made that the detection signal, generated by the BET-switch (the 1-BET switch 71 or the MAXIMUM-BET switch 73), is received, the main CPU 41 executes the operation to subtract a credit number, equivalent to the number of medals that are bet, from the credit number stored in the control RAM 43.

In S3, if determination is made that no medals are inserted, then, the main CPU 41 restores the operation to S1. In contrast, if determination is made that the medals are inserted or if the operation in S5 is executed, then, the main CPU 41 determines whether or not the start lever 10 is operated (S6). That is, the main CPU 41 serves to discriminate whether or not the input signal is received from the start switch 6S.

In S6, if determination is made that no start lever 10 is operated, the main CPU 41 restores the operation to S2. On the contrary, if determination is made that the start lever 10 is operated, the main CPU 41 executes operations related to various setting (S7). During such operations to set various setting, the operation is executed to perform the sampling of the random number resulting from the random number generator 46 at the timing in which the start lever 10 is operated, thereby executing a lottery operation by which an internal winning combination (winning flag) is generated based on the sampled random number and the odds lottery table (see FIGS. 10A and 10B) set in the control RAM 43. Further, during such operations to set various setting, the main CPU 41 executes the operation related to a selection of a stop control table, for stopping the reels 3L, 3C, 3R, and the operation to achieve the initialization for rotating the reels 3L, 3C, 3R, thereby commencing the rotations of the reels 3L, 3C, 3R.

After the reels 3L, 3C, 3R have begun to rotate, the numbers of drive pulses transmitted to the stepping motors 53L, 53C, 53R, respectively, are counted with the resulting count values being stored in the RAM 43. Reset pulses are obtained from the reels 3L, 3C, 3R for each revolution of each reel and are inputted to the main CPU 41 via the reel position detection circuit 60. With the reset pulses being obtained in such a way, the count values of the drive pulses counted by the control RAM 43 are reset to “0”, respectively. By so doing, the control RAM 43 stores therein the count values, associated with the rotational positions within the ranges of respective one revolution of the reels 3L, 3C, 3R. Further, with the symbol table (see FIG. 4) stored in the program ROM 42 in order to allow the rotational positions of the reels 3L, 3C, 3R and the symbols S, on the outer peripheries of the reels 3L, 3C, 3R, to be associated with each other, code numbers, sequentially allocated to the respective reels 3L, 3C, 3R for certain rotational pitches thereof, and symbol codes indicative of the symbols S, provided in association with the respective code numbers, are correlated to each other. Further, the winning symbol combination table, stored in the program ROM 42, is referred to when controllably stopping the reels 3L, 3C, 3R or when executing a wining confirmation after all the reels 3L, 3C, 3R are stopped. After the operation in S7 has been executed, the main CPU 41 restores the operation to S8.

In S8, the main CPU 41 sets a start effect command to the control RAM 43. The start effect command functions as a command by which the liquid crystal display device 31 is started to provide a display of a predetermined effect image and includes data related to the internal winning combination that is determined in the lottery operation set forth above. The start effect command is supplied to the sub-control circuit 82 at a predetermined timing. After the operation in S8 is executed, the main CPU 41 restores the operation to S9.

In S9, the main CPU 41 determines whether or not the stop buttons 11L, 11C, 11R are turned “ON” depending on the presence of or absence of the input signals from the reel stop signal circuit 56 (S9). If determination is made that the stop buttons 11L, 11C, 11R are not turned “ON”, the main CPU 41 determines whether or not a value of an automatic stop timer lies at a value of “0”. In S10, if determination is made that the value of the automatic stop timer does not fall in the value of “0”, the operation is routed back to S9.

On the contrary, if determination is made that the stop buttons 11L, 11C, 11R are turned “ON” or if determination is made that the value of the automatic stop timer lies at the value of “0”, the main CPU 41 stops the rotations of the reels 3L, 3C, 3R in association with the depressed stop buttons 11L, 11C, 11R. In such moment, the operation is executed to determine the number of sliding symbols based on a winning request (i.e., internal winning combination), positions (rotational positions of the reels 3L, 3C, 3R during operation) of the symbols S and selected stop control table or the like (S11).

Next, the main CPU 41 executes the rotations of the reels 3L, 3C, 3R for the numbers of rotations by respective values equivalent to the numbers of sliding symbols determined in S11 after which the reels 3L, 3C, 3R are caused to stop (S12), upon which a stop request is set on one reel (S13). Then, the main CPU 41 determines whether or not all the three reels 3L, 3C, 3R are stopped (S14). If determination is made that all the three reels 3L, 3C, 3R are not stopped, the operation is routed back to S9. On the contrary, if determination is made that all the three reels 3L, 3C, 3R are stopped, the main CPU 41 performs the winning retrieval (S15). When this takes place, retrieval operation is executed by referring to the winning symbol combination table stored in the program ROM 42. Further, an alteration may be such that determination is made whether or not winning flag is normal upon which if winning flag is found not to be normal, the operation is interrupted upon executing the operation to display an illegal error.

After the winning retrieval (S15) has been executed, the main CPU 41 sets a completion effect command to the program RAM 43 (S16). The completion effect command represents a command that allows an effect image for the completion of the game to be displayed depending on a gaming outcome and includes data related to the result of the winning retrieval in step S15. The completion effect command is supplied to the sub-control circuit 82 at a predetermined timing.

Next, the main CPU 41 determines whether or not the medals are paid out or the presence of or absence of the number of winnings (S17). If determination is made that the medals are paid out, the main CPU 41 executes the operations to accumulate or payout the number of medals depending on the gaming state and the winning combination (S18). When performing the operation to accumulate medals, the main CPU 41 executes the operation to allow the credit number, stored in the program RAM 43, to be added. On the contrary, when performing the payout of medals, the main CPU 41 transmits a payout command signal to the hopper drive circuit 51 by which the hopper 50 is allowed to payout a predetermined number of medals. In this moment, the medal detection unit 50S counts the number of medals paid out from the hopper 50 after which when the count value reaches a predetermined number, a medal payout completion signal is inputted to the main CPU 41. This allows the main CPU 41 to stop driving the hopper 50 via the hopper drive circuit 51, thereby completing the payout operation of medals.

Subsequently, the main CPU 41 determines whether or not the winning occurs on “RB” (S19). If determination is made that the winning occurs on “RB”, the main CPU 41 executes the operation related to the “RB” setting (S20). In S20, the main CPU 41 executes the operations related to the odds lottery table for “RB” and the winning symbol combination table for “RB”. Further, in S20, the main CPU 41 begins to count the “RB” game winning times, etc., to allow the resulting count value to be displayed over the bonus gaming information display unit 16, while commencing to execute the operation to update gaming data stored in the gaming information storage RAM 52. After the operation in S20 has been executed, the main CPU 41 restores the operation to S20.

In S21, the main CPU 41 sets an “RB” setting command to the program RAM 43. The “RB” setting command represents a command, by which an effect image for “RB” is displayed over the liquid crystal display device 31 as a screen image, which is supplied to the sub-control circuit 82 at a predetermined timing.

If determination is made in S19 that no winning occurs on “RB” or if the operation in S21 is executed, the main CPU 41 determines whether or not the winning occurs on “BB” (S22). If determination is made that the winning occurs on “BB”, then, the main CPU 41 executes the operations related to the setting of “BB” (S23). In S23, the main CPU 41 executes the operations to perform the setting of the odds lottery table for “BB”, the winning symbol combination table for “BB”, etc. Further, in S23, the main CPU 41 begins counting the number of times the “BB” games being practiced, displaying the resulting count value over the bonus gaming information unit 16 and counting the paid out medals. Furthermore, the operation is executed to alter the content of the gaming data, related to “BB”, for the gaming data stored in the gaming information storage RAM 52. In this moment, the main CPU 41 functions as a gaming state updating device by which the operation is shifted to a special gaming state (“BB”). Subsequently, the main CPU 41 restores the operation to S24.

In S24, the main CPU 41 sets a “BB” setting command to the control RAM 43. The “BB” setting command represents a command, permitting an effect image for “BB” to be displayed over the liquid crystal display device 31 as a screen image, which is supplied to the sub-control circuit 82 at a predetermined timing.

If determination is made in S22 that no winning occurs on “BB” or if the operation in S24 is executed, the main CPU 41 determines whether or not the “RB” is completed (S25). If determination is made that the “RB” is completed, then, the main CPU 41 executes the operation related to cancellation of the setting on “RB” (S26). In S26, the main CPU 41 executes the operation to alter the setting from the odds lottery table for “RB”, set in the operation in S20, and the winning symbol combination table for “RB”, etc., to the odds lottery table for use in a normal gaming state (except for those of “RB” or “BB”), while executing the operation to store information, such as the medal number, etc., got in the relevant “RB”, in the gaming information storage RAM 52 as the gaming data. Subsequently, the CPU 41 restores the operation to S27.

In S27, the main CPU 41 allows an “RB” canceling command 4o be set to the control RAM 43. The “RB” canceling command represents a command by which the operation is executed to stop the display of the effect image for “RB”, provided in display as the screen image, while permitting a normal effect image (except for those of “RB” or “BB”) to be displayed over the liquid crystal display device 31. The “RB” canceling command is supplied to the sub-control circuit 82 at a predetermined timing.

In S25, if determination is made that no “RB” is completed or if the operation in S27 is executed, the main CPU 41 determines whether or not the “BB” is completed. If determination is made that “BB” is completed, then, the main CPU 41 executes the operation related to the “BB” setting cancellation (S29). In S29, the main CPU 41 executes the operations to alter the setting from the odds lottery table for “BB”, set in the operation in S22, and the winning symbol combination table for “BB”, etc., to the odds lottery table for use in the normal gaming state (except for those of “RB” or “BB”), while executing the operation to store information, such as the medal number, etc., got in the outcome of the relevant “BB”, in the gaming information storage RAM 52 as the gaming data. Subsequently, the CPU 41 restores the operation to S30.

In S30, the main CPU 41 allows a “BB” canceling command to be set to the control RAM 43. The “BB” canceling command represents a command by which the operation is executed to stop displaying the effect image for “BB”, provided in display as the screen image, while permitting the normal (except for those of “RB” or “BB”) effect image to be displayed over the liquid crystal display device 31. The “BB” canceling command is supplied to the sub-control circuit 82 at a predetermined timing.

In S27, if determination is made that no “RB” is completed or if the operation in S29 is executed, determination is made whether or not the accumulated medal-clearing switch 74 is inputted (S31). The accumulated medal-clearing switch 74 represents a switch, located in front of the pachi-slot gaming machine at a position rightward of the medal insertion slot 6, and inputting the accumulated medal-clearing switch 74 allows all the game medals, stored in the pachi-slot gaming machine 1, to be paid out. Since the accumulated game medals are necessarily paid out when the player finishes playing the game with the pachi-slot gaming machine 1, inputting the accumulated medal-clearing switch 74 enables the confirmation on the player's intention to finish the game. That is, in S31, determination is made whether or not the player finishes the game.

If the accumulated medal-clearing switch 74 is inputted, the operation goes to S32, upon which an accumulated medal clearing process is executed. The accumulated medal clearing process (S32), which will be described below in detail, is a process by which the medals, accumulated inside the pachi-slot gaming machine 1, are paid out while converting the gaming data, stored in the gaming information storage RAM 52, into the two-dimensional code 30 for display over the liquid crystal display device 31. On the contrary, if no accumulated medal-clearing switch 74 is inputted, a main routine of the game execution process is completed.

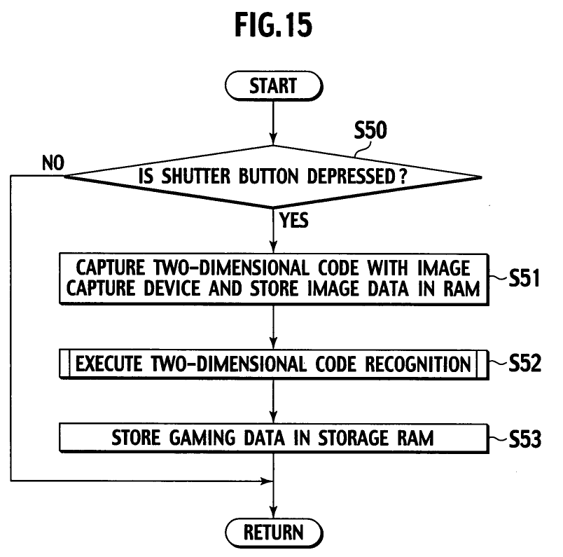

Now, the gaming data retrieving process (S1) to be executed in the main routine of the pachi-slot gaming machine 1 is described below in detail with reference to FIG. 15. The accumulated medal clearing process is a process by which the gaming data, displayed over the liquid crystal display 105 of the mobile phone 100 as the two-dimensional code 30, is stored in the gaming information storage RAM 52 inside the pachi-slot gaming machine 1. First in S50, determination is made whether or not the mobile phone 100, whose liquid crystal display 105 is displayed with the two-dimensional code 30, is placed on the image capture device 25 after which the shutter button 26 is depressed. If the shutter button 26 is depressed, the image capture device 25 captures the two-dimensional code 30 as image data which in turn is stored in the control RAM 43 (S51). Upon obtaining the image data, including the two-dimensional code 30, from the mobile phone 100, a recognition process (S52) for the two-dimensional code 30 is executed. Upon execution of the process in S52, the two-dimensional code 30 is converted/decoded to the gaming data, which in turn is stored in the gaming information storage RAM 52 (S53). After the gaming data is stored in the gaming information storage RAM 52, the gaming data retrieving process is completed and the operation goes to S2 (see FIG. 13).

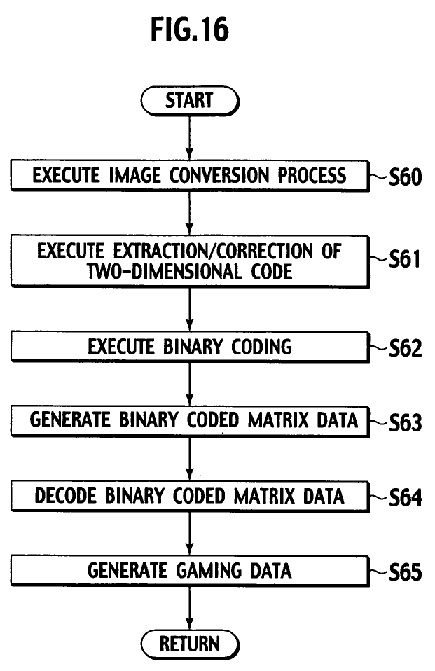

The recognition process for the two-dimensional code 30 to be executed in S52 is described with reference to FIG. 16. First, the image data, captured by the image capture device 25, is read out by the control RAM 43 and subjected to the image conversion process by the sub-CPU 84 of the sub-control circuit 82 (S60). The image conversion process is a process by which the operation is executed to select the image data, of the area on which the two-dimensional code 30 is displayed, from the image data resulting from capturing the image data (two-dimensional code 30) on the mobile phone 100, for correction of an inclination and distortion of the image data upon which the image data is converted/decoded to an image in black and white in accordance with a predetermined threshold for thereby obtaining the image data inclusive of the two-dimensional code 30 as viewed in a front thereof.

Subsequently, the sub-CPU 84 selects the two-dimensional code 30 from the image data obtained in S60, thereby performing correction such as noise removal, etc., (S61). Binary coding operation is executed for the two-dimensional code 30 obtained in S61 to rewrite respective dots, forming the two-dimensional code 30, to “0” or “1” (S62), thereby generating binary coded matrix data (S63). After the binary coded matrix data has been generated, the sub-CPU 84 decodes the binary coded matrix data (S64), thereby generating the gaming data (S65). Upon termination of the operation in S65, the current sub-routine is completed to allow the operation to shift to S53 in the flowchart shown in FIG. 15. Thus, by obtaining the two-dimensional code 30 upon executing the gaming data retrieving process while permitting the recognition process for the two-dimensional code 30 to decode the two-dimensional code 30 into the gaming data, the gaming data stored in the mobile phone 100 as the two-dimensional code 30 can be stored in the pachi-slot gaming machine 1. Therefore, the gaming data of the past can be reflected on the current game, making it possible to accumulate the gaming information.

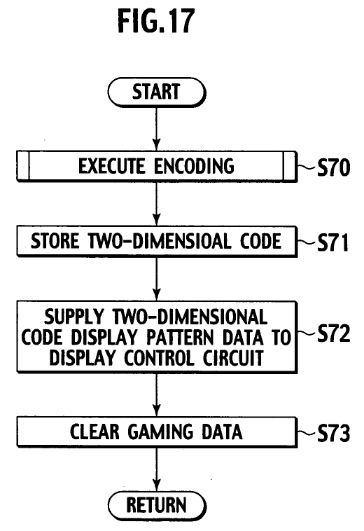

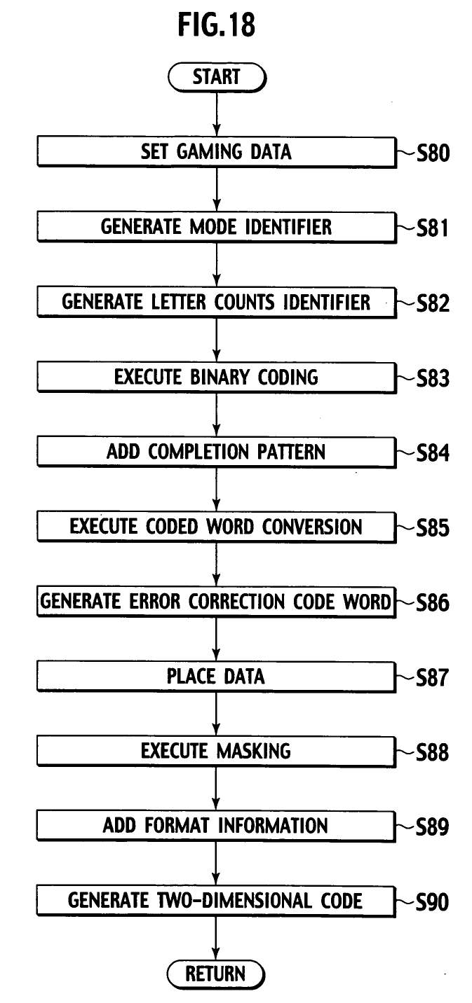

Next, the accumulated medal clearing process, to be executed in S32 in the main routine of the pachi-slot gaming machine 1, is described. FIG. 17 is a flowchart of the accumulated medal clearing process. The accumulated medal clearing process is a process, executed in cases where the accumulated medal-clearing switch 74 is inputted, which is performed when the player finishes the game and leaves from the pachi-slot gaming machine 1. As the player inputs the accumulated medal-clearing switch 74, the operation goes to the accumulated medal clearing process (S32), in which encoding operation is executed to encode current gaming data into the two-dimensional code 30 (S70). First, the encoding operation to be executed in S70 is described with reference to FIG. 18. As the encoding operation is commenced, the sub-CPU 84 reads out the gaming data, updated in the current game by the gaming information storage RAM 52, which in turn is set to the work RAM 86 (S80). Next, the sub-CPU 84 generates a mode identifier depending on a letter type (such as, for instance, a numeral, an alpha-numeral and a Chinese character, etc.) of the gaming data (S81). Subsequently, the sub-CPU 84 generates a letter count identifier depending on a letter count of the gaming data (S82). Then, the sub-CPU 84 executes the operation to code the gaming data in binary value (S83) and the operation is executed to add a completion pattern to data obtained in the operations in S81 to S83 (S84).

After the completion pattern has been added, the sub-CPU 84 executes coded word conversion of data obtained in S84 (S85) and, additionally, the operation is executed to generate an error correction code word, based on data obtained in S85, which in turn is added to data obtained in S85 (S86). Thereafter, the sub-CPU 84 executes the operation to code data obtained in S86 in a binary mode to allow data to be placed in a matrix form (S87). Then, the sub-CPU 84 executes the operation to mask a predetermined pattern for data obtained in S87 (S88). Next, the operation is executed to add format information, inclusive of an error correction level and a mouse identifier (S89), upon which the two-dimensional code 30 is generated (S80). The resulting two-dimensional code 30 is stored in the work RAM 86, thereby terminating the encoding operation (S70).

In S71 to which the operation is shifted when the encoding operation (S70) is terminated, the sub-CPU 84 reads out display pattern data for the two-dimensional code 30 from the program ROM 85 while reading out the two-dimensional code 30 generated in the work RAM 86 for supply to the image control circuit 91 (S71). Thereafter, after the operation in S71 has been executed, the gaming data stored in the gaming information storage RAM 52 is cleared (S72) and the accumulated medals are paid out depending on the number of credits stored in the control RAM 43 (S73). The gaming data is converted into the two-dimensional code 30 and the medals, accumulated in the pachi-slot gaming machine 1, are paid out, upon which the accumulated medal clearing process is terminated.

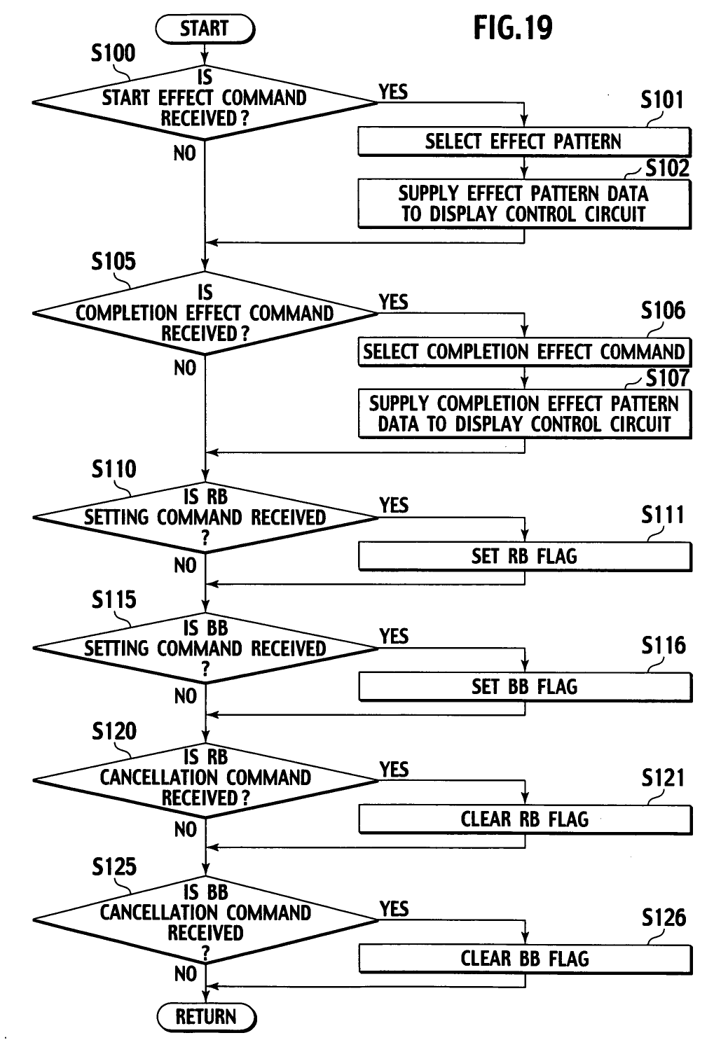

Here, the command receiving process to be executed in the sub-control circuit 82 is described with reference to the accompanying drawings. FIG. 19 is a flowchart showing a sub-routine of the command receiving process to be executed in the sub-control circuit 82. First, in S100, the sub-CPU 84 determines whether or not the start effect command is received. If determination is made that no start effect command is received, the operation goes to S105. In contrast, if determination is made that the start effect command is received, the sub-CPU 84 executes the operation in S101 to select the effect pattern associated with the relevant command from among a plurality of kinds of effect patterns stored in the program ROM 85. For instance, if “RB” flag is set, the sub-CPU 84 selects the effect pattern for “RB”. Further, if “BB” flag is set, the effect pattern for “BB” is selected. In succeeding S102, effect pattern data, representing data indicative of the effect pattern, is supplied to the image control circuit 91. After the operation in S52 has been executed, the operation goes to S105.

In S105, the sub-CPU 84 determines whether or not the completion effect command is received. If determination is made that no completion effect command is received, the operation goes to S110. In contrast, if determination is made that the completion effect command is received, the sub-CPU 84 executes the operation in S106 to select the completion effect pattern, associated with the relevant command, from among a plurality of kinds of completion effect patterns stored in the program ROM 85. Next, in S107, the completion effect pattern data is supplied to the image control circuit 91. After the operation in S107 has been executed, the operation shifts to S110 (S110).

In S110, the sub-CPU 84 determines whether or not the “RB” setting command is received. If determination is made that the “RB” setting command is received, the operation goes to S115. In contrast, if determination is made that the “RB” setting command is received, the sub-CPU 84 executes the operation in S111 to set “RB” flag. Upon execution of S111, the operation goes to S115. Also, “RB” flag represents flag that is set at a start of “RB” game and cleared at the end of “RB”.

In S115, the sub-CPU 84 determines whether or not a “BB” setting command is received. If determination is made that the “BB” setting command is received, the operation goes to S120. In contrast, if determination is made that the “BB” setting command is received, the sub-CPU 84 executes the operation in S116 to set “BB” flag. Also, “BB” flag represents flag that is set at a start of “BB” game and cleared at the end of “BB”.

Upon execution of S116, the sub-CPU 84 determines whether or not “RB” canceling command is received (S120). If determination is made that the “RB” canceling command is received, “RB” flag is cleared (S121).

In S120, if determination is made that “RB” canceling command is received, or if the operation in S121 is executed, the sub-CPU 84 determines whether or not “BB” canceling command is received (S126). If determination is made that no “BB” canceling command is received, the current sub-routine is completed. On the contrary, if determination is made that “BB” canceling command is received, the sub-CPU 84 clears “BB” flag (S126). In cases where the operation is executed in S126 to clear “BB” flag, the current sub-routine is completed.

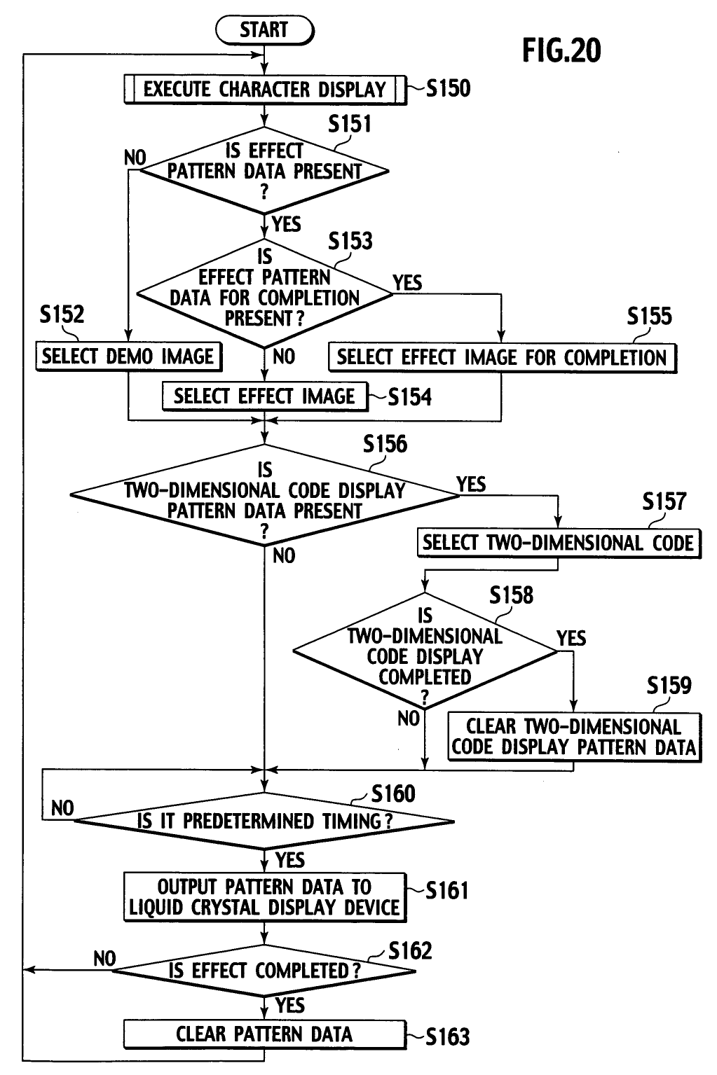

Next, the display control process, to be executed in the display control circuit, is described in detail with reference to FIG. 20. FIG. 20 is a flowchart showing a sub-routine of the display control process to be executed in the display control circuit. The image control CPU 92 generates a screen image associated with various data supplied from the sub-CPU 84. As the display control process is commenced, first in S150, a character display process is executed. The character display process represents a process by which characters are displayed over the liquid crystal display device 31 based on the gaming data stored in the gaming information storage RAM 52. Also, the character display process is described below in detail with reference to the accompanying drawings. After the character display process (S150) is completed, determination is made whether or not effect pattern data is supplied from the sub-CPU 84 (S151: “NO”). The image control CPU 92 selects a demo image from the image ROM 96 for storage in the image control work RAM 93 (S152).

In the meanwhile, in cases where effect pattern data is supplied from the sub-CPU 84 (S151: “YES”) while no completion effect pattern data is supplied (S153: “NO”), the image control CPU 92 selects an effect image from the image ROM 96 for storage in the image control work RAM 93 (S1540).

Then, in cases where effect pattern data is supplied from the sub-CPU 84 (S151: “YES”) and completion effect pattern data is supplied (S153: “YES”), the image control CPU 92 selects an effect image for a completion mode from the image ROM 96 for storage in the image control work RAM 93 (S155). After the operations in S152, S154 or S155 are executed, if display pattern data for the two-dimensional code 30 is received (S156: “YES”), the image control CPU 92 selects the two-dimensional code 30 from the work RAM 86 for storage in the image control work RAM 93 (S157). When this takes place, the two-dimensional code 30 is stored in superimposed relation with the effects images selected in S152, S154 or S155 and stored in the buffer. Thereafter, if it is time for completing the display of the two-dimensional code 30 (S158: “YES”), pattern data for the two-dimensional code 30 is cleared (S159).

Next, the screen images are outputted to the liquid crystal display device 31 each at a predetermined timing (for instance for every 1/30 seconds) (S160: “YES”) (S161). As a result, the two-dimensional code 30 is displayed in the two-dimensional code display area 24 of the liquid crystal display device 31 in a manner as shown in FIG. 11. In contrast, if no predetermined timing exists (S160: “NO”), the operation is routed back to S160. Thereafter, if no effect is completed (S162: “NO”), the operation is routed back to S150. On the contrary, if the effect is completed (S162: “YES”), effect pattern data is cleared (S163) and the operation is routed back to S150.

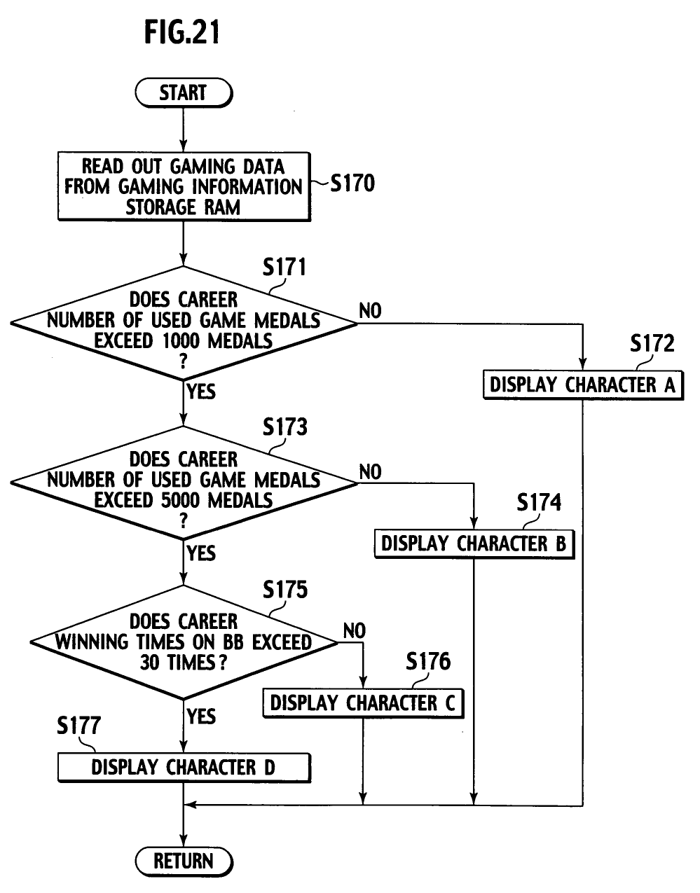

Now, the character display process, to be executed in S150 set forth above, is described below in detail with reference to FIGS. 21 and 22D. Referring to FIGS. 21 and 22D, the character display process is described. FIG. 21 is a flowchart of the character display process and FIGS. 22A to 22D are views for illustrating examples in which the characters are displayed. As the character display process begins, first, the gaming data is read out from the gaming information storage RAM 52 (S170). A kind of characters to be displayed in the effect display area 23 is selected based on the content of read out gaming data. In S171, determination is made whether or not the number of career game medals used by the player, who is the owner of the gaming data, exceeds a value of 1000 medals. If the number of career game medals is stored in gaming data in a value exceeding 1000 medals (S171: “YES”), the operation goes to S173. On the contrary, if the number of pieces game medals is stored in gaming information in a value less than 1000 medals (S171: “NO”), a character (A) is selected and displayed in the effect display area 23 (S172). The character (A) in the presently filed embodiment represents an “Egg” as shown in FIG. 22A and the “Egg” is displayed in the effect display area 23. After the character (A) has been displayed in the effect display area 23 (S172), the character display process is terminated.

In contrast, in S173 to which the operation is shifted when determination is made in S171 that the number of career game medals exceeds the value of 1000 medals (S171: “YES”), determination is made whether or not the number of career game medals exceeds 1000 medals. If determination is made that the number of career game medals exceeds 1000 medals (S173: “YES”), the operation goes to S175. On the contrary, if the number of career game medals is less than 5000 medals (S173: “NO”), that is, when the number of used career game medals is greater than 1000 medals and less than 5000 medals, a character (B) is selected and displayed in the effect display area 23 (S174). Here, the character (B) in the presently filed embodiment represents a “Chick”, as shown in FIG. 22B, which is displayed in the effect display area 23. After the character (B) has been displayed in the effect display area 23 (S174), the character display process is completed. Subsequently, determination is made in S175 whether or not the career winning times on “BB” stored in the gaming data exceeds 30 times. If the career winning times on “BB” exceeds 30 times (S175: “YES”), a character (D) is selected and displayed in the effect display area 23 (S177). Here, the character (D) in the presently filed embodiment represents a “Cock”, as shown in FIG. 22D, which is displayed in the effect display area 23. After the character (D) has been displayed in the effect display area 23 (S177), the character display process is completed. On the contrary, if the career winning times on “BB” is less than 30 times (S175: “NO”), a character (C) is selected and displayed in the effect display area 23 (S176). Here, the character (C) in the presently filed embodiment represents a “Hen”, as shown in FIG. 22C, which is displayed in the effect display area 23. After the character (C) has been displayed in the effect display area 23 (S176), the character display process is completed.

Also, with the gaming machine of the presently filed embodiment, it may be preferred for the code information (two-dimensional code 30) to be displayed like the pachi-slot gaming machine 1 when the player finishes playing the game. More particularly, at the end of game, it is preferred for the code information to be displayed immediately before the medals, accumulated in the pachi-slot gaming machine 1, are paid out. This is because displays the code information immediately before the accumulated medals are paid out enables the player to obtain the gaming data in a reliable manner without forgetting the gaming data displayed as the code information. Also, the present invention is not limited to such a timing at which code information is displayed on the gaming machine according to the present invention.

(Structure of Mobile Device)

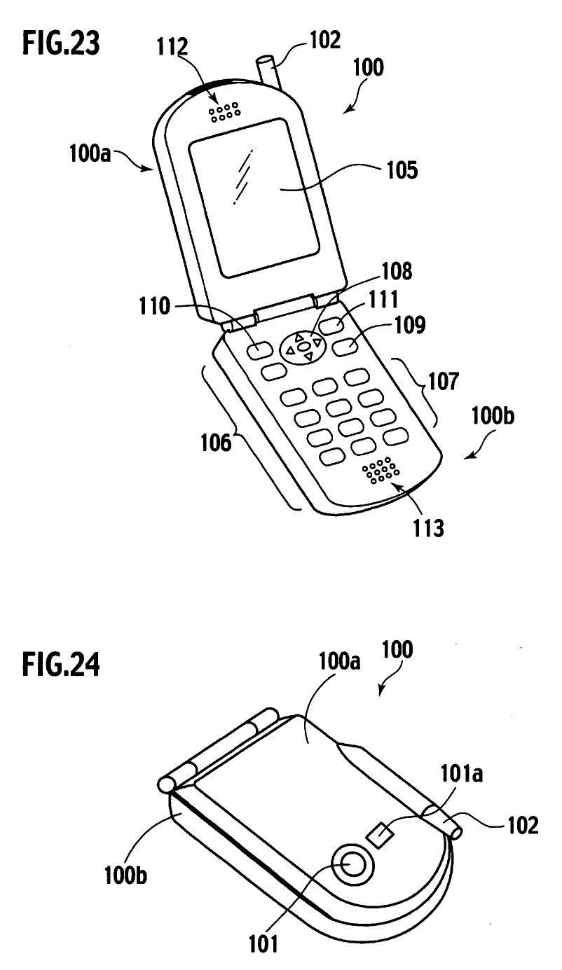

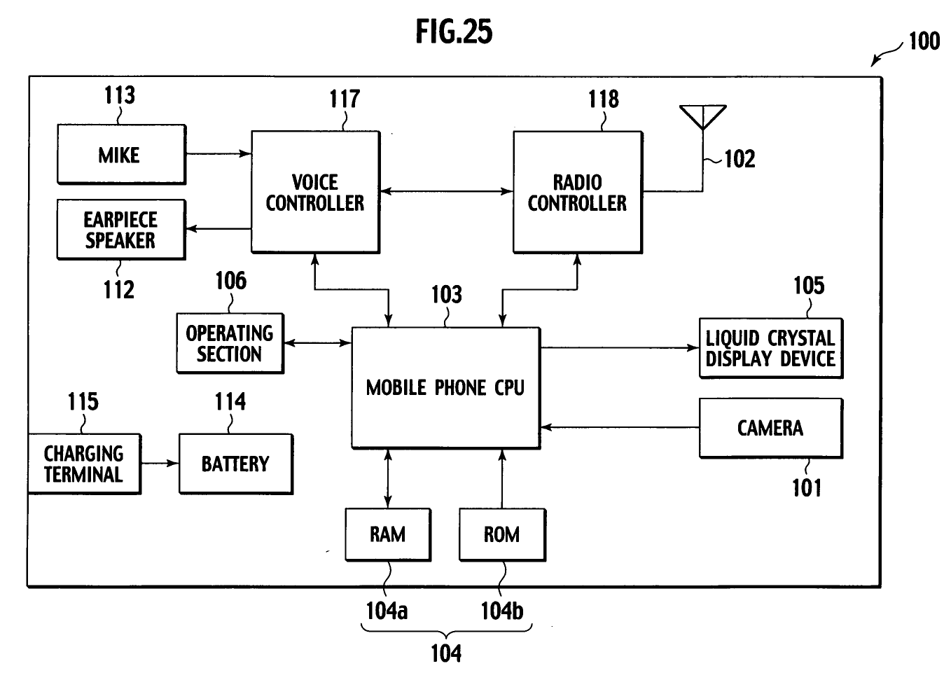

Now, the mobile phone 100, as a mobile device of the present invention, by which a game system of the presently filed embodiment is defined, is described in detail with reference to FIGS. 23 and 24. FIG. 23 is an exterior perspective view of the mobile phone 100 of the presently filed embodiment. FIG. 24 is an exterior perspective view of the mobile phone 100 of the presently filed embodiment in a folded state. Also, the mobile phone 100 corresponds to the mobile device of the present invention.

As shown in FIGS. 23 and 24, the mobile phone 100 is comprised with a first case 100a having a liquid crystal display 105, and a second case 100b having an operating section 106, with the first and second cases 100a and 100b being structured to be foldable in directions to allow the liquid crystal display 105 and the operating section 106 to face inward.

The first case 100a is provided with a mobile phone communication unit 102, the liquid crystal display 105 and an earpiece speaker 112. The liquid crystal display 105 is located on the first case 100a at one surface thereof, which forms an inside when the mobile phone 100 is folded inward, and provides a display of various information such as content of inputs effectuated by the operating section 106, the Internet site, etc. Further, by displaying the image data, involving the two-dimensional code 30 captured by the camera 101, over the liquid crystal display 105 enables the pachi-slot gaming machine 1 to acquire image data via the image capture device 25 of the pachi-slot gaming machine 1. Also, with the liquid crystal display 105 permitted to display an image available to be captured by the camera 101 in an image capture mode for the camera 101 as will be described later, the liquid crystal display 105 functions as a so-called finder. As shown in FIG. 23, the earpiece speaker 112 is located in an area above the liquid crystal display 105 for reproducing a voice signal of the other end of a phone call with the mobile phone 100. In the meanwhile, as shown in FIG. 24, the mobile phone communication unit 102 is located in an area at a rear side of the liquid crystal display 105 to be connected to a network to perform transmission and receiving of various data. The mobile phone communication unit 102 includes a so-called antenna that is mounted on the first case in retractable capabilities. The camera 101 is mounted in the first case 100a on a rear side thereof at a substantially central area. The camera 101 serves to obtain an image as image data available to be captured by the camera 101 and includes a light emitting device 101a adapted to emit a light in a shortage of light intensity during image capture to enable sharp image data to be obtained.

The second case 100b is provided with an operating section 106 on one surface, which faces inward when the mobile phone 100 is folded inward, of the second case 100b, and a mike 113. The second case 100b internally accommodates therein the mobile phone CPU 103, which serves to control a function of the mobile phone 100, and the memory 104 that stores the image data, captured by the camera 101, and data or the like that is downloaded. As shown in FIG. 23, the operating section 106 is provided with dial key/character keys 107, a cursor key 108 by which a cursor is moved for selecting content to be displayed, a mail key 110, by which en electronic mail is transmitted and received, and an internet connection key 111 to be connected to the Internet.

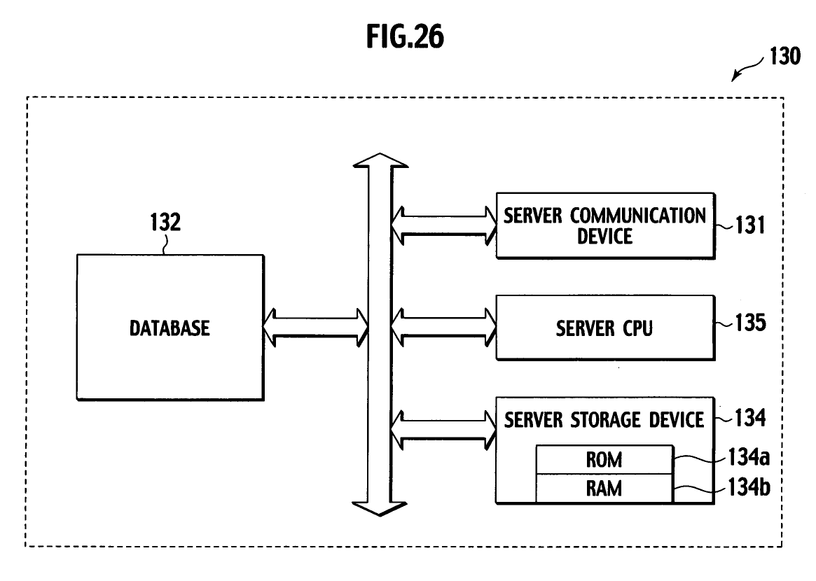

Now, control of the mobile phone 100 is described. FIG. 25 is a block diagram showing an internal structure of the mobile phone 100. The mobile phone 100 is comprised with the image capture device 25, playing a role as the image capture device, the mobile phone communication unit 102, the mobile phone CPU 103, the memory 104, the liquid crystal display 105, the operating section 106, a voice controller 117, the earpiece speaker 112, the mike 113, a radio controller 118 (transmitter and receiver) and a battery 14. The mobile phone communication unit 102 is controlled by the mobile phone CPU 103 to transmit radio wave to and receive the same from a base station as medium via the mobile phone communication unit 102. The voice controller 117 outputs a receiver signal, outputted from the mobile phone communication unit 102 via the mobile phone CPU 103, to the earpiece speaker 112, while outputting the voice signal, outputted from the mike 113, to the mobile phone communication unit 102 as a transmission signal via the mobile phone CPU 103.

The phone call speaker 112 converts the receiver signal, outputted from the voice controller 117, into the voice signal and the mike 113 outputs a transmission voice signal, generated by an operator, into the voice signal for output to the voice controller 117. The camera 101 is operative to capture the two-dimensional code 30 in image for display on the liquid crystal display device 31 of the pachi-slot gaming machine 1, with image resulting from the image data being captured being stored in a RAM 104a of the memory 104. While the presently filed embodiment is described with reference to a case wherein a CCD camera is employed as the image capture device, the present invention is not particularly limited to such an image capture device and, for instance, a CMOS sensor camera may be employed.

The memory 104 is comprised of the RAM 104a and a ROM 104b, with the RAM 104a storing the image data resulting from the camera 101 capturing the two-dimensional code 30 in image, image data for awaiting images, various data, such as music data for ring alert (ring alert music of the mobile phone: hereinafter referred to as “Chaku-Melo”), and various programs in a non-volatile fashion. In the meantime, the ROM 42 stores therein a conversion program for the two-dimensional code 30 that will be described later, and control programs related to sending and receiving operations of the phone, preparation/sending/receiving operation for electronic mails and the Internet operations and with the mobile phone 100, permitting the mobile phone CPU 103 to execute these control programs allows the execution of various operations. The battery 114 supplies various circuits with electric power and can be electrically charged via a charging terminal 115. Also, the mobile phone CPU 103 performs the sending and receiving of the electronic mails and transmitting and receiving of data over the Internet by means of the mobile phone communication unit 102.

The mobile phone CPU 103 has a capability of downloading the conversion program 133 for the two-dimensional code 30 from the server 130 over the Internet, based on a predetermined command inputted via the operating section 106 for storage in the memory 104. In case of the first embodiment, the conversion program for the two-dimensional code 30 is preliminarily preinstalled for storage in the ROM 104b of the memory 104. The mobile phone CPU 103 operates to execute reading out the conversion program for the two-dimensional code 30 from the memory 104 and has functions (A) and (B) as described below.

(A) The mobile phone CPU 103 recognizes the two-dimensional code 30 from image data, obtained when the camera 101 captures the two-dimensional code 30 in image, to allow the recognized two-dimensional code 30 to be encoded to generate the gaming data.

(B) The mobile phone CPU 103 allows the mobile phone communication unit 102 to transmit the gaming data, generated in a manner (A) described above, to the server 130 over the Internet.

(Structure of Server)

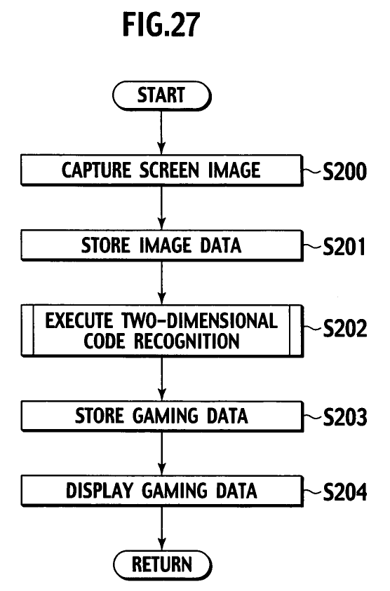

Next, the server, forming the game system, is described. FIG. 26 is a block diagram showing an internal structure of the server 130 shown in FIG. 1. The server 130 is comprised with a server communication device 131 enabling the communication with the mobile phone 100 over the Internet, database 132, a server storage device 134 and a server CPU 135 playing a role as an arithmetic-processing unit.

Database 132 stores therein the conversion program 133 for the two-dimensional code 30 to be transmitted to the relevant mobile phone 100 under circumstances where there is a request from the mobile phone 100 for downloading the programs. Upon receipt of the request signal from the mobile phone 100, for downloading the conversion program 133 for the two-dimensional code 30, and ID data of the mobile phone 100, the server CPU 135 reads out the conversion program 133 for the two-dimensional code 30 from data base 132 to be transmitted to the mobile phone 100, from which the download request signal is delivered, over the Internet. This results in a capability of causing the memory 104 of the mobile phone 100 to store the conversion program 133 for the two-dimensional code 30. Although no need arises for the conversion program 133 for the two-dimensional code 30 to be preliminarily preinstalled like the mobile phone 100 mentioned above, there is a mobile phone with no preliminarily preinstalled conversion program 133 for the two-dimensional code 30 and, so, the mobile phone 100 is enabled to suitably download the conversion program 133 for the two-dimensional code 30. Also, it is, of course, to be appreciated that in cases where the conversion programs 133 for the two-dimensional code 30 are preliminarily preinstalled in all the mobile phone 100, no need arises for the server 130 to have the function to download the conversion program 133 for the two-dimensional code 30.

Further, even in cases where the image data per se of the two-dimensional code 30 is transmitted from the mobile phone 100, the server 130 allows the ROM 134a to store the conversion program 133 for the two-dimensional code 30 function as a code information conversion device by which the resulting two-dimensional code 30 is analyzed for conversion. This is because of the fact that mobile phone 100, with respective specifications inoperative to activate the programs even if the conversion program 133 for the two-dimensional code 30 is preliminarily installed in the mobile phone 100 in a manner described above or even if the conversion program 133 for the two-dimensional code 30 is downloaded from the server and, in addition thereto, even if the conversion program 133 for the two-dimensional code 30 is downloaded to the mobile phone 100, to address such issues. That is, the server storage device 134 is comprised of a ROM 134a and a RAM 134b and the ROM 134a stores therein the conversion program 133 for the two-dimensional code 30 to be executed by the server CPU 135 wherein under a situation where the image data of the two-dimensional code 30 is transmitted from the mobile phone 100 together with the control programs, related to the server controls, to the ROM 134a, the two-dimensional code 30 is recognized from the resulting image data and decoded. In the meanwhile, the RAM 134b functions as a temporary storage device operative when executing various controls of the server 130.

With the server 130 set forth above, upon receipt of the conversion program 133 for the two-dimensional code 30 from the mobile phone 100, the conversion program 133 for the two-dimensional code 30 is read out from database 132 of the server 130 to transmit the same in a mode to be executed by the mobile phone 100. In the meanwhile, in cases where code information, transmitted from the mobile phone 100 and function as the gaming data, is comprised with the image data, the conversion program 133 for the two-dimensional code 30, stored in the ROM 134a, is executed, thereby decoding image data. A game, obtained upon decoding, is transmitted.

(Operations by Mobile Phone)

Now, operations to be executed in the mobile phone 100 set forth above are described.

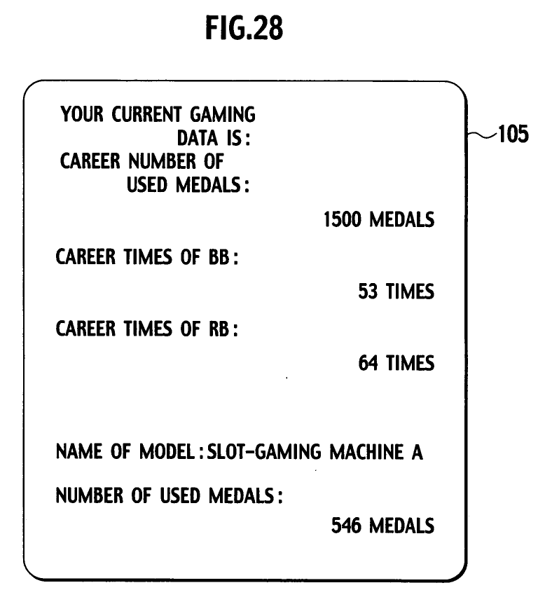

Since the mobile phone 100, forming the game system of the first embodiment, is of the type wherein the conversion program 133 for the two-dimensional code 30 is preinstalled, the mobile phone 100 is able to decode the two-dimensional code 30, acquired from the pachi-slot gaming machine 1, by itself for thereby confirming the content of the gaming data. FIG. 27 is a flowchart showing the operations to be executed in the mobile phone 100. First, depending on a command inputted via the operating section 106, the mobile phone CPU 103, incorporated by the mobile phone 100, drives the camera 101 function as the image capture device whereby the camera 101 captures the two-dimensional code 30, involved in the screen image displayed on the liquid crystal display device 31 of the pachi-slot gaming machine 1 (S200).

Subsequently, the mobile phone CPU 103 stores the image data, obtained in S200, in the memory 104 (S201). Next, the mobile phone CPU 103 starts up the conversion program 133 for the two-dimensional code 30 to perform the recognition process for the two-dimensional code 30 (S202), thereby recognizing the two-dimensional code 30 based on the image data obtained in S200. Thus, the gaming data is generated based on the recognized two-dimensional code 30. The recognition process for the two-dimensional code 30 is identical to the recognition process (S52) for the two-dimensional code 30, which has been already described in detail with reference to FIG. 15, and repeated description is herein omitted.

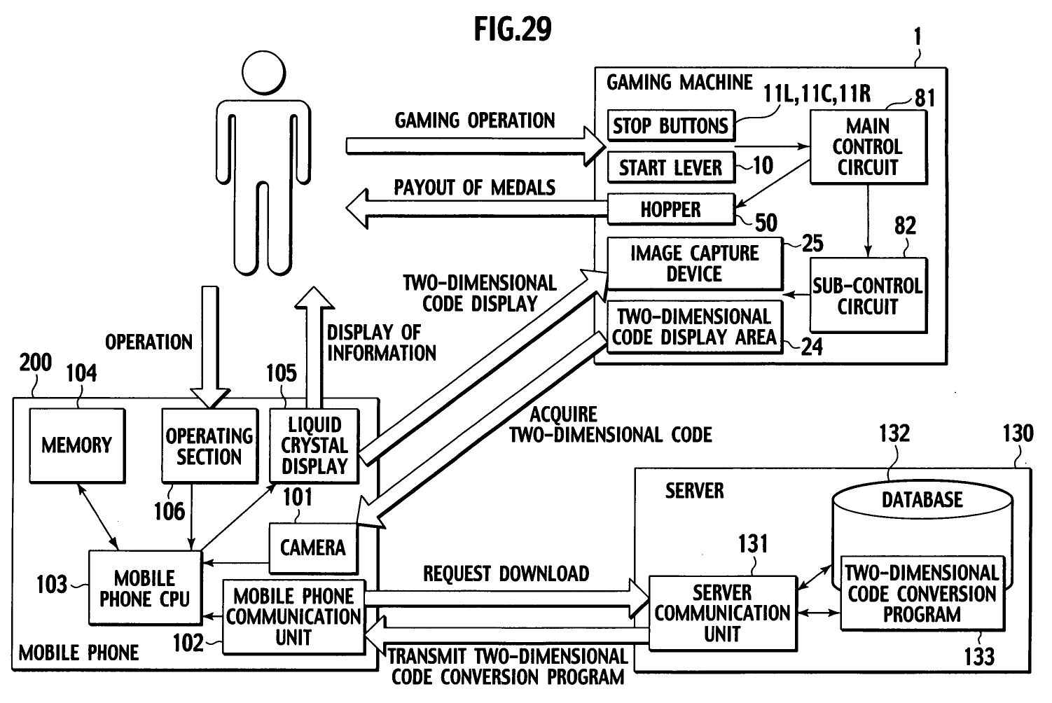

The mobile phone 100 CPU 103 stores the gaming data, obtained in the recognition process for the two-dimensional code 30 in S202, in the RAM 104a of the memory 104 (S203). The mobile phone CPU 103 provides a display of the content of the gaming data on the liquid crystal display 105 depending on the gaming data stored in the memory 104 mentioned above (see FIG. 28). By inputting a predetermined command upon operation of the operating section 106, the player is able to grasp entire content of the gaming data. FIG. 28 is a view showing one example of the gaming data, resulting from decoding the two-dimensional code 30, which is displayed in the liquid crystal display 105 of the mobile phone 100. The liquid crystal display 105 is initially provided with a display of the gaming data, composed of games summed up in the pachi-slot gaming machine, including the pachi-slot gaming machine 1 according to the present invention. Gaming data, associated with various modes of the pachi-slot gaming machine, is displayed in an area below the gaming data. Although FIG. 28 displays the gaming data related to a model name “SLOT-GAMING MACHINE A”, gaming data subsequent gaming data related to the “SLOT-GAMING AMCHINE A” can be displayed in a scroll fashion by operating the operating section 106 of the mobile phone 100. Also, a mode in which gaming data is displayed is not limited to the display mode shown in FIG. 28.

That is, the content to be displayed as gaming data is not limited to “NUMBER OF USED MEDALS”, “WINNING TIMES OF “BB” and “WINNING TIMES OF “RB” and gaming data, related to a regular winning combination such as a “CHERRY” and “PLUM”, may be displayed or the maximum record of the number of medals winning on “BB” at one time may be displayed. Additionally, it may be configured such that date and hour is recorded on such gaming data.

As set forth above, with the pachi-slot gaming machine 1 and the game system of the first embodiment, since the two-dimensional code 30, resulting from coding gaming data, is displayed in a mode available to be captured by the camera 101 of the mobile phone 100 (see FIG. 11) at the end of game, for instance, the player allows the camera 101 of the mobile phone 100 to capture the two-dimensional code 30 in image to enable the mobile phone 100 to easily obtain the gaming data generated from the two-dimensional code 30 (see FIG. 28). Further, by displaying the two-dimensional code 30 obtained in the liquid crystal display 105 of the mobile phone 100 to allow the image capture device 25 of the pachi-slot gaming machine 1 to capture the liquid crystal display 105, for thereby enabling the gaming data (gaming information) of the past to be reflected on the current game. This enables the player to continuously play a game even in making a slot in time and, hence, it becomes possible for the pachi-slot gaming machine 1 to have new high-interest on a game.

Since a game system is constructed of such a pachi-slot gaming machine 1, the camera 101, the mobile phone 100 having the mobile phone communication unit 102 and the liquid crystal display 105, the server communication device 131, and the server 130 including database 132 and the conversion program 133 for the two-dimensional code 30, the two-dimensional code 30, acquired from the pachi-slot gaming machine 1 by the operation of the player to use the mobile phone 100, is converted upon execution of the conversion program 133 for the two-dimensional code 30 of the mobile phone 100. With the gaming data, resulting from such a conversion, stored in the memory 104 of the mobile phone 100, the player is enabled to easily acquire the gaming data, which would need troublesome work, to be displayed over the mobile phone 100, thereby making it possible to easily confirm and analyze the content of such gaming data.

### Second Embodiment

Now, a game system different from that of the first embodiment is described as a second embodiment. While the game system of the first embodiment, mentioned above, is configured to allow the conversion program 133 for the two-dimensional code 30 to be preinstalled in the memory 104 of the mobile phone 100, the conversion program 133 for the two-dimensional code 30 is not preinstalled in a mobile phone 200 by which a game system of the second embodiment is formed. The second embodiment is described with reference to a case wherein the conversion program 133 for the two-dimensional code 30 is downloaded from the server 130 for storage in the memory 104 to allow the conversion program 133 for the two-dimensional code 30 to be executed for recognizing the two-dimensional code 30 for conversion to the gaming data.

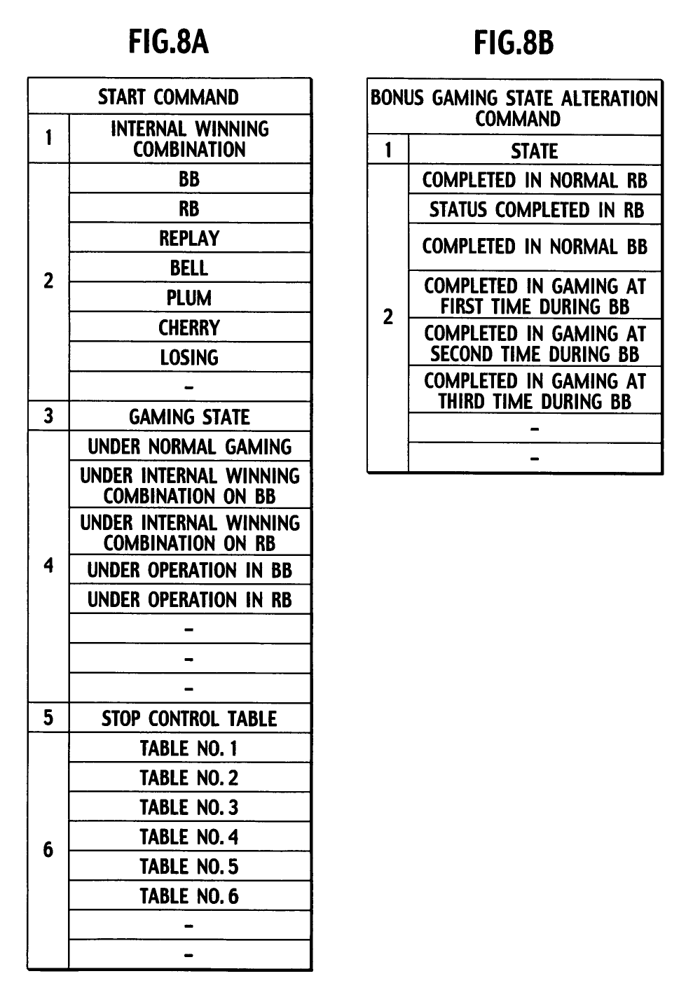

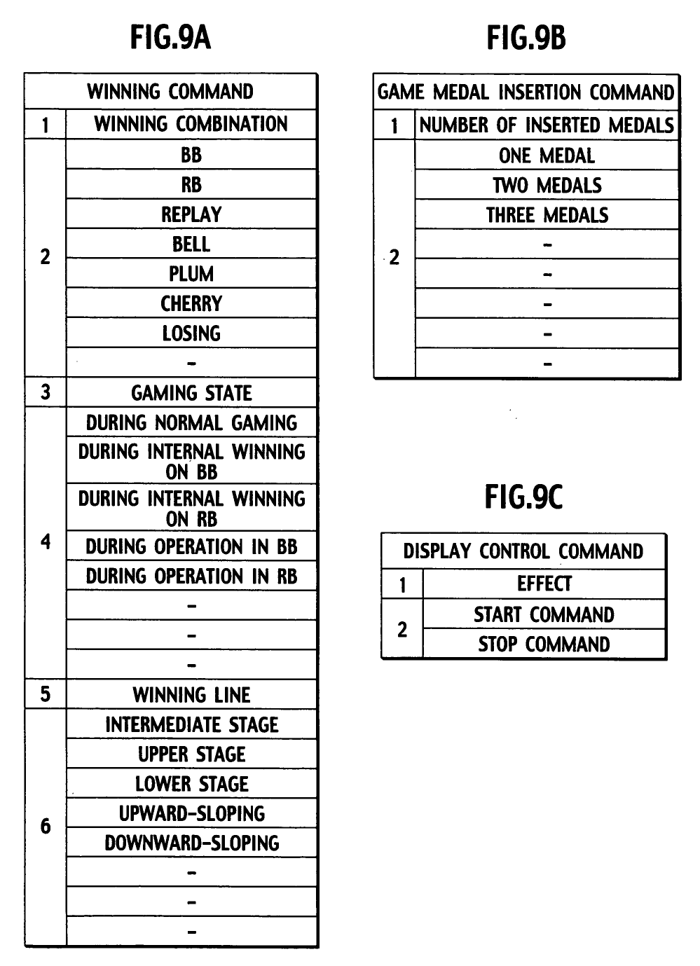

Also, outer appearances and fundamental internal structures (see FIGS. 1 to 10, FIG. 15 and FIGS. 18 to 21) of the pachi-slot gaming machine, the mobile phone 200 and the server 130, by which the game system of the second embodiment mentioned above is formed, and the processes (see FIGS. 12 to 14 and FIGS. 16 and 17) to be executed in the pachi-slot gaming machine are identical to those of the first embodiment and, so, description of the same is herein omitted, with description being made of the mobile phone 200, forming the game system of the second embodiment, and processes to be executed in the mobile phone 200 and the server. Hereunder, the same component parts as those of the game system of the first embodiment bear like reference numerals for description.

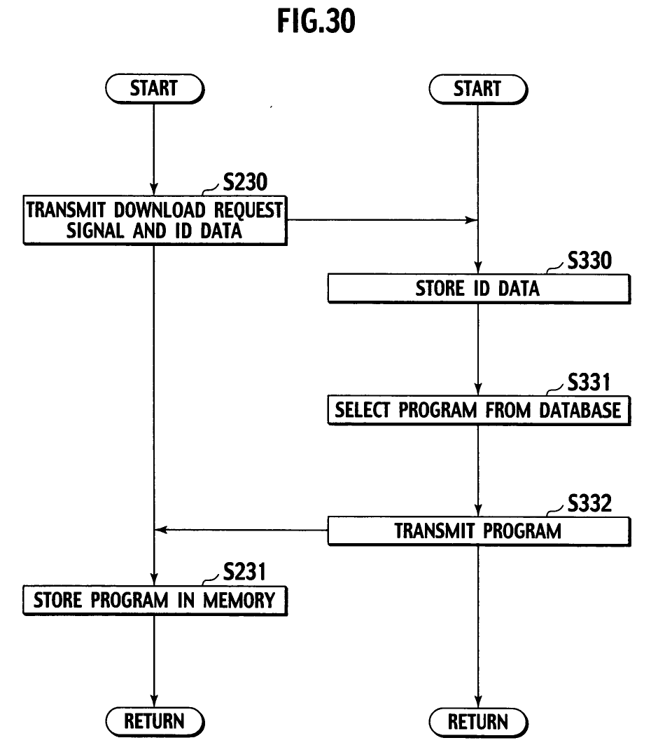

The game system of the second embodiment is described with reference to the accompanying drawings. FIG. 29 is a system structural view of the game system of the second embodiment. As set forth above, the mobile phone 200 differs from the mobile phone 100 of the first embodiment in that no conversion program 133 for the two-dimensional code 30 is preinstalled in the ROM 104b but is identical in other structures to the mobile phone 100. That is, the conversion program 133 for the two-dimensional code 30 is downloaded from the server 130 and stored in the memory 104, whereby the mobile phone 200 is enabled to function in the same manner as the mobile phone 100 of the first embodiment.

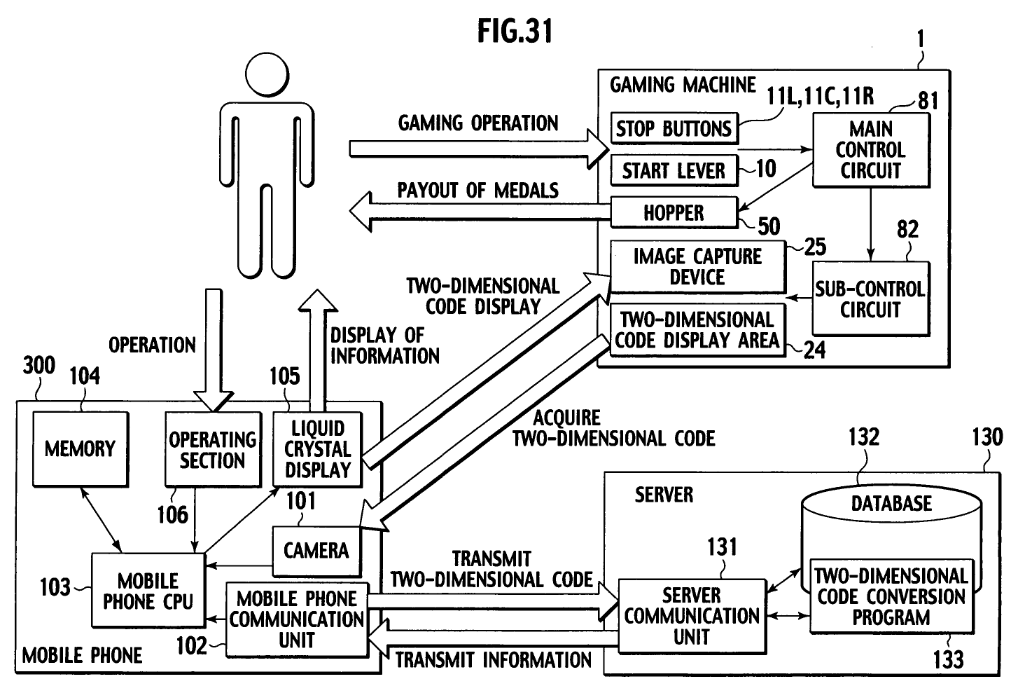

Now, the processes to be executed in the mobile phone 200 and the server 130 of the second embodiment are described with reference to the accompanying drawings. FIG. 30 is a flowchart of the process to be executed between the mobile phone 200 and the server 130. As shown in FIG. 30, upon operation of a player to execute a predetermined operation, the mobile phone 200 transmits a request signal for downloading the conversion program 133 for the two-dimensional code 30 and unique ID data for the relevant mobile phone 200 to the server 130 via the mobile phone communication unit 102 under Networking Protocol (such as FTP) that is well known in the art (S230).

On the other hand, upon receipt of the download request signal and identification data transmitted from the mobile phone 200, the server CPU 135 stores ID data, owned by the mobile phone 200 by which the download request signal is transmitted, in the RAM 134b (S330). Thereafter, the server CPU 135 reads out the conversion program 133 for the two-dimensional code 30 from database 132 for downloading (S331) and transmits the two-dimensional code 30 from database 132 to the mobile phone 200 (S332). Then, upon receipt of the two-dimensional code 30 from database 132 from the server 130, the mobile phone 103 stores the conversion program 133 for the two-dimensional code 30 in the memory 104 (S231).

Thus, upon operation of the server 130 to download the conversion program 133 for the two-dimensional code 30, the mobile phone 200 forming the game system of the second embodiment operations in the same functions as the mobile phone 100 of the first embodiment. That is, by executing the conversion program 133 for the two-dimensional code 30 stored in the RAM 104a during a phase wherein the camera 101 captures the two-dimensional code which is generated based on the coded gaming data of the pachi-slot gaming machine 1, the player is enabled to easily grasp the content of the gaming data. That is, even in cases where the player has the mobile phone 200 in which no conversion program 133 for the two-dimensional code 30 is preinstalled, the player is able to utilize the game system like the player who has the mobile phone 100 in which the conversion program 133 for the two-dimensional code 30 is preinstalled whereby the player is able to confirm own gaming data and analyze the same.

### [Third Embodiment]

Now, a game system different from those of the first and second embodiments is described as a third embodiment. With the game systems of the first and second embodiments, the mobile phone 100 and the mobile phone 200 are able to execute the conversion program 133 for the two-dimensional code 30 using the mobile phone CPU 103 provided that the conversion program 133 for the two-dimensional code 30 is stored in the memory 104. A mobile phone 300, forming a game system of the third embodiment, has an Internet connection function through which the camera 101 is able to retrieve the two-dimensional code 30. However, the mobile phone 300 is unable to execute the conversion program 133 for the two-dimensional code 30 with the mobile phone CPU 103.

Also, outer appearances and fundamental internal structures (see FIGS. 2 to 10 and FIGS. 23 to 26) of the pachi-slot gaming machine, the mobile phone and the server, by which the game system of the third embodiment mentioned above is formed, and the processes (see FIGS. 13 through 22D) to be executed in the pachi-slot gaming machine are identical to those of the first and second embodiments and, so, description of the same is herein omitted, with description being made of the mobile phone 300, forming the game system of the third embodiment, and processes to be executed in the mobile phone 300 and the server 130. Hereunder, the same component parts as those of the game systems of the first and second embodiments bear like reference numerals for description. As set forth above, the mobile phone 300 differs from the mobile phones 100 and 200 of the first and second embodiments in that the mobile phone CPU 103 is unable to execute the conversion program 133 for the two-dimensional code 30.

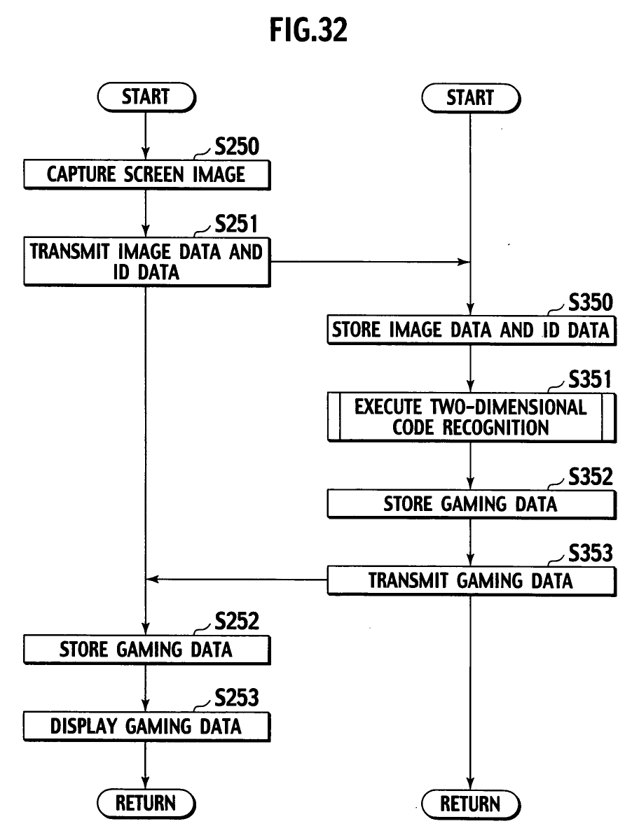

The game system of the third embodiment structured with the mobile phone 300, which is unable to execute the conversion program 133 for the two-dimensional code 30, is described with reference to the accompanying drawings. FIG. 31 is a view for illustrating a system structure of the game system of the third embodiment. As shown in FIG. 31, since the mobile phone 300 is unable to execute to execute the conversion program 133 for the two-dimensional code 30, the mobile phone 300 transmits the two-dimensional code 30, acquired from the pachi-slot gaming machine 1, to the server 130. The server 130 is configured in a structure to decode the received two-dimensional code 30 to allow the resultant gaming data to be transmitted to the mobile phone 300. Other structures are similar to those of the first and second embodiments.

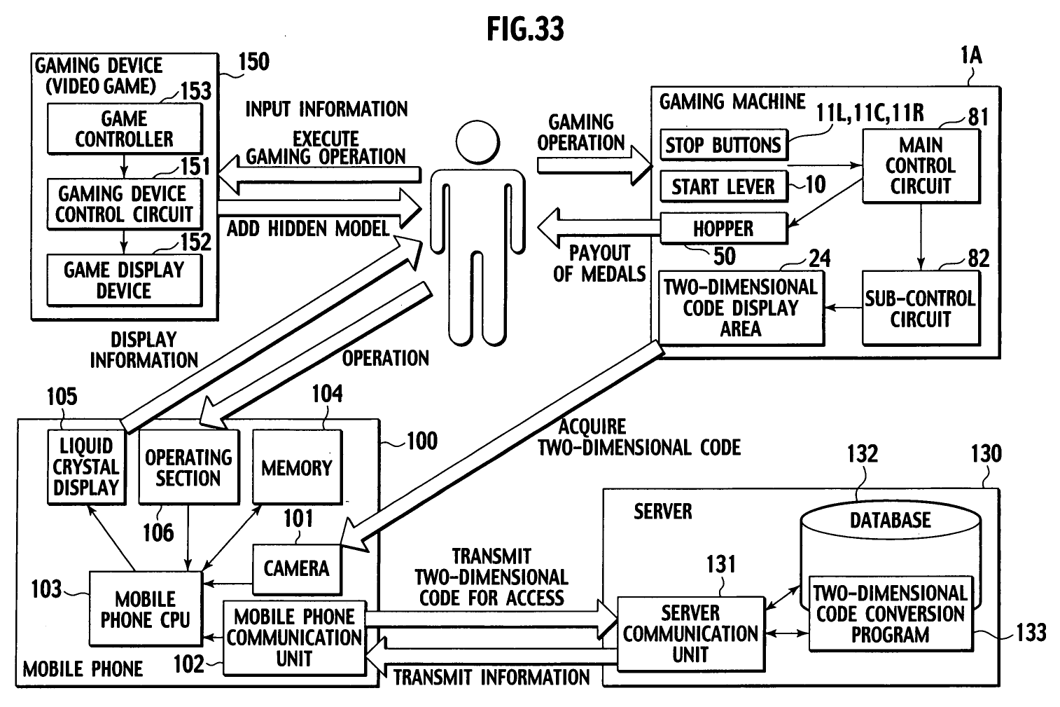

Now, the processes to be executed between the mobile phone 300 and the serve 130 are described in detail with reference to the accompanying drawings. FIG. 32 is a flowchart showing the process to be executed between the mobile phone 300 and the server 130. First, in S250, the mobile phone CPU 103, incorporated in the mobile phone 300, drives the camera 101, function as the image capture device, in response to a command inputted via the operating section 106 to cause the camera 101 to capture the two-dimensional code 30 contained in the screen image displayed on the two-dimensional code display area 24 of the pachi-slot gaming machine 1 (see FIG. 11).

Subsequently, the mobile phone CPU 103 accesses to a predetermined address (such as an URL indicative of a site of a gaming machine manufacturer) inside the server 130 in response to a command inputted via the operating section 106 or data indicative of an address preliminarily transmitted from the server 130 to allow image data, obtained when the camera 101 captures the two-dimensional code 30 in image, to be transmitted together with ID data of the mobile phone 300 to the server 130 over the Internet by means of the mobile phone communication unit 102 under the Internet Protocol (such as FTP) that is well known in the art (S251).

In the meanwhile, upon receipt of image data and ID data of the mobile phone 300, the server CPU 135, incorporated in the server 130, stores the image data, described above, and ID data in the RAM 134b (S350). Next, the server CPU 135 executes a process for recognizing the two-dimensional code 30 (S351) such that the two-dimensional code 30 is recognized from the image data obtained when the camera 101 (image capture device) of the mobile phone 300 captures the two-dimensional code 30 (code information) to cause the resulting recognized two-dimensional code 30 to be converted to the gaming data. Also, the process for recognizing the two-dimensional code 30 in the third embodiment, which is similar to that in the first embodiment, has been already described with reference to FIG. 16 and, therefore, description of the same is herein omitted.

Then, the server CPU 135 stores the gaming data, obtained by the process for recognizing the two-dimensional code 30 in S301, in the RAM 134b in correlation with ID data of the mobile phone 300 (S352). The server CPU 135 reads out the gaming data, obtained by the process for recognizing the two-dimensional code 30 in S301, from the RAM 134b for transmission to the mobile phone 300 based on ID data (S153). Upon receipt of the gaming data from the server 130, the mobile phone CPU 103 stores the relevant gaming data in the memory 104 (S252). Then, the mobile phone CPU 103 displays the gaming data over the liquid crystal display 105 (see FIG. 24). Thus, the player is enabled to grasp the content of gaming data upon inputting a predetermined command through operation of the operating section 106.

As set forth above, with the game system of the third embodiment, since the two-dimensional code 30, in which gaming data related to the outcome of the premium lottery is coded, is displayed over the pachi-slot gaming machine 1 to allow the player to use the camera 101 of the mobile phone 300 for capturing the two-dimensional code 30 in image upon which the resulting image data is transmitted to the server 130 in the same manner as the first embodiment, the player is enabled to obtain the gaming data from the server 130. That is, even in cases where no conversion program 133 for the two-dimensional code 30 is stored in the memory 104 of the mobile phone 300, the game system of the third embodiment makes it possible for the player to obtain the gaming data to grasp the content thereof. Accordingly, even in cases where the player has the mobile phone 300 with no capability of executing the conversion program 133 for the two-dimensional code 30, the player is able to utilize the game system like the other players who have the mobile phone 100 and the mobile phone 200 with their capabilities of executing the conversion program 133 for the two-dimensional code 30, respectively, whereby the player is able to confirm own gaming data and analyze the same.

Also, the present invention is not limited to the embodiments set forth above and it is to be understood that various improvements and modifications may be made without departing from the scope of the present invention. For instance, while the presently filed embodiments have been described with reference to the structures wherein the two-dimensional code display area 24 takes the form of a display area on which a part of the effect display area 23 is displayed under a particular condition, the pachi-slot gaming machine 1 may be provided with a two-dimensional code display area as a separate display device.

Further, while the presently filed embodiment has been described with reference to the structure wherein the characters are displayed depending on the gaming data stored in the gaming information storage RAM 52, it may be altered such that a tale, composed of a plurality of short stories, is displayed. In such a case, since the tale is able to rouse interests of a player who desires to look at the rest of the stories, it becomes possible to encourage the player to play a game in a further continuous manner.

Furthermore, while the presently filed embodiment has been described with reference to the structure arranged to provide a display of the four kinds of characters depending on the gaming data stored in the gaming information storage RAM 52, it may be configured in a structure to increase the number of determination conditions for the gaming data for thereby increasing kinds of characters to be displayed. This allows the characters to be differently displayed on each determination condition of the gaming data and, hence, in cases where a specified condition is established, a rare character can be displayed. As a result, making an attempt to display the rare character enables the player to rouse new interests on a game.

Furthermore, according to the above embodiments, since the code information is easily transferred to the outside, it is possible to easily accumulate the code information. Additionally, the gaming machine of the present invention is configured to read the code information, it is possible to used the preliminary accumulated code information in a new play in the gaming machine, whereby the player can play a continuously play with his accumulated code information.

Additionally, since the game-related information is easily transferred to outside, it is possible to accumulate the game-related information, whereby a data based that stores the game-related information can be obtained.

Additionally, the mobile device is configured to capture the code information displayed on the gaming machine. By sending the captured code information to the server, the player obtains the game-related information regarding the player. By this configuration, since the player easily obtains his -game-related information, various analyses regarding the game-related information can be made, whereby the player can be develop his skill in playing the gaming machine by using results of the analysis.

Additionally, the gaming machine is configured to receive the code information from the server, and the gaming machine converts the received code information to data which is readable to the player, whereby the player can be recognized that what code information is transferred to the gaming machine by seeing the data displayed on the display device of the gaming machine.

Additionally, the mobile device is configured to send the code information obtained from the gaming machine and receive the converted code information, which is readable by the player, from the server. By storing the converted code information in the mobile device, the player can recognize the code information displayed on the display device of the mobile device anywhere.

### Fourth Embodiment

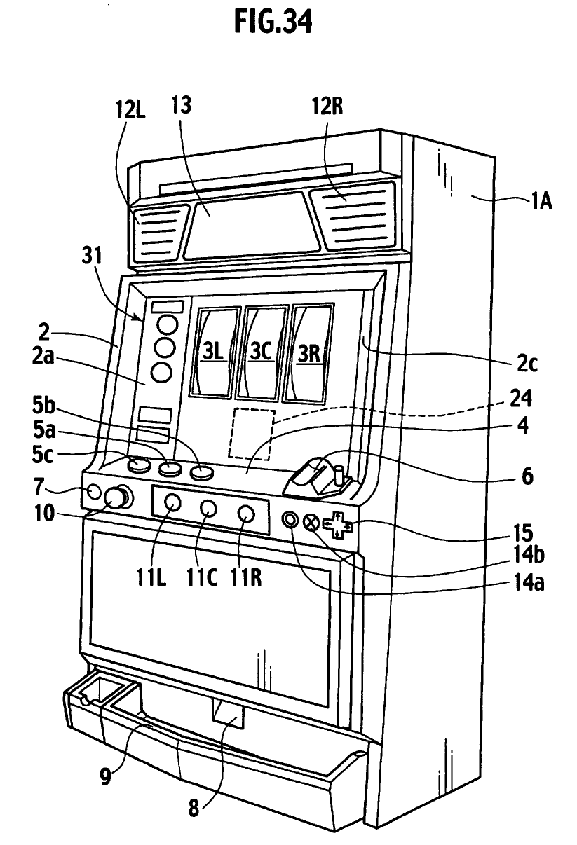

Next, a fourth embodiment according to the present invention is described. (Structure of Game System) FIG. 33 is a network structural view showing one example of a game system of a fourth embodiment. The game system is comprised of the pachi-slot gaming machine 1, the mobile phone 100 equipped with the camera 101 (not shown, see accompanying drawings, related to the first embodiment, and FIG. 24) function as the image capture device, the server 130 operative to transmit data to and receive the same from the mobile phone 100 over the Internet, and a gaming device (video game machine) 150 operative to execute game programs stored in a CD-ROM 1554.

As will be understood upon comparison between FIG. 1 and FIG. 33, a pachi-slot gaming machine 1A has no image capture device 25 in a form different from the pachi-slot gaming machine 1 of the first embodiment. Other structures and functions are identical to those of the pachi-slot gaming machine 1 and, hence, duplicated description of the same is herein omitted.

The mobile phone 100, to be used in the presently filed embodiment, has the same structure as the mobile phone 100 of the first embodiment and, therefore, duplicated description is herein omitted.

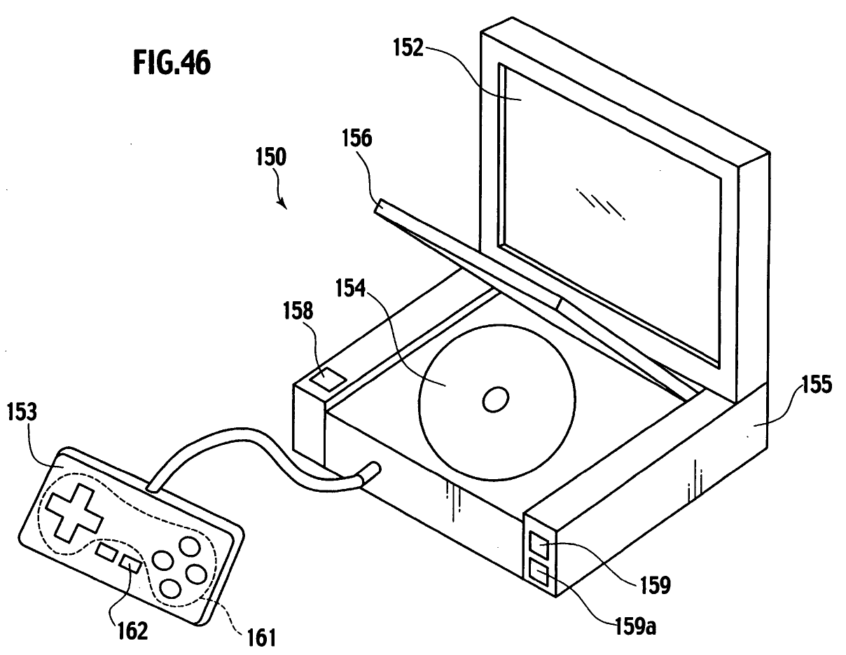

Further, the server 130 of the presently filed embodiment receives a lottery outcome, transmitted form the mobile phone 100, and extracts premium data from among premium data (such as, for instance, image data for an awaiting image, music data for Chaku-Melo (“Chaku-Melo” is music data of cellular phone ring melody)) and password data, etc., for canceling restrictions on functions of game programs) based on lottery outcome data received from the mobile phone 100. Then, the selected premium data is transmitted to the mobile phone 100. The gaming device 150 is able to read out record medium such as, for instance, the CD-ROM 154 (see FIG. 46) stored in the game programs to allow the player to amuse himself upon operation of a game controller 153. By inputting the password data transmitted from the mobile phone 100 as premium data, the restricted functions of the game program, stored in the CD-ROM 154, are released to have a function to be usable. The game program to be used in the presently filed embodiment represents a game program that enable the player to play the game upon simulation thereof with the pachi-slot gaming machine 1A, which takes the form of a structure wherein by inputting the above-described password (password data), the player is able to select, in addition to the pachi-slot gaming machine 1A operative to allow the player to play in a normal fashion, a pachi-slot gaming machine of another model. The password data, mentioned above, corresponds to game-related information or key information based on which game-related information is obtained. With the presently filed embodiment, although this key information includes electronic information that releases the functional restrictions limited on function of the game program described above, the present invention is not limited to such information for releasing the functional restrictions and, for instance, image data or the like can be suitably altered for varying costumes of a character function as a personage on a game for use in the game program described above, provided that electronic information includes the game-related information of the present invention or information for obtaining the game-related information.

That is, the game-related information, obtained in the gaming machines of the present invention, or key information for obtaining game-related information refer to information are of the nature obtained depending on the lottery outcome resulting inside the pachi-slot gaming machine 1A functions as the gaming machine. Thus, such information has a capability of providing a player with a game related to a home use gaming device (video game) or a some kind of merit aside from an exciting and entertaining capability of the gaming machine whereby the exciting and entertaining capability is expanded in width to provide a capability of achieving a breakthrough on a present situation under which excitement, born by the game of the gaming machine per se, directly leads to popularity of the relevant gaming machine.

Thus, with the game system of the presently filed embodiment, by capturing the two-dimensional code 30, displayed on the liquid crystal display device 31 of the pachi-slot gaming machine 1A, at the end of the play on “BB”, using the camera 101 of the mobile phone 100, the two-dimensional code 30 can be obtained with the mobile phone 100. Then, by transmitting the lottery outcome data which is generated based on the two-dimensional code 30 to the server 130, the premium data can be obtained from the server 130. In addition, in cases where this premium data includes the password data, inputting the password to the game program, to be executed in the gaming device 150, enables the player to amuse himself with the game program using a function (of a hidden model of a pachi-slot gaming machine in the presently filed embodiment) that is subject to functional restrictions.

Also, the system of the presently filed embodiment is not limited to the pachi-slot gaming machine 1A like the first embodiment and may have applications to, for instance, a pachinko-gaming machine, a slot-gaming machine, etc.

Further, code information usable in the presently filed embodiment is not particularly limited to the two-dimensional code 30 as explained in connection with the first embodiment described above.

Furthermore, like the first embodiment, with the presently filed embodiment, the mobile device is not limited to the mobile phone 100 and, of course, may include a PDA, etc.

Moreover, while the presently filed embodiment is described with reference to a case wherein transmission and receiving of data are performed between the mobile phone 100 and the server 130 over the radio, the present invention is not limited to such a case and may achieve transmission and receiving of data over a cable communication.

(Structure of Pachi-Slot Gaming Machine)

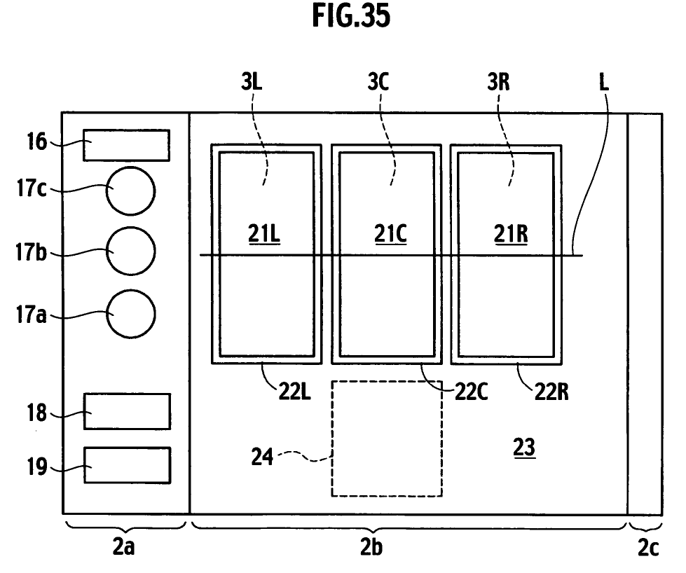

FIGS. 34 and 35 are perspective views typically showing the pachi-slot gaming machine 1A shown in FIG. 33. As described above, the pachi-slot gaming machine 1A differs from the pachi-slot gaming machine 1 of the first embodiment in that the pachi-slot gaming machine 1A does not include the image capture device 25.

Therefore, the pachi-slot gaming machine 1A has no shutter button 26 but includes a 2-BET button 5c. Also, the buttons predetermined at 5a, 5b represent the 1-BET button and the MAXIMUM-BET button, respectively, like the first embodiment. Operating the 2-BET button 5c enables two medals of gaming media to be used in a game. In addition, the pachi-slot gaming machine 1A is also provided with the symbols S like those shown in FIG. 4. Also, since the winning combinations are set in the pachi-slot gaming machine 1A in the same way as those used in FIG. 5, mentioned above, and duplicated description of the same is herein omitted. Structures and functions of the other parts are similar to those of the pachi-slot gaming machine 1 and duplicated description of the same is herein omitted.

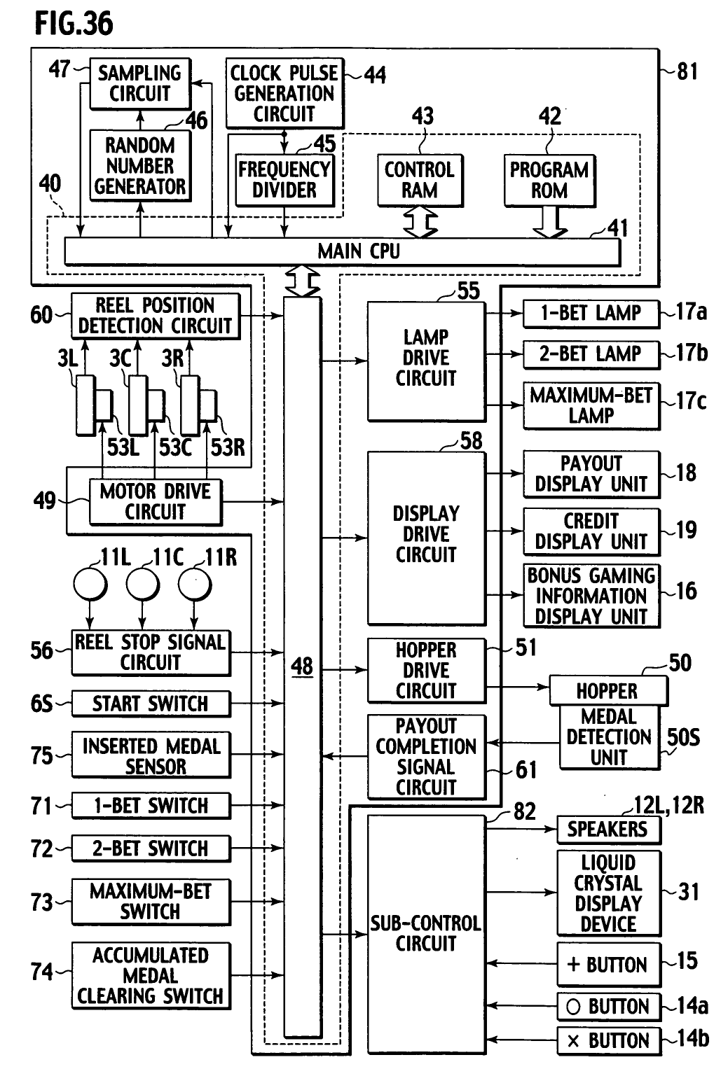

An internal structure of the pachi-slot gaming machine 1A is shown in FIG. 36. As will be understood from comparison between the pachi-slot gaming machine 1A and the pachi-slot gaming machine 1 of the first embodiment, a control system of the pachi-slot gaming machine 1A includes the 2-BET switch 72 in place of the shutter button 26 and the image capture device 25. Other structure is identical to that of FIG. 6 and duplicated description of the same is herein omitted.

With the presently filed embodiment, the sub-CPU 84 -has a function to execute various operations in accordance with programs stored in the program ROM 85, thereby controlling the sub-control circuit 82 in accordance with a variety of commands supplied from the main CPU 41. Further, the sub-CPU 84 executes display controls for the image control circuit 91. Furthermore, the sub-CPU 84 executes the lottery -for determining whether to afford a premium to a player at a timing when a command, related to the “BB” setting, is received from the main control circuit 81, after which the lottery outcome data, related to such a lottery outcome, is encoded to generate the two-dimensional code 30 for storage in the work RAM 86. Then, the sub-CPU 84 selects a display pattern for the two-dimensional code 30 from the program ROM 85 at a timing when a command, related to the “BB” cancellation from the main control circuit 81, to transmit the same to the image control CPU 92. The display pattern for the two-dimensional code 30 may include various data, such as position and time period in which the two-dimensional code 30 is displayed, which is needed for the two-dimensional code 30 to be displayed. As described below, the image control CPU 92, which has received the display pattern for the two-dimensional code 30, executes the operation to read out the two-dimensional code 30 from the work RAM 86 for display over the liquid crystal display device 31 depending on the display pattern for the two-dimensional code 30. Also, while the presently filed embodiment is described with reference to a case wherein lottery outcome data is encoded to generate the two-dimensional code 30, the present invention may be implemented such that the two-dimensional code 30 is preliminarily stored in the image ROM 96 or the like.

Additionally, with the presently filed embodiment, the work RAM 86 has a function to store various flags and values of variables in temporary storage areas of the sub-CPU 84. Moreover, the work RAM 86 stores the lottery outcome data, related to the lottery outcome, and the two-dimensional code 30 resulting from encoding such a lottery outcome data. Also, while the presently filed embodiment employs the work RAM 86 as the temporary storage area of the sub-CPU 84, the present invention is not limited to 'such a configuration and may include readable record medium.

Further, with the presently filed embodiment, the image ROM 96 stores character images, etc., representing, for instance, a background image and characters. While the presently filed embodiment is described with reference to a case wherein the lottery outcome data is encoded to crease the two-dimensional code 30, the present invention may be implemented such that the two-dimensional code 30 is preliminarily stored in the image ROM 96.

Even with the presently filed embodiment, the image control CPU 92 operates in the same manner as that of the first embodiment to store various images, extracted from the image ROM 96 or the work RAM 86, in the video RAM 97 to allow the various images to be superimposed such that, for instance, a background image, a character image and the two-dimensional code 30 overlap on an image, placed rearmost area, in this order whereby a screen image is synthesized which in turn is supplied to the liquid crystal display device 31 at a predetermined timing. As a result, the liquid crystal display device 31 displays the two-dimensional code 30 (see FIG. 11). As shown in FIG. 11, the player is able to capture the two-dimensional code 30, displayed over the liquid crystal display device 31, using the camera 101 of the mobile phone 100. When this takes place, the liquid crystal display device 31 functions as a code information display device that provides a display of the two-dimensional code 30 (code information), resulting from coding lottery outcome data related to the lottery outcome, in a mode available to be captured by the camera 101 (readout device) from the outside of the pachi-slot gaming machine 1A.

Also, while the presently filed embodiment is described with reference to a case wherein the sub-CPU 84 encodes the lottery outcome data to generate the two-dimensional code 30, the present invention may be implemented in such a way to allow the two-dimensional code 30 to be preliminarily stored in a storage device incorporated in a gaming machine. In such a case, more than one table data is preliminarily stored in the storage device in correlation with a certain random number and the image data of the two-dimensional code 30, thereby causing image data of the two-dimensional code 30, associated with the random number depending on the lottery outcome, to be displayed over the liquid crystal display device 31.

Hereunder, it is supposed that the pachi-slot gaming machine 1A is started up and variables for use in the main CPU 41 are initialized at predetermined values while operating under a steady state with preset values being set to predetermined values.

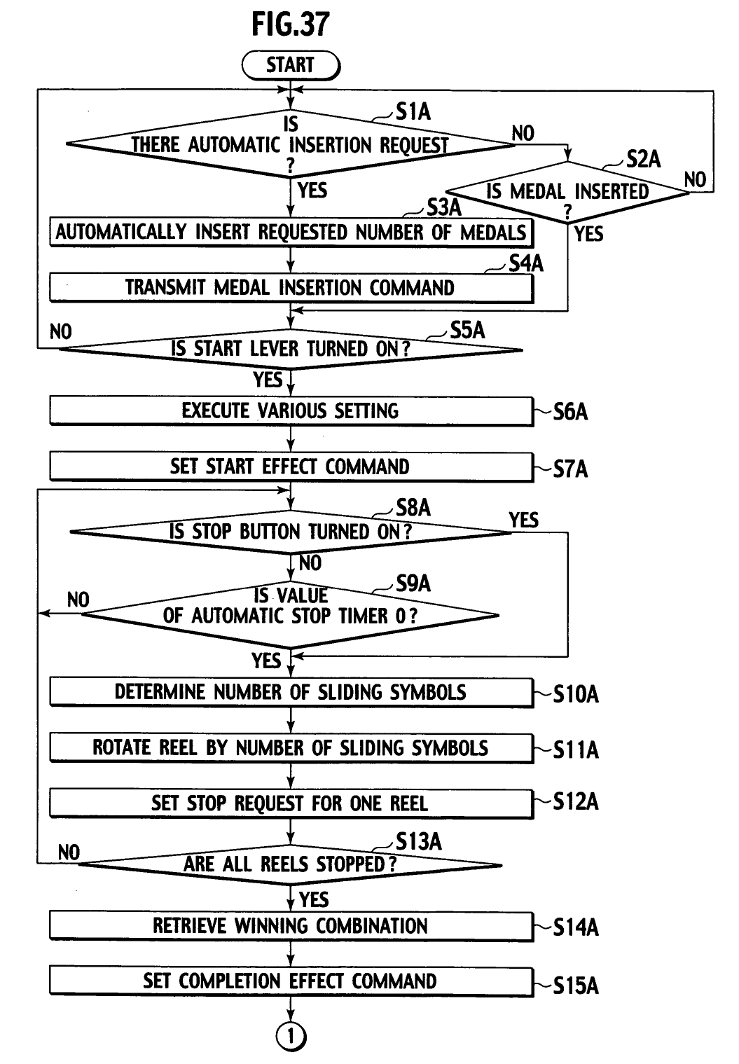

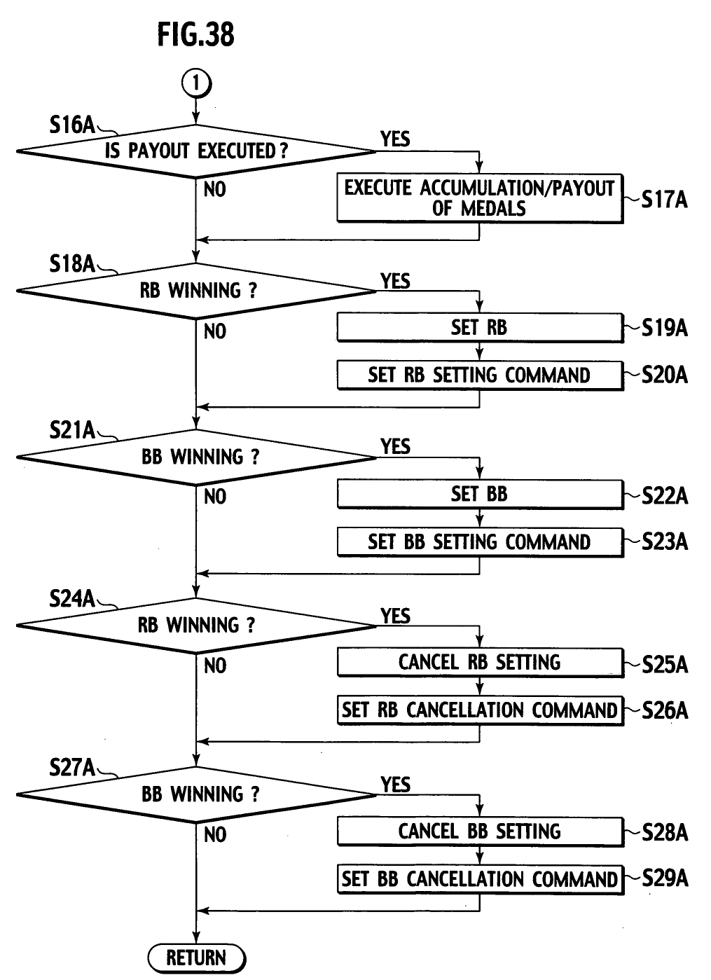

FIGS. 37 and 38 are flowcharts showing a main routine of a game execution process to be performed in the main control circuit of the presently filed embodiment.

First, in step 1A (S1A), the main CPU 41 determines whether or not there is a request for automatic insertion of medals. Also, as used herein, the phrase “a situation where there is a request for automatic insertion” refers to a situation under which the winning combination of “REPLAY” is established in a preceding game. In the presence of the request for automatic insertion of medals, the operation is executed to automatically insert the requested number of medals (S3A), while transmitting a medal insertion command to the sub-control circuit 82 (S4A).

On the contrary, if determination is made in S1 that there is no request for automatic insertion of medals, the main CPU 41 determines whether or not the medals are inserted (S2A). That is, upon discriminating whether or not a detection signal is received from the inserted medal sensor 75 detecting that the medals are inserted to the medal insertion slot 6 or whether or not a detection signal is received from the BET-switch (1-BET switch 71, the 2-BET switch 72 or the MAXIMUM-BET switch 73), the main CPU 41 determines whether or not the medals are inserted. Also, if determination is made that the detection signal is received from the BET-switch (1-BET switch 71, the 2-BET switch 7-2 or the MAXIMUM-BET switch 73), the main CPU 41 executes the operation by which the number of credits, equivalent to the number of medals subjected to “BET”, is subtracted from the number of credits stored in the RAM 43.

In S2A, if determination is made that no medal is inserted, the main CPU 41 restores the operation to S1A. Further, in S2A, if determination is made that the medals are inserted or if the operation in S4A is executed, the main CPU 41 determines whether or not the start lever 10 is operated (S5A). That is, the main CPU 41 determines whether or not an input signal is received from the start switch 6S.

In S5A, if determination is made that no start lever 10 is operated, the main CPU 41 restores the operation to S1A. On the contrary, if determination is made in S5A that the start lever 10 is operated, the main CPU 41 executes various operations related to various setting (S6A). During operations on various setting, the sampling is executed on the random number delivered from the random number -generator 46 at a timing when the start lever 10 is operated, thereby performing lottery operation that generates an internal winning combination (winning flag) based on the random number, resulting from the sampling, and the odds lottery table (see FIGS. 10A and 10B) set in the RAM 43. Further, during such operations on various setting, for instance, the main CPU 41 executes the operation to select a stop control table, by which the reels 3L, 3C, 3R are stopped, and initializing operation, by which the reels 3L, 3C, 3R are rotated, upon which the reels 3L, 3C, 3R begin to rotate.

After the rotations of the reels 3L, 3C, 3R have started, the numbers of drive pulses transmitted to the stepping motors 53L, 53C, 53R are counted, respectively, with the resulting count values being stored in the control RAM 43. Reset pulses are obtained for each rotation of the reels 3L, 3C, 3R and these pulses are inputted to the main CPU 41 via the reel position detection circuit 60. Upon receipt of these reset pulses, the count values of the drive pulses counted in the control RAM 43 are cleared to “0”. By so doing, the control RAM 43 stores the count values associated with the rotational positions within a range for one revolution of each of the reels 3L, 3C, 3R.

Further, with the symbol table (see FIG. 4) stored in the program ROM 42 for the purpose of permitting the rotational positions of the reels 3L, 3C, 3R and the symbols S drawn on the reel outer peripheries to be correlated to each other, code numbers, sequentially allocated to certain rotational pitches of the respective reels 3L, 3C, 3R, respectively, are associated with symbol codes, indicative of the symbols S provided in association with the respective code numbers, on the basis of the rotational positions at which the above-described reset pulses are generated. Furthermore, the winning symbol combination table, stored in the program ROM 42, is referred to when controllably stopping the respective reels 3L, 3C, 3R and when performing the winning confirmation after all the reels have been stopped. After the operation in S6 has been executed, the main CPU 41 restores the operation to S7A.

In S7A, the main CPU 41 sets a start -effect command in the control RAM 43. The start effect command represents a command, by which the liquid crystal display device 31 begins to provide a display of a predetermined effect image, which includes data related to the internal winning combination determined in the lottery outcome mentioned above. The start effect command is supplied to the sub-control circuit 82 at a predetermined timing. After the operation in S7A has been executed, the main CPU 41 restores the operation to S8A.

In S8A, the main CPU 41 determines whether or not the stop buttons 11L, 11C, 11R are tuned “ON” in response to the presence of or absence of the input signals from the reel stop signal circuit 56 (S8A). If determination is made that the stop buttons 1L, 11C, 11R are not tuned “ON”, the main CPU 41 determines whether or not a value of the automatic stop timer lies at “0” (S9A). In S9A, if determination is made that the value of the automatic stop timer does not lie at “0”, the operation is routed back to S8A.

On the contrary, if determination is made in S8A that the stop buttons 1L, 11C, 11R are tuned “ON” or if determination is made in S9A that the value of the automatic stop counter lies at “0”, the main CPU 41 stops rotating the reels 3L, 3C, 3R, associated with the inputted stop buttons 11L, 11C, 11R, respectively, but, in this moment, the number of sliding symbols is determined based on a winning request (i.e., an internal winning combination), positions (rotational positions of the reels 3L, 3C, 3R) of the symbols S and the selected stop control table (S10).

Next, the main CPU 41 executes the operation to rotate the reels 3L, 3C, 3R by respective numbers of rotations equivalent to the number of sliding symbols determined in S10A upon which the reels 3L, 3C, 3R are caused to stop (S11A), thereby setting a stop request for one reel 3 (S12A). The main CPU 41 determines whether or not all the reels 3L, 3C, 3R are stopped (S13A). If determination is made that all the reels 3L, 3C, 3R are not halted, the operation is routed back to S8A. On the contrary, if determination is made that all the reels 3L, 3C, 3R are halted, the main CPU 41 executes the winning retrieval (S14A). When this takes place, the operation is executed by referring to the winning symbol combination table, or the like, that is stored in the ROM 42. Also, it may be configured that determination is made whether or not the winning flag is normal and if the winning flag is found not to be normal, an illegal error is displayed to interrupt the operation.

After the winning retrieval has been executed (S14A), the main CPU 41 sets a completion effect command to the RAM 43 (S15A). The completion effect command represents a command, permitting an effect image to be displayed at the end of the game depending on the gaming outcome, which includes data related to an outcome of the winning retrieval in S14A. The completion effect command is supplied to the sub-control circuit 82 at a predetermined timing.

Next, the main CPU 41 determines whether or not the medals are paid out, that is, the presence of or absence of winning number (S16A). If determination is made that the medals are paid out, the main CPU 41 executes the operations to accumulate or payout the number of medals depending on a gaming state and winning combination (S17A). When accumulating the medals, the main CPU 41 executes the operation to allow the number of credits, stored in the control RAM 43, to be added. In the meantime, when paying out the medals, the main CPU 41 transmits a payout command signal to the hopper drive circuit 51 to cause a predetermined number of medals to be paid out from the hopper 50. In this moment, the medal detection unit 50S counts the number of medals being paid out from the hopper 50 and when the count value reaches a predetermined number, a medal payout completion signal is inputted to the main CPU 41. This allows the main CPU 41 to stop driving the hopper 50 for completing the payout operation of the medals.

Subsequently, the main CPU 41 determines whether or not the winning occurs on “RB” (S18A). If determination is made that the winning occurs on “RB”, the main CPU 41 executes the operation related to the “RB” setting (S19A). In S19A, the main CPU 41 executes the operations related to the setting of the odds lottery table for “RB” and winning symbol combination table for “RB”. Also, in S19A, the main CPU 41 begins counting the winning times on “RB” ;game or the like, while commencing the operation to display the resulting count value in the bonus gaming information display unit 16. After the operation in S19A has been executed, the main CPU 41 restores the operation to S20A.

In S20A, the main CPU 41 sets an “RB” setting command to the control RAM 43. The “RB” setting command represents a command, permitting the effect image for “RB”, function as the screen image, to be displayed over the liquid crystal display device 31, which is supplied to the sub-control circuit 82 at a predetermined timing.

If determination is made in S18A that no winning occurs on “RB” or if the operation in S20A is executed, the main CPU 41 determines whether or not the winning occurs on “BB” (S21A). If determination is made that no winning occurs on “BB”, the main CPU 41 executes the operation related to the setting of “BB” (S22A). In S22A, the main CPU 41 executes the operations related to the setting of the odds lottery table for “BB” and the winning symbol combination table for “BB”. In S24A, the main CPU 41 begins counting the number of games practiced on “BB” or the like, displaying the resulting count value in the bonus gaming information unit 16 and counting the medals being paid out. In this moment, the main CPU 41 functions as a gaming state altering device in which the operation is shifted to a special gaming state (“BB”). Thereafter, the main CPU 41 restores the operation to S23A.

In S23A, the main CPU 41 sets a “BB” setting command to the control RAM 43. The “BB” setting command represents a command, permitting the effect image for “BB”, function as the screen image, to be displayed over the liquid crystal display device 31, which is supplied to the sub-control circuit 82.

In S21A, if determination is made that no winning occurs on “BB” or if the operation in S23A is executed, the main CPU 41 determines whether or not “RB” is completed (S24A). If determination is made that “RB” is completed, then, the main CPU 41 executes the operation related to an “RB” setting cancellation (S25A). In S25A, the main CPU 41 executes operations by which the odds lottery table for “RB”, set in S19A, and the winning symbol combination table for “RB” are altered to an odds lottery table for use in a normal gaming state (aside from “RB” or “BB”). Thereafter, the main CPU 41 restores the operation to S26A.

In S26A, the main CPU 41 sets an “RB” cancellation command to the control RAM 43. The “RB” cancellation command represents a command by which the display of the effect image for “RB” function as the screen image is terminated and the operation is executed to provide a display of an effect image for the normal mode (aside from “RB” or “BB”). The “RB” cancellation command is supplied to the sub-control circuit 82 at a predetermined timing.

In S24A, if determination is made that “RB” is completed or if the operation in S26A is executed, the main CPU 41 determines whether or not “BB” is completed (S27A). If determination is made that “BB” is completed, then, the main CPU 41 executes the operation related to the “BB” setting cancellation (S28A). In S28A, the main CPU 41 executes the operations by which the odds lottery table for “BB”, set in S22A, and the winning symbol combination table for “BB” are altered to an odds lottery table for use in the normal gaming state (aside from “RB” or “BB”). Thereafter, the main CPU 41 restores the operation to S29A.

In S29A, the main CPU 41 sets a “BB” cancellation command to the control RAM 43. The “BB” cancellation command represents a command by which the display of the effect image for “BB” function as the screen image is terminated and the operation is executed to provide a display of the effect image for the normal mode (aside from “RB” or “BB”). The BB cancellation command is supplied to the sub-control circuit 82 at a predetermined timing. In S27A, if determination is made that no “RB” is completed or if the operation in S29A is executed, the game execution process is completed.

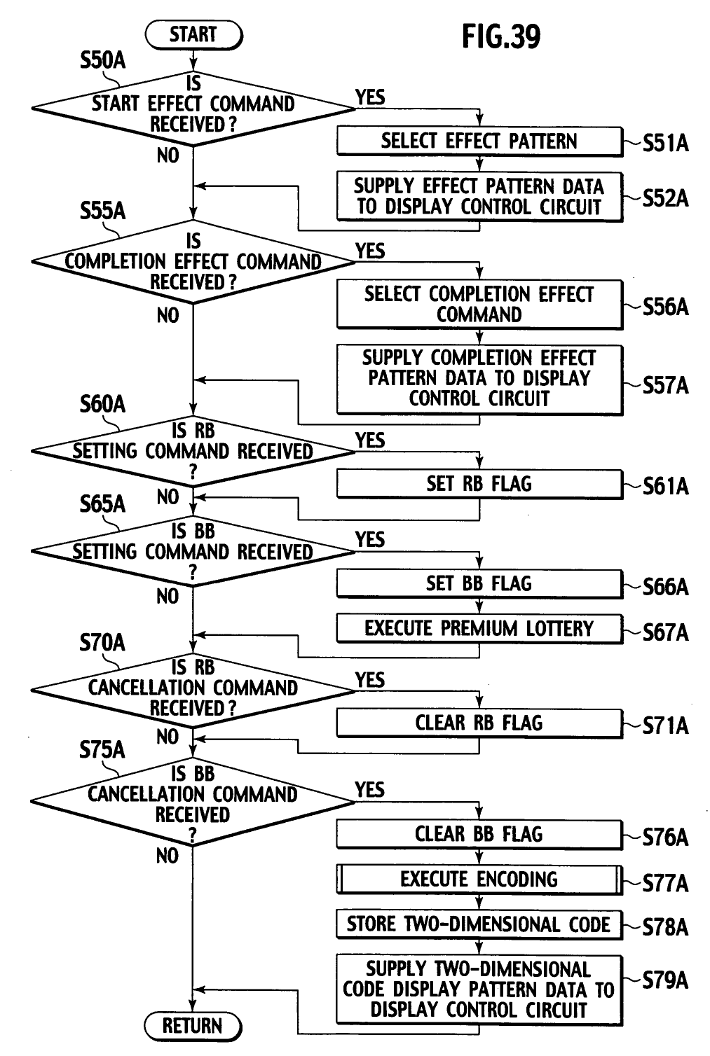

FIG. 39 is a flowchart showing a sub-routine of a command receiving process to be executed by the sub-control circuit 82. First, in S50A, the sub-CPU 84 determines whether or not a start effect command is received. If determination is made that no start effect command is received, the operation is shifted to S55A. In contrast, if determination is made that the start effect command is received, then, the sub-CPU 84 executes the operation in S51A to select an effect pattern, associated with the relevant command, from among a plurality of kinds of effect patterns stored in the program ROM 85. For instance, if “RB” flag is set, the sub-CPU 84 selects an effect pattern for “RB”. Moreover, if “BB” flag is set, an effect pattern for “BB” is selected. Next, in S52A, effect pattern data, indicative of data representing the effect pattern, is supplied to the image control circuit 91. After the operation is executed in S52A, the operation is shifted to S55A.

In S55A, the sub-CPU 84 determines whether or not the completion effect command is received. If determination is made that no completion effect command is received, the operation is shifted to S60A. On the contrary, if determination is made that the completion effect command is received, the sub-CPU 84 executes the operation in S56A to select a completion effect pattern, associated with the relevant command, from among a plurality of kinds of completion effect patterns stored in the program ROM 85. Next, in S57A, completion effect pattern data is supplied to the image control circuit 91. After the operation in S55A is executed, the operation is shifted to S60A.

In S60A, the sub-CPU 84 determines whether or not the “RB” setting command is received. If determination is made that no “RB” setting command is received, the operation is shifted to S65A. On the contrary, if determination is made that the “RB” setting command is received, the sub-CPU 84 executes the operation in S61A to set “RB” flag. After the operation in S61A is executed, the operation is shifted to S65A. Also, “RB” flag represents flag that is set at a start of “RB” and cleared at the end of “RB”.

In S65A, the sub-CPU 84 determines whether or not the “BB” setting command is received. If determination is made that no “BB” setting command is received, the operation is shifted to S70A. On the contrary, if determination is made that the “BB” setting command is received, the sub-CPU 84 executes the operation in S66A to set “BB” flag. “BB” flag is set at a start of “BB” and cleared at the end of “BB”. After the operation in S66A is executed, the sub-CPU 84 executes a premium lottery process (S67A). In executing the operation in S67A, the sub-CPU 84 functions as a lottery device by which the lottery is executed for determining whether to afford a premium to a player. In such a process, the sub-CPU 84 initially executes a random number program that is preliminarily stored in the program ROM 85, thereby selecting one random number from among random number ranging from 0 to 16383. Then, the sub-CPU 84 determines the lottery outcome data associated with the selected one random number by referring to the premium lottery table that is preliminarily stored in the program ROM 85.

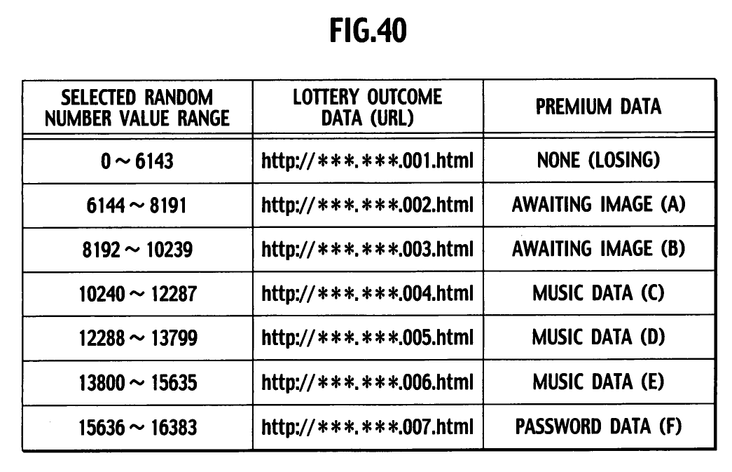

Now, the premium lottery table for use in the premium lottery process is described with reference to FIG. 40. FIG. 40 is a view showing one example of the premium lottery table. Also, while the lottery figure shows premium data for the purpose of indicating the correlation between lottery outcome data (URL) and premium data, no premium data is stored in the program ROM 85.

In cases where the selected random number is involved in a value ranging from 0 to 6143 upon execution of the premium lottery process, the URL, function as the lottery outcome data, represents “http://***.***.001.htm” in which the premium data is absent. In such a case, the lottery results in an outcome of the losing and even if a site of this URL is accessed, no premium data can be obtained.

In cases where the selected random number is involved in a value ranging from 6144 to 8191, the URL, function as the lottery outcome data, represents “http://***.***.002.htm” in which the premium data includes an “AWAITING IMAGE (A)”. Accordingly, if a site of this URL is accessed, it becomes possible to obtain image data of the “AWAITING IMAGE (A)” as the premium data.

In cases where the selected random number is involved in a value ranging from 8192 to 10239, the URL, function as the lottery outcome data, represents “http://***.***.003.htm” in which premium data includes an “AWAITING IMAGE (B)”. Accordingly, if a site of this URL is accessed, it becomes possible to obtain image data of the “AWAITING IMAGE (B)” as the premium data.

Further, in cases where the selected random number is involved in a value ranging from 10240 to 12287, the URL, function as the lottery outcome data, represents “http://***.***.004.htm” in which the premium data includes a “MUSIC DATA (C)”. Accordingly, if a site of this URL is accessed, it becomes possible to obtain image data of the “MUSIC DATA (C)” for “Chaku-Melo” as the premium data.

In cases where the selected random number is involved in a value ranging from 12288 to 13799, the URL, function as the lottery outcome data, represents “http://***.***.005.htm” in which the premium data includes a “MUSIC DATA (D)”. Accordingly, if a site of this URL is accessed, it becomes possible to obtain image data of the ” MUSIC DATA (D)” for “Chaku-Melo” as the premium data. Likewise, in cases where the selected random number is involved in a value ranging from 13800 to 15635, the URL, function as the lottery outcome data, represents “http://***.***.006.htm” in which the premium data includes a “MUSIC DATA (E)”. Accordingly, if a site of this URL is accessed, it becomes possible to obtain image data of the ” MUSIC DATA (E)” for “Chaku-Melo” as the premium data. In addition, in cases where the selected random number is involved in a value ranging from 15636 to 16383, the URL, function as the lottery outcome data, represents “http://***.***.007.htm” in which the premium data includes a “PASWORD DATA (F)”. Accordingly, if a site of this URL is accessed, it becomes possible to obtain ” PASWORD DATA (F)” as the premium data that enables the cancellation of functional restrictions, under which the functions are unavailable due to the presence of functional restrictions, of the game program to be executed by the gaming device 150 that will be described below.

Again with reference to FIG.39, in S65A, if determination is made that no “BB” setting command is received or if the premium lottery process is executed in S67A, the sub-CPU 84 determines whether or not the “RB” cancellation command is received (S70A). If determination is made that the “RB” cancellation command is received, “RB” flag is cleared (S71A).

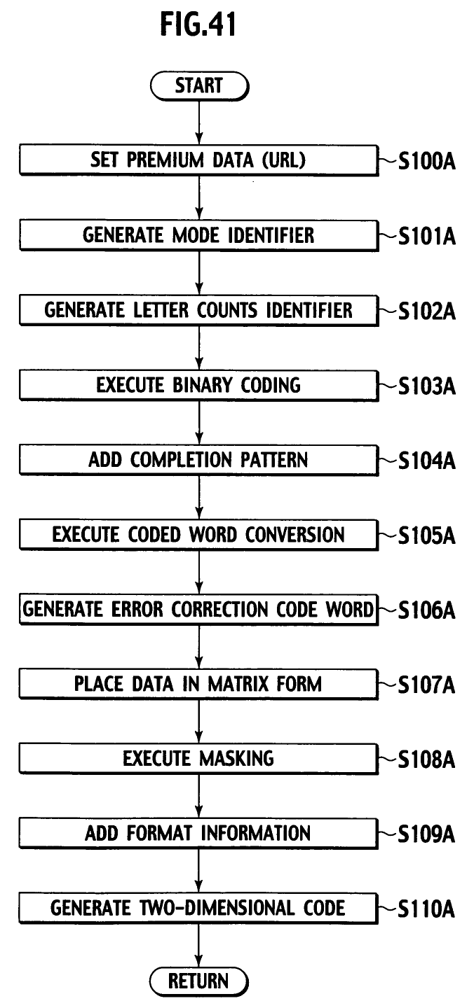

In S70A, if determination is made that no “RB” cancellation command is received or if the operation is executed in S71A, the sub-CPU 84 determines whether or not the “BB” cancellation command is received (S75A). If determination is made that no “BB” cancellation command is received, the current sub-routine is completed. On the contrary, if determination is made that the “BB” cancellation command is received, the sub-CPU 84 clears “BB” flag (S76A). Next, the sub-CPU 84 executes encoding operation to alter the URL, function as the lottery outcome data, into the two-dimensional code 30 in a coded form (S77A). The encoding operation will be described later in detail with reference to FIG. 41. Subsequently, the sub-CPU 84 stores the two-dimensional code 30, generated in S77A, in the work RAM 86 (S78A). The sub-CPU 84 reads out the display pattern data for the two-dimensional code 30 from the program ROM 85 and reads out the generated two-dimensional code 30 from the work ram 86 for supply to the image control circuit 91 (S79A). Thereafter, the current cub-routine is completed.

Now, the encoding operation, mentioned above, is described in detail with reference to FIG. 41. FIG. 41 is a flowchart showing a sub-routine of the encoding operation to be retrieved in S77A of the sub-routine shown in FIG. 39 for the execution.

First, the sub-CPU 84 sets the URL, function as the lottery outcome data related to the outcome of the lottery in the premium lottery process (FIG. 39 and in S67A), to the work RAM 86 (S100A). Next, the sub-CPU 84 generates a mode identifier, depending on letter types (such as, for instance, numerals, alpha numerals and Chinese characters, etc.) of the lottery outcome data, in work RAM 86 (S101A). Thereafter, the sub-CPU 84 generates a letter counts identifier depending on the letter counts of the lottery outcome data (S102A). Then, the sub-CPU 84 executes the operation to alter the lottery outcome data in a binary coded state (S103A), thereby adding a completion pattern to data resulting from the operations in S101A to S103A (S104A).

After the completion pattern has been added, the sub-CPU 84 executes coded word conversion of data obtained in S104A and generates an error correction code, to be added to data obtained in S105, based on data obtained in S105A. Thereafter, the sub-CPU 84 converts data, obtained in S106A in a binary form, thereby performing the operation to allow data to be placed in a matrix form (S107A). The sub-CPU 84 executes the operation to mask data, obtained by S107A, in a predetermined pattern (S108A). Next, the operation is executed to allow format information, involving an error correction level and a mask identifier, to be added (S109A), thereby generating the two-dimensional code 30 (S110A). The resulting two-dimensional code 30 is stored in the work RAM 86. Thereafter, the current sub-routine is completed.

Also, while the presently filed embodiment has been described with reference to a case wherein only the URL, function as the lottery outcome data, is encoded into the two-dimensional code 30, the present invention may be implemented in such a way to encode the lottery outcome data and other data (such as, for instance, data indicative of a model of a gaming machine, data unique to the relevant gaming machine for the gaming machine to be distinguished from the others, etc.).

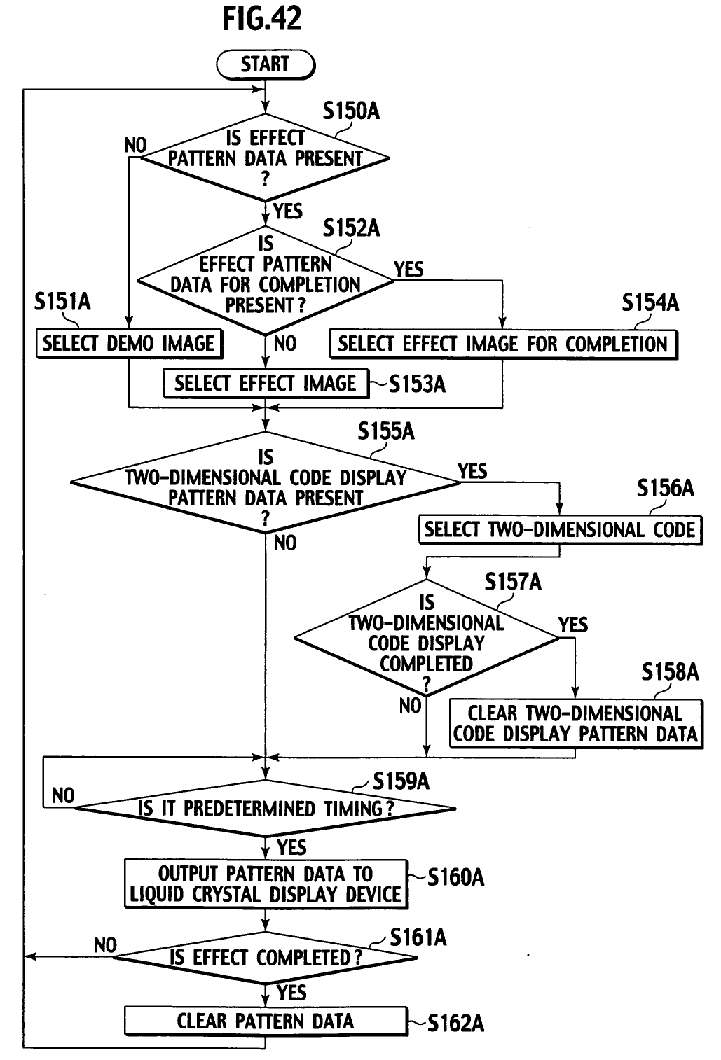

Now, the display control process to be executed in the display control circuit is described in detail with reference to the accompanying drawings. FIG. 42 is a flowchart showing a sub-routine of the display control process to be executed in the display control circuit. The image control CPU 92 generates a screen image associated with various data supplied from the sub-CPU 84. As the display control process is commenced, first in S150A, determination is made whether or not effect pattern data is supplied from the sub-CPU 84. If no effect pattern data is supplied from the sub-CPU 84 (S150A: “NO”), the image control CPU 92 extracts a demo image from the image ROM 96 for storage in the image control work RAM 93 (S151A).

The image control CPU 92 is supplied with effect pattern data from the sub-CPU 84 (S154A: “YES”) and if no completion effect pattern data is received (S152A: “NO”), an effect image is extracted from the image ROM 96 for storage in the image control work RAM 93 (S153A).

The image control CPU 92 is supplied with effect pattern data from the sub-CPU 84 (S150A: “YES”) and if no completion effect pattern data is received (S152A: “YES”), an effect image for an end stage is extracted from the image ROM 96 for storage in the image control work RAM 93 (S154A). After the operations in S151A, S153A or S154A have been executed, if the display pattern data for the two-dimensional code 30 is supplied (S155A: “YES”), the image control CPU 92 extracts the two-dimensional code 30 from the work RAM 86 for storage in the image control work RAM 93 (S156A). When this takes place, the two-dimensional code 30 is stored in a superimposed relation with the effect images selected in S161A, A153A or S154A and stored in the buffer. Subsequently, if there is a timing at which the display of the two-dimensional code 30 is completed (S157A: “YES”), the display pattern data for the two-dimensional code 30 is cleared (S158A).

Next, the effect image is outputted to the liquid crystal display device 31 at each predetermined timing (for instance at every 1/30 second) (S159A: “YES”). As a result, the two-dimensional code 30 is displayed in the two-dimensional code display area 24 of the liquid crystal display device 31 as shown in FIG. 11. On the contrary, if no predetermined timing exists (S159A: “NO”), the operation is routed back to S159A. Thereafter, in cases where no effect is completed (S161A: “NO”), the operation is routed back to S150. In contrast, if the effects are completed (S161A: “YES”), the operation is routed back to S158A.

Also, while the presently filed embodiment has been described with reference to a case wherein the lottery on the premium is practiced at the timing at which “BB” is set, the timing at which the lottery for the premium is executed is not particularly limited by the present invention and may be possible to be suitably set.

With the gaming machine of the present invention, code information (two-dimensional code 30) may be preferably displayed at the end of a special gaming state (“BB”). This is because of the fact that since code information is displayed when excitement about the game is mostly liable to go down at the end of the special gaming state, interest and concern about the game can be raised. Further, although it is hard to capture the two-dimensional code 30 with the image capture device 101 of the mobile phone 100 even if the same is displayed when the player gets involved in the game, it is time for the game to remain in a chukker at the end of the special gaming state and the display of code information is not impeditive to the playing of the game whereby the player is able to capture code information in a reliable manner. Also, the timing at which code information is displayed in the gaming machine of the present invention is not limited to such an example.

(Structure of Mobile Device)

The mobile device for use in the presently filed embodiment is similar to the mobile phone 100 used in the first embodiment and features to use the lottery data in place of the gaming data.

More particularly, the mobile phone 100 of the presently filed embodiment has functions described below.

(A) The mobile phone CPU 103 recognizes the two-dimensional code 30 from the image-data, obtained when the two-dimensional code 30 is captured by the camera 101, to generate the lottery outcome data based on such a recognized two-dimensional code 30.

(B) The mobile phone CPU 103 transmits the lottery outcome data, generated in step (A) mentioned above, to the server 130 via the mobile phone communication unit 102 over the Internet.

While the presently filed embodiment represents an example wherein the two-dimensional code 30, obtained when captured with the mobile phone 100, is recognized to allow the resulting lottery outcome data to be transmitted to the server 130 for thereby obtaining game-related information, available to be used in the game program of the gaming device 150, or electronic information as key information to get the relevant game-related information, the presently filed embodiment may also take the form of a structure wherein the conversion program 133 for the two-dimensional code 30 of the mobile phone 100 is converted to game-related information, available to be used in the game program of the gaming device 150, or electronic information as key information to get the relevant game-related information and the resulting electronic information, function as converted key information, is directly inputted to the gaming device 150. In this case, in order to enable electronic information to be converted to electronic information depending on the game program to be used in the gaming device 150, the conversion program 133 for the two-dimensional code 30 may be preferably downloaded from the network.

(Structure of Server)

Even with the presently filed embodiment, the server 130 has the substantially same structure as that of the first embodiment, set forth above, and description of the same is herein omitted (see FIG. 26). Hereunder, description is made of features of the server 130 of the presently filed embodiment.

Database 132 of the server 130 of the presently filed embodiment stores the premium data (such as, for instance, image data for an awaiting image, musical data for Chaku-Melo, password data for a game program, etc.) for each site depending on the URL function as the lottery outcome data. Upon receipt of the URL as the lottery outcome data and ID data of the mobile phone 100 from the mobile phone 100, the server 130 reads out data (such as, for instance, HTML, etc.), indicative of a site depending on the URL, and the premium data, such as those mentioned above, from database 132 for transmission to the mobile phone 100 over the Internet. As a result, the liquid crystal display device 105 of the mobile phone 100 displays the site depending on the URL function as the lottery outcome data, thereby enabling the premium data to be obtained on the relevant site.

With the server 130 of the presently filed embodiment, upon receipt of code information function as game-related information, functions as the lottery outcome data transmitted from the mobile phone 100, or key information to get the relevant game-related information, the server 130 directly or indirectly transmits password information to be directly inputted to the gaming device 150 as, for instance, game-related information, function as the lottery outcome data, or the key information to get the relevant game-related information. In cases where the code information, function as the lottery outcome data transmitted from the mobile phone 100, includes the image data, the relevant image data is decoded into the password information, depending on decoded game-related information or key information to get the relevant game-related information, for transmission to the mobile phone 100. As used herein, the phrase “to indirectly get password information from the server 130” is meant by the fact, as described below, that once the premium data, function as the game-related information or key information to get the relevant game-related information, is transmitted to the mobile phone 100 in the form of URL information, set forth above, to be available for downloading whereby the mobile phone is coupled to the URL, mentioned above, to enable the mobile phone 100 to receive the password information, function as the premium data mentioned above, from the other server or the server 130 described above.

(Process to be Executed Between Mobile Phone and Server)

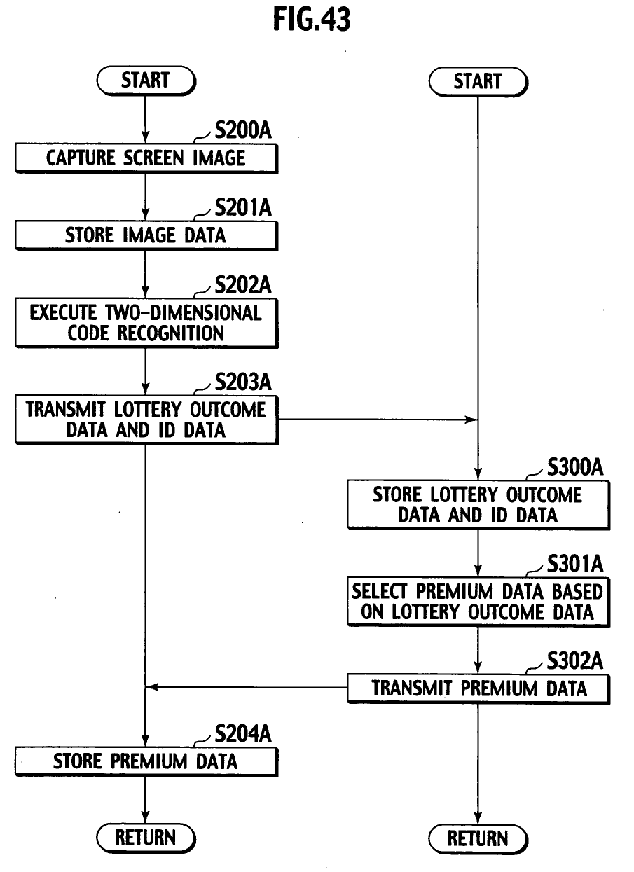

Now, description is made of a process to be executed between the mobile phone 100, set forth above, and the server 130. FIG. 43 is a flowchart showing a process to be executed between the mobile phone 100 and the server 130. First, the mobile phone CPU 103, incorporated in the mobile phone 100, drives the camera 101, functions as the image capture device, in response to a command inputted via the operating section 106, for capturing the two-dimensional code 30 in image contained in the screen image displayed over the liquid crystal display device 31 of the pachi-slot gaming machine 1A (S200A). Subsequently, the mobile phone CPU 103 allows the memory 104 to store image data obtained in S200A (S201A). Next, the mobile phone CPU 103 starts up the conversion program 133 for the two-dimensional core 30 for execution of the recognition operation for the two-dimensional code 30 (S202A) and recognizes the two-dimensional code 30 based on image data obtained in S200A. The lottery outcome data is generated based on such recognized two-dimensional code 30. The recognition process for the two-dimensional code 30 is described later in detail with reference to the accompanying drawings.

Then, the mobile phone CPU 103 allows the mobile phone communication unit 102 to transmit the lottery outcome data, obtained in the recognition process for the two-dimensional code 30 in S202A, together with ID data of the mobile phone 100 to the server 130 over the Internet (S203A).

In the meanwhile, upon receipt of the lottery outcome data (URL) and ID data of the mobile phone 100 from the mobile phone 100 over the Internet, the server CPU 135 of the server 130 allows the lottery outcome data (URL) and ID data to be stored in the RAM 134b (S300A). Then, the server CPU 135 selects data (such as, for instance, HTML data, etc.), indicative of a site associated with the URL function as lottery outcome data obtained in S300A, and the premium data, associated with such a site, from database 132 (S301A). Subsequently, the server CPU 135 transmits data, indicative of the site, and selected premium data to the mobile phone 100 (S302A).

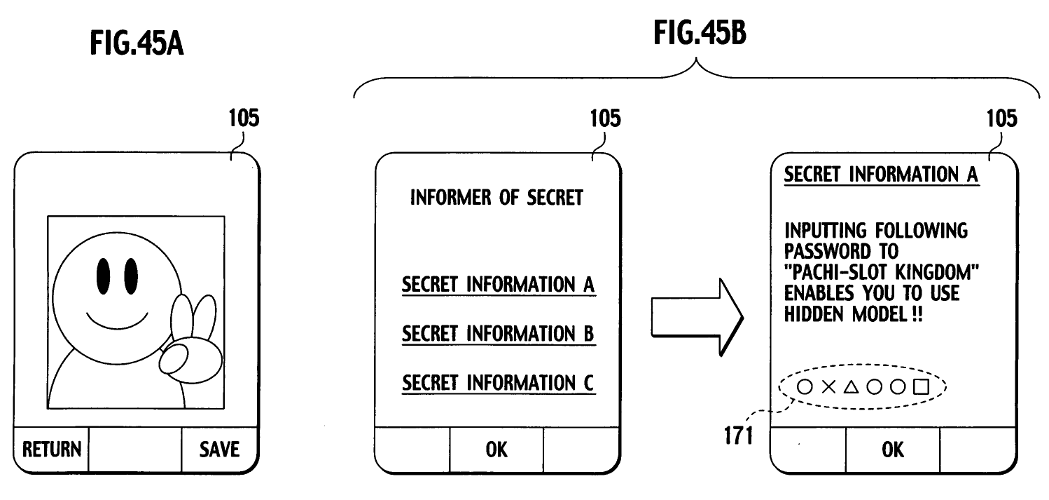

Upon receipt of data (data, indicative of the site, and the premium data) from the server 130, the mobile phone CPU 103 stores such data (S204A). Then, the mobile phone CPU 103 allows the liquid crystal display device 105 to display the site associated with the URL function as the lottery outcome data (see FIGS. 45A and 45B). By inputting a predetermined command upon operation of the operating section 106, the player is enabled to acquire the premium data.

(Code Conversion Process for Two-Dimensional Code 30)

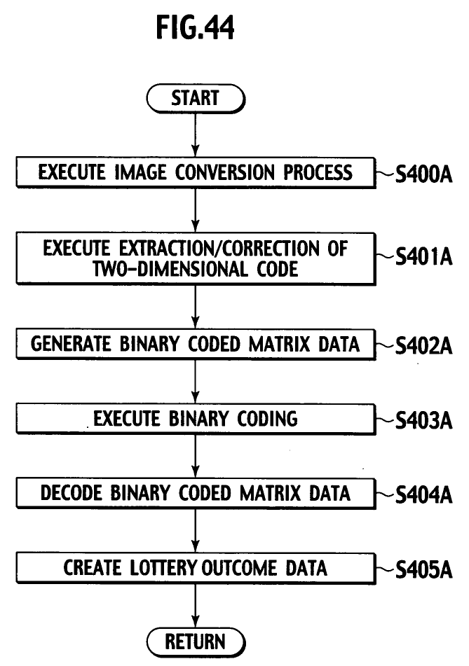

Now, the recognition process (S202A) for the two-dimensional code 30 to be executed by implementing the conversion program 133 for the two-dimensional code 30 in the mobile phone CPU 103 is described with reference to FIG. 44. FIG. 44 is a flowchart showing the recognition process (S202A) for the two-dimensional code 30 to be retrieved and executed in the operation in S202A shown in FIG. 44. First, the mobile phone CPU 103 executes an image conversion process for the image data stored in RAM 104a (S400A). The image conversion process represents a process in which the operation is executed to extract the image data in the area, in which the two-dimensional code 30 is displayed, from the image data captured with the camera 101, for correction of inclination and distortion to be converted into a monochrome image with a predetermined threshold for thereby obtaining image data involving the two-dimensional code 30 as viewed in a front thereof.

Next, the mobile phone CPU 103 extracts the two-dimensional code 30 from the image data, obtained in S400A, for correction of noise or the like (S401A). Then, the mobile phone CPU 103 executes binary coding of the two-dimensional code 30, obtained in S401A, to rewrite the respective dots forming the two-dimensional code 30 in “0” or “1” (S402A), thereby generating binary coded matrix data (S403A). After generating the binary coded matrix data, the mobile phone CPU 103 decodes the binary coded matrix data (S404A), thereby generating the lottery outcome data (S404A). After completing the operation in S405A, the current sub-routine is completed and the operation goes to S203A of the flowchart shown in FIG. 43.

As the mobile phone 100 transmits the URL, related to the lottery outcome data, and ID data of the mobile phone 100 to the server 130 (S203A in FIG. 43), the server 130 transmits data (such as, for instance, HTML data, etc.), indicative of the site associated with the URL, and the premium data to the mobile phone 100 (S302 in FIG. 43) such that the liquid crystal display device 105 of the mobile phone 100 displays an image representing the password as shown in FIGS. 45A and 45B.

(Flow of Premium Data after Receipt Thereof)

FIG. 45A is a view showing one example of an awaiting image transmitted from the server 130 to the mobile phone as premium data. Provided in a central area of the liquid crystal display 105 is the awaiting image that represents a character appearing as an effect in the pachi-slot gaming machine 1A. Further, there are two options such as “RETURN” and “SAVE” in areas below the liquid crystal display 105. In this case, operating the operating section 106 to select one option “SAVE” allows the image data for the awaiting image to be stored in the memory 104 of the mobile phone 100. Also, in cases where music data for Chaku-Melo is transmitted as the premium data, the liquid crystal display 105 is provided with a display of a title of music data, mentioned above, and three options, including “RETURN”, “REPRODUCTION” and “SAVE”, are displayed in areas below the liquid crystal display 105. When this takes place, selecting the option “REPRODUCTION” music data is reproduced.

In the meanwhile, FIG. 45B is a view showing a case in which password data, for the game program to be executed in the gaming device 150, is transmitted as the premium data. The liquid crystal display 105 provides a display of a site related to the game program to be executed in the gaming device 150. As the operating section 106 is operated to select the option desired by the player, the liquid crystal display 105 provides a display of the password 171, associated with the selected option, and the content of the password 171 representing which of the functional restrictions is to be cancelled.

(Structure of Gaming Machine)

Now, the gaming machine, forming the game system of the presently filed embodiment, is described in detail with reference to FIG. 46. FIG. 46 is an exterior perspective view of the gaming device 150 of the presently filed embodiment. As shown in FIG. 46, the gaming device 150 is constituted with a gaming device main body 155 internally provided with a gaming device control circuit 151 that reads out game programs from a CD-ROM 154, function as recording medium, in which the game programs, described below, are stored, a game display section 152 by which various information are displayed upon execution of the game programs, and a game controller 153 that reflects intensions of a player during a game upon operations of the player.

The game display section 152 is a display device that is mounted on the gaming device main body 155 at a rear side thereof so as to stand upright to make it possible to provide various displays upon powering on the gaming device main body 155. Under a situation where the CD-ROM 154 is mounted to the gaming device main body 155 for execution, the game display section 152 provides a display of various contents based on the game program. Further, speakers (not shown) are integrally formed with the game display section 152 to be operative to output voice signals based on the game program.

The gaming device main body 155 is formed in a cuboidal shape and has an upper surface whose central area formed with an opening and closing door 156 that is rotatable about an axis at the rear side of the gaming device main body 155. Further, the upper surface of the gaming device main body 155 has one end whose front area is provided with an open button 158 to open the opening and closing door 156, enabling the opening and closing door 156 to be opened. With the opening and closing door 156 being opened, a CD-ROM readout device 157 is located on a central area of the gaming device main body 155 for reading out the stored content from the CD-ROM 154.

Further, the gaming device main body 155 has a front and side area whose one end is provided with a power switch 159 and the reset button 159a one above the other. The gaming device main body 155 has a front side whose central area to which the game controller 153 is connected to allow the player to perform various operations of the gaming device 150. Provided in the game controller 153 are a cross joint key 160, a trigger button 161 and a start button 162, which are operated to transmit various command signals to the gaming device 150.

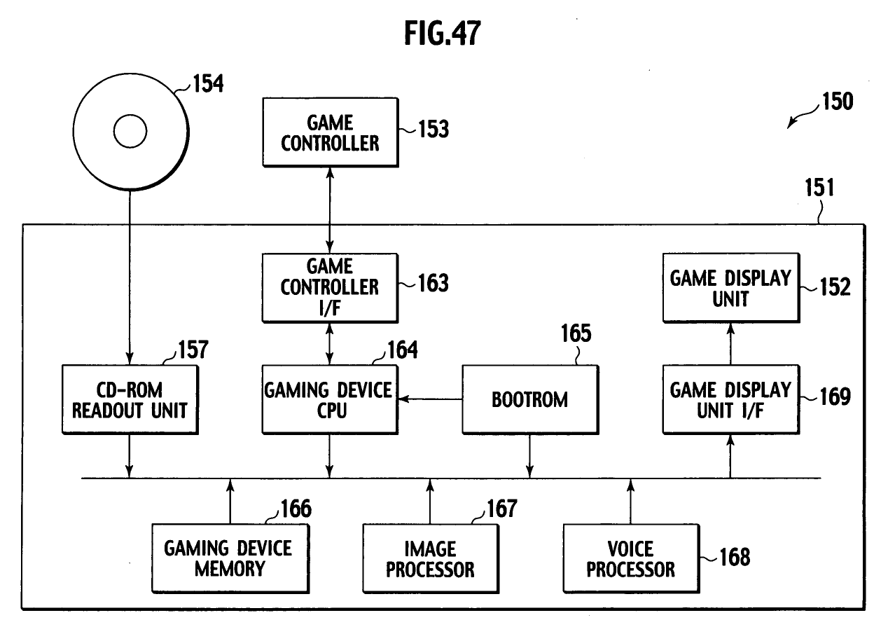

Next, a control system of the gaming device 150 is described in detail with reference to the accompanying drawings. FIG. 47 is a block diagram showing the control system of the gaming device 150 of the presently filed embodiment. As set forth above, with the gaming device 150, the game display section 152 and the game controller 153 are connected to the gaming device main body 155, respectively. Thus, by permitting the gaming device 150 to read out and execute the CD-ROM 154, forming record medium in which the game programs are stored, the gaming device 150 functions as a device that enables the player to play a game.

The gaming machine main body 155 has the gaming device control circuit 151 by which various controls are performed on the gaming device 150. The gaming device control circuit 151 includes the CD-ROM readout unit 157, a controller interface 163 (hereinafter abbreviated as a “controller I/F”), a gaming device CPU 164, a BOOT ROM 165, a gaming device memory 166, an image processor 167, a voice processor 168 and a game display unit I/F 169. The various component parts of the gaming device control circuit 151 are described. The CD-ROM readout unit 157 functions as an interface in which the CD-ROM 154, forming record medium stored with the game programs, is mounted to allow the gaming device main body 155 to read in the gate programs. The controller I/F 163 functions as an interface that is applied with a signal, which is inputted in response to the operations of the game controller 153 by the player, from the game controller 153 to be inputted to the gaming device CPU 164.

The gaming device CPU 164 controls various parts, by which the gaming device main body 155 is formed, so as to perform desired operations of the gaming device 150 as a whole 150. In particular, the gaming device CPU 164 starts up the gaming device main body 155 in accordance with an initializing program stored in the BOOT ROM 165. Further, under a situation where the ID-ROM 154 is mounted to the gaming device 150, a desired computing operation is performed in accordance with the program stored in the CD-ROM 154 to execute a game by controlling various parts of the gaming device main body 155 based on the resulting computation result. The BOOT ROM 165 is a memory for a startup program in which an operating system, etc., which is started up when the gaming device main body 155 is powered on, is stored. The gaming device memory 166 is a memory in which arbitrary data is temporarily stored followed upon various operations executed in the gaming device main body 155. The gaming device memory 166 is able to store, in addition to data in mid-flow of computation in the voice processor 168 or the like, intermediate steps of the game programs.

The image processor 167 is a dedicated circuit that generates an image to be displayed on the game display unit 152. The voice processor 168 is a dedicated circuit that reproduces a voice outputted from the game display unit 152. The game display unit I/F 169 is an interface that allows image data, generated by the image processor 167 or the gaming device CPU 164, and voice data, generated by the voice processor 168 and the gaming device CPU 164, to be outputted to the game display unit 152.

The game controller 153 functions as a command device such as, for instance, a game pad and a keyboard through which the operation on the game is commanded. In normal practice, the game controller 153 is detachably connected to the gaming device main body 155. The game display unit 152 functions as a device with which a monitor, adapted to display the image data generated by the image processor 167 and the gaming device CPU 164, and speakers, adapted to output voice data generated by the voice controller 168 and the gaming device CPU 164, are integrally structured.

The CD-ROM 154 functions as record medium in which the game programs are stored. With the presently filed embodiment, specific functions of the game programs are restricted to provide an inability of performing and selection and determination of the relevant function unless a predetermined condition is satisfied.

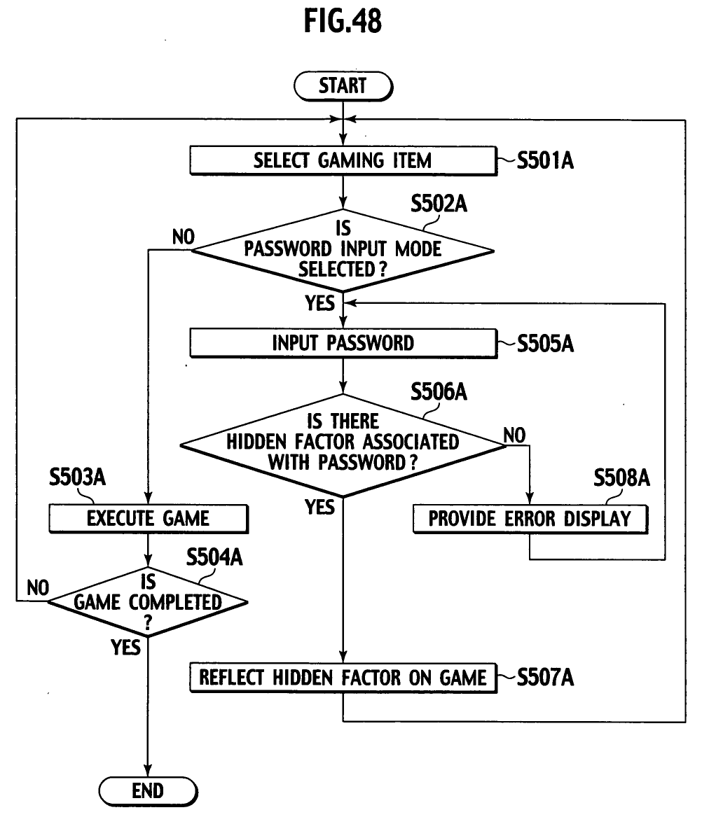

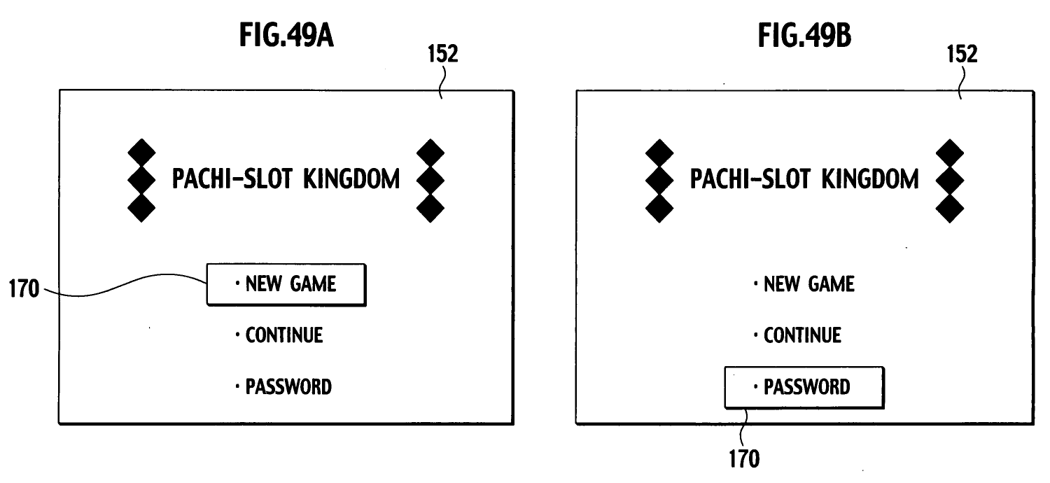

Now, a game program, to be executed by the gaming device 150 of the presently filed embodiment, is described in detail with reference to FIGS. 48 to 51B. FIG. 48 is a flowchart of the game program of the presently filed embodiment. FIGS. 49A to 51B are views for illustrating appearances of the game display unit 152 present when the program is executed.

With the presently filed embodiment, the game program, to be executed in the gaming device 150, includes a game program that is operative to simulate, for instance, a pachi-slot gaming machine to allow a game to be played like an actual machine. The game program is a game program, normally operative to be selected from three kinds of pachi-slot gaming machines for play, which further enables the player to be able to play a game with one kind of pachi-slot gaming machine, as will be described later, under a situation where a specified condition is satisfied and enables the player to play a game upon simulation of the maximum four kinds of slot-gaming machines.

Now, the game program is sequentially described with reference to the flowchart shown in FIG. 48. As the CD-ROM 154 is installed onto the gaming device 150 to begin the execution of the game program, first, the game display unit 152 provides a display of a game item selection screen (see FIG. 48A), thereby performing game item selecting operation (S501A). In S501A, moving a cursor 170 upon operating the game controller 153 allows a desired game item, displayed on the game display unit 152, to be selectively determined. As shown in FIG. 49B, for instance, moving the cursor 170 with the game controller 153 enables any of the game items such as “NEW GAME”, CONTINUE” AND “PASSWORD” to be selected. After the game item selecting operation (S501A) has been terminated, the operation goes to S502A.

In S502, determination is made whether or not the game item, selectively determined in S501, belongs to a password input mode (that is, “PASSWORD”). If the password input mode is present (S502A: “YES”), then, the operation goes to S505A.

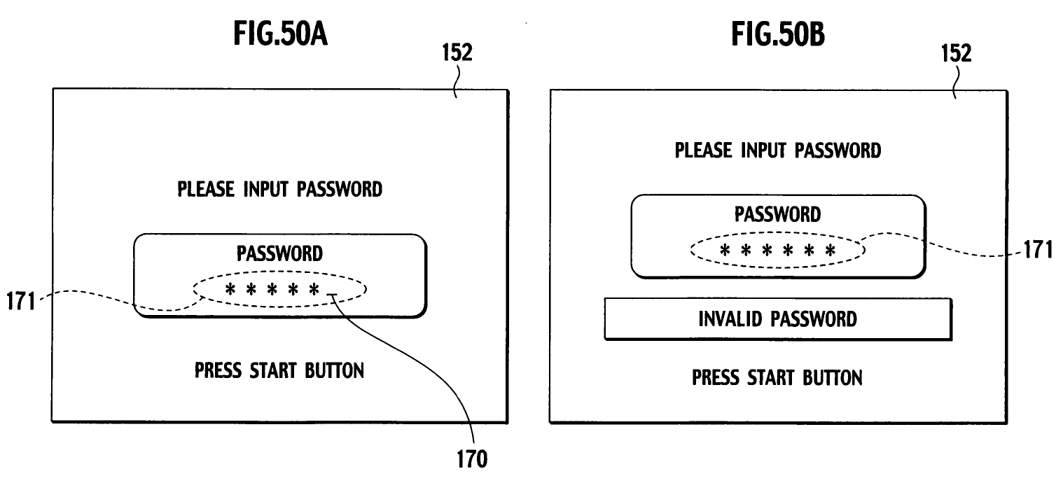

On the contrary, if the password input mode is absent (S502A: “NO”), the operation goes to S503A. As used herein, the phrase “the password input mode is absent” represents a situation where the game item “NEW GAME” or “CONTINUE”, shown in FIGS. 48A and 48B, is selected. Under such a situation, the game is executed in S503A. Under the situation of the presently filed embodiment, permitting the selection screens (see FIGS. 50A) of the slot-gaming machines A to C for selection of a desired slot-gaming machine enables the relevant slot-gaming machine to be simulated. Here, the game item “NEW GAME” represents a mode under which a payer plays this game from an initial state. In the meanwhile, the game item “CONTINUE” represents a mode under which a state of an immediately preceding game is succeeded to allow the player to play the game with the slot-gaming machine. When this takes place, the number of credits on medals, obtained up to the immediately preceding game, is succeeded and the player is able to play the game with another slot-gaming machine. After the game has been practiced in S503A, determination is made whether or not the game is completed in S503A. If the game is finished (S504A: “YES”), the game is completed intact. On the contrary, if the game is not finished (S504A: “NO”), the operation is routed back to S501A.

On the contrary, if the password input mode is selected in S502A (S502A: “YES”), the operation goes to a password input operation (S505A). As the operation shifts to the password input mode (S505A), the game display unit 152 provides a display as shown in FIG. 50A. Provided in the central area of the game display unit 152, shown in FIG. 50A, is an input column through which a password 171 is inputted. Operating the game controller 153 allows a predetermined password 171 to be inputted in the input column. Thus, the password is inputted to the input column and the operation goes to S506A.

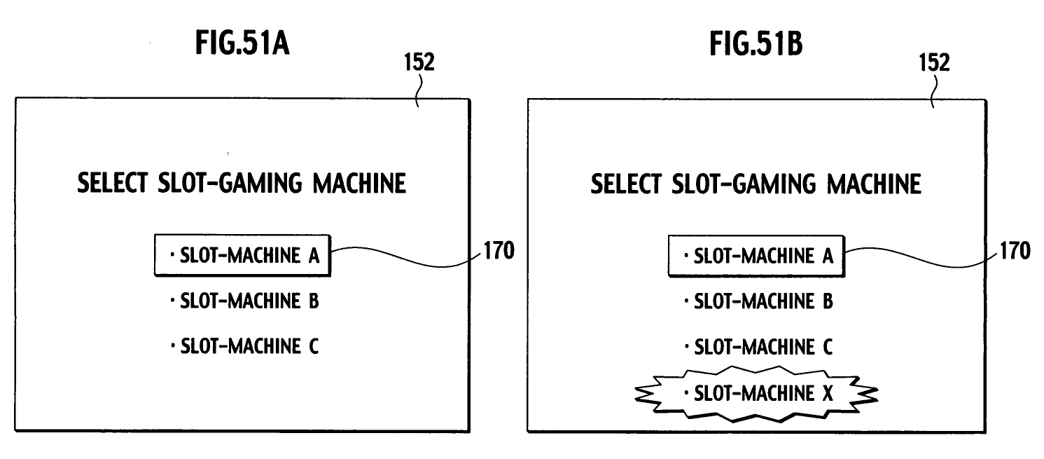

In S506A, determination is made whether or not a hidden factor is present in association with the password 171 that is inputted in S505A. If the hidden factor, associated with the password 171, is present (S506A: “YES”), that is, if the password, inputted in the input operation, belongs to “◯×◯◯□”, then, determination is made that there is the hidden factor associated with the password 171 (S506A: “YES”), allowing the hidden factor, associated with the password 171, to be reflected on the game (S507A). As used herein, the term “hidden factor” refers to a model. (i.e., a so-called hidden model) of a slot-gaming machine, which cannot be selected under normal practice, in which a “SLOT-GAMING AMCHINE X”, shown in FIG. 51B, is possibly selected (S507A) upon which the operation is routed back to S501A. In contrast, if no hidden factor associated with the password 171 is present, that is, if the other input than the password, shown in FIG. 44B, is inputted, the game display unit 152 provides a display of an error indication as shown in FIG. 50B (S508A), after which the operation is routed back to S505A.

In such away, inputting the password 171 and practicing the game after canceling the restriction on the hidden factor provides a capability of selecting a slot-gaming machine, which could not be selected with the password input being absent (FIG. 51A) and enables the player to play a game with this “SLOT-GAMING MACHINE X”.

By permitting the password 171 to be taught to the player by means of the two-dimensional code 30, displayed on the two-dimensional code display area 24, at the end of “BB”, the game program, to be executed in the gaming device 150, provides the player with a capability of using a game function unable for the player who does not know the password 171. This provides the player with amusement in a capability of playing the game program in a further deep fashion.

As set forth above, with the pachi-slot gaming machine 1A and the game system of the presently filed embodiment, since the two-dimensional code 30 which is generated based on the coded URL function as the lottery outcome data related to the outcome of the premium lottery, is displayed in a mode available to be captured with the camera 101 of the mobile phone 100 (see FIG. 11), for instance, the presence of operation performed by the player to capture the two-dimensional code 30 with the camera 101 of the mobile phone 100 allows the mobile phone 100 to transmit the lottery outcome data, generated from the two-dimensional code 30, to the server 130 whereby the player is able to obtain the premium data, depending on the outcome of the lottery, from the server 130 (see FIG. 43). Accordingly, due to a capability for the pachi-slot gaming machine 1A to provide a display of the two-dimensional code 30 needed for obtaining the premium (see FIG. 11), a game arcade has the ability of achieving improvement on effort to pull in more customers and a gaming machine manufacturer has a capability of providing a service with advantages on both sides of the game arcade and the gaming machine manufacturer like a way such that players in the game arcade are enabled to have supports and attachments for the pachi-slot gaming machine 1A provided by the same gaming machine manufacturer. Also, another advantage exists with a capability of providing such a service without causing an increase in shop attendant's trouble.

Further, aside from amusement in which the medals are merely got, the player can be afforded with new amusement, which is free from influences of regulation, wherein password data for the game program is obtained as the premium, enabling a popularity of the pachi-slot gaming machine 1A to be maintained even in a drop in a speculation property of the pachi-slot gaming machine 1A due to the occurrence of increased regulation. Thus, it becomes possible to prevent the variation in regulation for the pachi-slot gaming machine 1A from adversely affecting premiums of the game arcade and the gaming machine manufacturer. In addition, the game program of the gaming device 150, forming the game system of the present invention, is enabled to use a game function that cannot be selected by the player who does not know the password 171. That is, the player can be afforded with two amusements in such a way wherein the player is able to deeply enjoy the pachi-slot gaming machine 1A while enabling the player to play the game program in a further deep fashion.

Further, the mobile phone 100 corresponds to the mobile device of the present invention. With the mobile phone 100, the two-dimensional code 30 can be captured from the pachi-slot gaming machine 1A, by which the two-dimensional code 30 resulting from coding the lottery outcome related to the premium lottery is displayed, to allow the resulting image data to be transmitted to the server 130, making it possible to obtain premium data from the server 130 depending on the lottery outcome (see FIGS. 25, 26 and 43). Accordingly, it becomes possible to provide services with advantages on both sides of the game arcade and the gaming machine manufacturer. While the presently filed embodiments, set forth above, adopt the process wherein the password 171 is finally displayed on the liquid crystal display 105 of the mobile phone 100 as password information to represent code information as game-related information, obtained depending on the lottery outcome of the gaming machine, of key information to obtain game-related information upon which displayed password information is manually inputted using the game controller 153 of the gaming device 150, the present invention is not limited to such a process and in cases where a Bluetooth communication function and optical communication function are present and the gaming machine has a function to receive signals based on these functions, the mobile phone 100 is also enabled to transmit game-related information or key information for obtaining the relevant game-related information to the gaming device 150 over the radio. Further, it may be configured such that in cases where the mobile phone 100 is provided with a card slot, a memory card is installed onto the slot to allow the relevant memory card to store game-related information or key information for obtaining the relevant game-related information once to allow the gaming device 150 to store this key information (upon indirectly inputting) for utilization.

### Fifth Embodiment

Now, a game system, different from the fourth embodiment mentioned above, is described as a fifth embodiment. While with the game system of the fourth embodiment mentioned above, the mobile phone 100 has the conversion program 133 for the two-dimensional code 30 to perform recognition of the two-dimensional code 30 and conversion of the same into lottery outcome data, the game system of the fifth embodiment is described with reference to a case wherein the mobile phone 100 has no conversion program 133 for the two-dimensional code 30 whereas the server 130 has the conversion program 133 for the two-dimensional code 30 to perform recognition of the two-dimensional code 30 and conversion of the same into the lottery outcome data.

Also, outer appearances and internal structures of the pachi-slot gaming machine, forming the game system of the fifth embodiment, the mobile phone and the server and the processes to be executed by the pachi-slot gaming machine 1A are similar to those of the fourth embodiment and, so, description of the same is herein omitted. Description is herein made of a process to be executed between the mobile phone 100 and the server 130. The same component parts as those of the game system of the fourth embodiment bear like reference numerals for description.

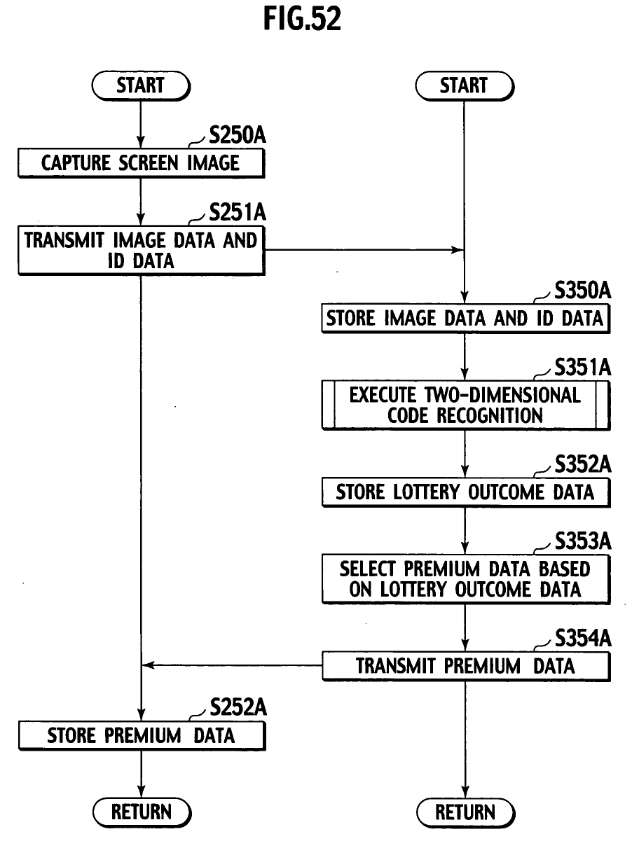

FIG. 52 is a flowchart showing a process to be executed between the mobile phone 100 and the server 130 by which a service providing system of the fifth embodiment is defined. First, in S250, the mobile phone CPU 103, incorporated in the mobile phone 100, drives the camera 101 function as the image capture device in response to a command inputted via the operating section 106, causing the camera 101 to capture the two-dimensional code 30, involved in a screen image displayed on the two-dimensional code display area 24 of the pachi-slot gaming machine 1A (see FIG. 11).

Subsequently, the mobile phone CPU 103 accesses a predetermined address (such as, for instance, a URL indicative of a site of a gaming machine manufacturer) inside the server 130 depending on data indicative of an address, preliminarily transmitted from the server 130, and allows the image data, obtained when the camera 101 captures the two-dimensional code 30, to be transmitted together with ID data of the mobile phone 100 to the server 130 via the mobile phone communication unit 102 over the Internet based on a communication standard (such as, for instance, FTP, etc.) that is known in the art (S251A).

In the meanwhile, upon receipt of image data and ID data of the mobile phone 100 fro the mobile phone 100 over the Internet, the server CPU 135, incorporated in the server 130, stores the relevant image data and ID data in the RAM 134b (S350A). Next, the server CPU 135 executes a recognition process for the two-dimensional code 30 (S351A) for recognizing the two-dimensional code 30 from image data, obtained when the camera 101 (readout device) of the mobile phone 100 captures the two-dimensional code 30 (code information), to allow recognized two-dimensional code 30 to be converted to lottery outcome data. Also, the recognition process for the two-dimensional code 30 in the second embodiment, which is similar to the recognition process for the two-dimensional code 30 in the third embodiment, has been already described with reference to FIG. 44 and, therefore, description of the same is herein omitted.

Next, the server CPU 135 stores the lottery outcome data, resulting from executing the recognition process for the two-dimensional code 30 in S301A (see FIG. 43), in the RAM 134b in correlation with ID data of the mobile phone 100 (S352A). Then, the server CPU 135 selects data (such as, for instance, HTML data, etc.), indicative of the site associated with the URL function as the lottery outcome data obtained by the recognition process for the two-dimensional code 30 in S301A, and the premium data associated with such a site from database 132 (S353A). Thereafter, the server CPU 135 transmits data, indicative of the site, and the premium data to the mobile phone 100 (S354A).

Upon receipt of data, indicative of the site, and the premium data from the server 130, the mobile phone CPU 103 stores data (i.e., data, indicative of the site, and the premium data), transmitted from the server 130, in the memory 104 (S252A). Then, the mobile phone CPU 103 allows the liquid crystal display 105 to provide a display of the site, associated with the URL function as the lottery outcome data, based on data described above (see FIGS. 45A and 45B). Subsequently, by operating the operating section 106 by player to input a predetermined command, the player is enabled to obtain the premium data.

As set forth above, with the pachi-slot gaming machine 1A and the game system of the fifth embodiment, since the two-dimensional code 30 which is generated based on the lottery outcome data related to the outcome of the premium lottery, is displayed over the pachi-slot gaming machine 1A, like the fourth embodiment, the player uses the camera 101 of the mobile phone 100 to capture the two-dimensional code 30 to allow the mobile phone 100 to transmit resulting image data to the server 130 whereby the player is able to obtain the premium data from the server 130 depending on the outcome of the lottery. Accordingly, even in cases where the conversion program 133 for the two-dimensional code 30 is not stored in the memory 104 of the mobile phone 100, the game system of the fifth embodiment enables the premium data to be obtained. Consequently, due to a capability for the pachi-slot gaming machine 1A to provide a display of the two-dimensional code 30 needed for obtaining the premium, a game arcade has an ability of achieving improvement on effort to pull in more customers and a gaming machine manufacturer has a capability of providing a service with advantages on both sides of the game arcade and the gaming machine manufacturer like a way such that players in the game arcade are enabled to have supports and attachments for the pachi-slot gaming machine 1A provided by the same gaming machine manufacturer. Also, another advantage exists with a capability of providing such a service without causing an increase in shop attendant's trouble.

Further, aside from amusement with the medals being merely got, the player can be afforded with new amusement, which is free from influences of regulation, wherein password data for the game program is obtained as the premium, enabling the pachi-slot gaming machine 1A to have an enhanced popularity even in the presence of a drop in a speculation property of the pachi-slot gaming machine 1A due to the occurrence of increased regulation. Thus, it becomes possible to prevent premiums of the game arcade and the gaming machine manufacturer from suffering adverse affects caused by variation in regulation on the pachi-slot -gaming machine 1A. In addition, a capability of the player to get the password for the game program as the premium data results in an ability for the game program manufacturer to raise publicity for the player of the pachi-slot gaming machine 1A. As a result, an advantage appears on the game program manufacturer in building up a novel clientele. On the other hand, for the gaming machine manufacturer, due to probabilities of users of the game program are going to play games with the pachi-slot gaming machine 1A with a view to further amusing themselves on the games, the gaming machine manufacturer is able to have an increased chance to build up a new clientele.

Also, it is, of course, to be appreciated that the present invention is not limited to the embodiments set forth above and various improvements and modifications may be possible without departing from the scope of the present invention. For instance, although with the embodiments, mentioned above, image data for the awaiting image, music data for Chaku-Melo, and password data for the game have been employed as the premium data, premium data of the present invention is not limited to such examples. As the premium data, for instance, data, indicative of a format to be filled in with personal information (such as, for instance, named, address, etc.) for application to a premium, may be transmitted to the mobile device. In such a case, filling in predetermined personal information in the format, described above, for transmission to the server enables the player to obtain the above-described premium via parcel delivery service, etc. By so doing, it becomes possible for a corporeal thing to be adopted as the premium.

Furthermore, while with the presently filed embodiment, the game program, to be executed by the gaming device 150, is game program that enables a player to play a game upon simulation of a slot-gaming machine, such as the pachi-slot gaming machine 1A, in the same way as that of an actual slot-gaming machine while the password 171 renders the slot-gaming machine, which is normally inoperative, operative to function as a hidden model, the present invention is not limited to contents of the game program and password 171 specified above. For instance, the game program, by which the pachi-slot gaming machine 1A is simulated, may be configured in a way to provide an increase in the number of medals to be owned by the player or to provide a capability of using a function to vary moving speeds of the symbols, to be displayed over the game display section 152, of the pachi-slot gaming machine 1A.

While the presently filed embodiment has employed the game program by which the slot-gaming machine is simulated for play like the actual one, the game program has no need to simulate the slot-gaming machine and may include various games such as a so-called role playing game, an action game and puzzle game or the like. In such a case, the password 171, available to be obtained from the two-dimensional code 30, may include data of an item in which the game program is progressed with an advantage given to the player. For instance, the role playing game and the action game or the like may be implemented in such a way in which strong weapons and protective guards or the like. Moreover, if the game program includes the puzzle game, the puzzle game may be structured in such a way to enable the use of a function to be altered in a further increased difficulty level or to enable the use of a hint function in an opposite way by which a hint is provided for the current puzzle game.

Additionally, in the present invention, bonus gamed such as a free game can be used as the special gaming state of a slot machine.

As set forth above, while the embodiments of the present invention have been described, it is intended that the embodiments described are meant to be illustrative of the concrete examples only and not limiting to the scope of the present invention and concrete structures of various devices may be possible to be appropriately modified in design. Further, the advantages effects described with reference to the embodiments of the present invention are considered to be merely illustrative of the most favorable effects resulting from the present invention and the advantageous effects of the present invention are not limited to those described with reference to the embodiments of the present invention.

Although, the embodiments above are described with the gaming machines being used in Japan, the present invention can be applied to a gaming machine used in various countries such as slot machines. Meanwhile, in the gaming machine for used in various countries does not include the stop buttons 11L, 11C, 11R, whereas the reels 3L, 3C, 3R of the gaming machine for used in various countries are automatically stopped after predetermined time period elapsed.

Further, according to the present invention, it is possible to combine above described various embodiments.

According to the embodiments above, it is possible to show the various game-related information or the key information depending on the player's play condition. By this configuration, the code information, which is coded based on various game-related information, can be provided to the player, whereby it is possible to provide the gaming machine have new high-interest on a game program. And, by this feature, the game arcade has a merit that the ability of pulling in more customers can be improved, and the gaming machine manufacture has a merit that supports for the gaming machine of the manufacture can be increased.

Since the player obtains the game-related information that is needed to execute the game program under a special mode, whereby the player can feel superior for the other player who has no game-related information. Furthermore, by providing the various game-related information to the player, the player can enjoy the game program more. Meanwhile, since the gaming machine manufacture, which performs as a game-related information provider, can directly contact with the player without through the game arcade, it is possible to render the player to feel kinship with the manufactures.

Additionally, since the game program can be changed its mode based on the various game-related information that is generated based on the cod information, various players can enjoy various mode of the game program by using his game-related information respectively.

Although the invention has been described above by reference to certain embodiments of the present invention, the invention is not limited to the embodiments described above and modifications will occur to those skilled in the art, in light of the teachings. The scope of the invention is defined with reference to the following claims.

What is claimed is:

1. A gaming machine comprising:
a display device;
a lottery device;
a gaming state varying device varying a gaming state of the gaming machine depending on a lottery outcome resulting from the lottery device;
a code information display device displaying code information depending on the gaming state so that an external image capture device captures the code information; and
a code information readout device reading out the code information.

2. A gaming machine comprising:
a plurality of reels having peripheries provided with symbols, respectively;
a variable display start device starting variable displays of the reels;
a variable display stop device stopping the variable displays of the reels;
a game control device operative such that in a case wherein a combination of the symbols of the reels at stops of the reels is established in a predetermined combination, a premium is afforded to a player in accordance with the combination;
a code information display device displaying code information which is generated based on coded information related to a game executed by the player; and
a code information readout device reading out the code information owned by the player.

3. A method for controlling a gaming machine having a display device, a lottery device and a gaming state varying device varying a gaming state of the gaming machine depending on a lottery outcome resulting from the lottery device, comprising the steps of:
displaying code information, which is able to capture by an external image capture device, over a code information display device, formed on the display device of the gaming machine, depending on the gaming state; and
reading out the code information by a code information readout device provided on the gaming machine.

4. A game system comprising:
a gaming machine having a display device; a lottery device; a gaming state varying device varying a gaming state of the gaming machine depending on a lottery outcome resulting from the lottery device; a code information display device displaying code information depending on the gaming state so that an external image capture device captures the code information; and a code information readout device reading out the code information;
a mobile device including an image capture device captures the code information displayed over the code information display device of the gaming machine, a transmitter transmitting the code information, which is captured with the image capture device, to a server, a receiver receiving data, which is generated based on the code information, from the server, and a display device operative to display the data resulting from the code information, received from the receiver, and the- code information captured by the image capture device; and
the server including a receiver receiving the code information from the mobile device, a code information conversion device analyzing and converting the code information transmitted from the mobile device, and a transmitter transmitting the data, resulting from the code information converted with the code information conversion device, to the mobile device.

5. A game system comprising:
a gaming machine having a plurality of reels having peripheries provided with symbols, respectively; a variable display start device starting variable displays of the reels; a variable display stop device stopping the variable displays of the reels; a game control device operative such that in a case wherein a combination of the symbols of the reels at stops of the reels is established in a predetermined combination, a premium is afforded to a player in accordance with the combination; a code information display device displaying code information which is generated based on coded information related to a game executed by the player; and a code information readout device reading out the code information owned by the player;
a mobile device including an image capture device captures the code information displayed over the code information display device of the gaming machine, a transmitter transmitting the code information, which is captured with the image capture device, to a server, a receiver receiving data, which is generated based on the code information, from the server, and a display device operative to display the data resulting from the code information, received from the receiver, and the code information captured by the image capture device; and
the server including a receiver receiving the code information from the mobile device, a code information conversion device analyzing and converting the code information transmitted from the mobile device, and a transmitter transmitting the data, resulting from the code information converted with the code information conversion device, to the mobile device.

6. A server comprising:
a receiver receiving code information, displayed over a code information display device of a gaming machine which includes a display device; a lottery device; a gaming state varying device varying a gaming state of the gaming machine depending on a lottery outcome resulting from the lottery device; the code information display device displaying code information depending on the gaming state so that an external image capture device captures the code information; and a code information readout device reading out the code information, from a mobile device;
a code information conversion device analyzing and converting the code information transmitted from the mobile device; and
a transmitter transmitting data, resulting from the code information converted with the code information conversion device, to the mobile device.

7. A server comprising:
a receiver receiving code information, displayed over a code information display device of a gaming machine which includes a plurality of reels having peripheries provided with symbols, respectively; a variable display start device starting variable displays of the reels; a variable display stop device stopping the variable displays of the reels; a game control device operative such that in a case wherein a combination of the symbols of the reels at stops of the reels is established in a predetermined combination, a premium is afforded to a player in accordance with the combination; the code information display device displaying code information which is generated based on coded information related to a game executed by the player; and a code information readout device reading out the code information owned by the player, from a mobile device;
a code information conversion device analyzing and converting the code information transmitted from the mobile device; and
a transmitter transmitting data, resulting from the code information converted with the code information conversion device, to the mobile device.

8. A mobile device comprising:
an image capture device capturing code information including data related to a game displayed over a code information display device of a gaming machine which includes a display device; a lottery device; a gaming state varying device varying a gaming state of the gaming machine depending on a lottery outcome resulting from the lottery device; the code information display device displaying code information depending on the gaming state so that the image capture device captures the code information; and a code information readout device reading out the code information;
a transmitter transmitting the code information, captured with the image capture device, to a server;
a receiver receiving data, resulting from encoding the code information and related to the game, from the server; and
a display device operative to display the code information, captured with the image capture device, and the data, received with the receiver, and related to the game.

9. A mobile device comprising:
an image capture device capturing code information including data related to a game displayed over a code information display device of a gaming machine which includes a plurality of reels having peripheries provided with symbols, respectively; a variable display start device starting variable displays of the reels; a variable display stop device stopping the variable displays of the reels; a game control device operative such that in a case wherein a combination of the symbols of the reels at stops of the reels is established in a predetermined combination, a premium is afforded to a player in accordance with the combination; the code information display device displaying code information which is generated based on coded information related to a game executed by the player; and a code information readout device reading out the code information owned by the player;
a transmitter transmitting the code information, captured with the image capture device, to a server;
a receiver receiving data, resulting from encoding the code information and related to the game, from the server; and
a display device operative to display the code information, captured with the image capture device, and the data, received with the receiver, and related to the game.

10. A gaming machine operative to be used in a game system having a gaming device which includes an interface through which game-related information is inputted from an outside and executes a game based on a game program depending on the game-related information inputted via the interface, and the gaming machine, the gaming machine comprising:
a display device;
a lottery device;
a gaming state varying device varying a gaming state depending on a lottery outcome resulting from the lottery device, wherein
the display device further includes a code information display device displaying code information, function as the game-related information or key information for obtaining the game-related information, which is readable with an external image capture device depending on the gaming state varied by the gaming state varying device.

11. A game system comprising:
a gaming machine which includes a display device; a lottery device; a gaming state varying device varying a gaming state depending on a lottery outcome resulting from the lottery device; a code information display device displaying code information, function as the game-related information or key information for obtaining the game-related information, which is readable with an external image capture device depending on the gaming state varied by the gaming state varying device;
a mobile device including an image capture device captures the code information displayed over the code information display device, a code information conversion device analyzing and converting the code information capture with the image capture device, a transmitter transmitting information, resulting from the code conversion device, to a server, a receiver receiving the gaming-related information or key information for obtaining the game-related information, resulting from encoding the information, from the server, and a display device operative to display the code information, captured with the image capture device, and the gaming-related information or key information for obtaining the -game-related information resulting from encoding the code information received with the receiver;
the server including a receiver receiving the information, resulting from the code conversion device, from the mobile device, and a transmitter transmitting the game-related information or key information for obtaining the game-related information, to the mobile device depending on the information received with the receiver; and
a gaming device, including an interface available to input the game-related information or the key information for obtaining the game-related information from an outside, which is configured to execute a game based on a game program depending on the game-related information or the key information inputted via the interface.

12. A game program operative to be executed by a game machine to be used in a game system including the game machine being executed based on game-related information or key information, a gaming machine with a code information display device displaying code information, a mobile device and a server, comprising the steps of:
inputting the game-related information or the key information which is generated based on the code information displayed over the code information display device of the gaming machine; and
varying a gaming state based on the game-related information or the key information for obtaining the game-related information which are inputted.
